(19) United States
(12) Patent Application Publication
(10) Pub. No.: US 2025/0148912 A1
(43) Pub. Date: May 8, 2025

(54) ROAD INTELLIGENCE NETWORK WITH COLLABORATIVE SENSING AND POSITIONING FOR DRIVER REGISTRATION AND MONITORING

(71) Applicant: Stuart Alexander Jacobson, Beaverton, OR (US)

(72) Inventor: Stuart Alexander Jacobson, Beaverton, OR (US)

(21) Appl. No.: 18/939,249

(22) Filed: Nov. 6, 2024

Related U.S. Application Data
(60) Provisional application No. 63/596,961, filed on Nov. 7, 2023.
(60) Provisional application No. 63/599,975, filed on Nov. 16, 2023.
(60) Provisional application No. 63/605,407, filed on Dec. 1, 2023.

(51) Int. Cl. G08G 1/0967; B60R 16/023; G01S 17/50; G01S 17/931; G06Q 50/26; G08G 1/01; G08G 1/017; G08G 1/04

(52) U.S. Cl. CPC G08G 1/096741; G01S 17/50; G01S 17/931; G08G 1/0116; G08G 1/0129; G08G 1/0133; G08G 1/0175; G08G 1/04; B60R 16/023; G06Q 50/265

(57) ABSTRACT

Systems and techniques are provided for a road intelligence network for improved road safety, traffic management, and/or driver monitoring. The road intelligence network can use monitoring information comprising image data of vehicles on a roadway, or can use monitoring information comprising relative position and distance information for vehicles on the roadway determined using a network of beacon transmitters and receivers. Real-time mapping information indicative of vehicle movement and trajectory can be determined from the monitoring information and correlated to specific vehicles to detect unsafe or undesired driving behaviors, which may be further based on comparisons with historical mapping information of the roadway or for particular vehicles, or baseline driving characteristics of neighboring vehicles. Remediation messages and actions can be transmitted to a mobile application on a user device of a driver, in response to detection of the unsafe driving behavior.

### CROSS-REFERENCE TO RELATED APPLICATIONS

This application claims the benefit of priority to U.S. Provisional Patent Application No. 63/596,961 filed Nov. 7, 2023 and entitled “ROAD INTELLIGENCE NETWORK AND APPLICATIONS THEREOF: DRIVER REGISTRATION AND MONITORING BASED ON IMAGE INFORMATION INCLUDING LICENSE PLATE IMAGES,” U.S. Provisional Patent Application No. 63/599,975 filed Nov. 16, 2023 and entitled “COLLABORATIVE SENSING AND POSITIONING FOR ROAD SAFETY,” U.S. Provisional Patent Application No. 63/602,192 filed Nov. 22, 2023 and entitled “COLLABORATIVE SENSING AND POSITIONING FOR ROAD SAFETY,” and U.S. Provisional Patent Application No. 63/605,407 filed Dec. 1, 2023 and entitled “COLLABORATIVE SENSING AND POSITIONING FOR ROAD SAFETY,” the disclosure of which is each herein incorporated by reference in its entirety and for all purposes.

### TECHNICAL FIELD

The present disclosure relates generally to vehicle navigation and control, and more specifically pertains to systems and techniques for implementing a road intelligence network using various combinations of sensor infrastructure, cameras, and/or beacon devices that may be deployed to stationary roadside locations and/or that may be deployed in-vehicle for collaborative sensing techniques.

### BACKGROUND

An autonomous vehicle is a motorized vehicle that can navigate without a human driver. Different levels of autonomous vehicle control can be provided. For example, a semi-autonomous vehicle may include one or more automated systems to perform steering and/or acceleration in certain scenarios. A fully autonomous vehicle can perform all driving tasks, although human override may remain available. An exemplary autonomous vehicle includes a plurality of sensor systems, such as, but not limited to, a camera sensor system, a Lighting Detection and Ranging (LIDAR) sensor system, a radar sensor system, amongst others, wherein the autonomous vehicle operates based upon sensor signals output by the sensor systems. Specifically, the sensor signals are provided to an internal computing system in communication with the plurality of sensor systems, wherein a processor executes instructions based upon the sensor signals to control a mechanical system of the autonomous vehicle, such as a vehicle propulsion system, a braking system, or a steering system.

Advanced Driver Assistance Systems (ADAS) levels can be used to classify the autonomy systems of vehicles based on their respective capabilities. ADAS levels can refer to the set of six levels (0 to 5) defined by the Society of Automotive Engineers (SAE), or may be used more generally to refer to different levels and/or extents of autonomy. The six ADAS levels categorized by the SAE include Level 0 (No Automation), Level 1 (Driver Assistance), Level 2 (Partial Automation), Level 3 (Conditional Automation), Level 4 (High-Level Automation), and Level 5 (Full Automation).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for implementing a road intelligence network that can be used to provide various monitoring, sensing, and/or detection capabilities for highway traffic safety administration. In some aspects, the systems and techniques can additionally, or alternatively, be used to implement collaborative sensing and/or relative positioning using vehicle-based sensors, transmitters, receivers, etc., in combination with a plurality of beacon devices provided in, on, alongside, etc., roadway surfaces. In some embodiments, the road intelligence network can perform the various monitoring, sensing, and/or detection processes for highway traffic safety administration based at least in part on the collected collaborative sensing and relative positioning data.

According to at least one illustrative example, a method is provided, the method comprising: obtaining, from one or more sensors included in a plurality of sensors associated with a roadway environment, monitoring information associated with one or more vehicles; determining real-time mapping information indicative of one or more of movement information or trajectory information of the one or more vehicles, wherein the real-time mapping information is determined based at least in part on correlating each vehicle of the one or more vehicles to respective portions of the monitoring data; detecting an unsafe driving behavior for a particular vehicle based on analyzing the real-time mapping information and one or more of historical mapping information obtained for the roadway environment or for the particular vehicle; and transmitting, to a driver mobile application associated with a driver of the particular vehicle, a remediation message automatically generated in response to detection of the unsafe driving behavior.

In some aspects, detecting the unsafe driving behavior includes: determining, based on the real-time mapping information, one or more driving characteristics corresponding to the particular vehicle; identifying neighboring vehicles within the roadway environment, wherein the neighboring vehicles are included in the one or more vehicles and are located nearby to the particular vehicle; and determining, based on the real-time mapping information, one or more baseline driving characteristics corresponding to the identified neighboring vehicles.

In some aspects, detecting the unsafe driving behavior is based on one or more deviations between the driving characteristics corresponding to the particular vehicle and the baseline driving characteristics corresponding to the identified neighboring vehicles.

In some aspects, the neighboring vehicles are located within a configured threshold distance from the particular vehicle.

In some aspects, the neighboring vehicles are located in an adjacent lane position relative to a current lane position of the particular vehicle.

In some aspects, detecting the unsafe driving behavior is further based on analyzing sensor data obtained from one or more sensors associated with the particular vehicle, wherein the one or more sensors includes at least an accelerometer.

In some aspects, at least a portion of the sensor data is obtained from a Controller Area Network (CAN) bus associated with the particular vehicle, or is obtained from a CAN bus associated with additional vehicles included in the one or more vehicles.

In some aspects, the remediation message comprises automatically generated driver assistance information configured to remediate erratic driving characteristics associated with the unsafe driving behavior.

In some aspects, the remediation message comprises a warning notification or a request for the driver to stop the unsafe driving behavior.

In some aspects, the remediation message comprises an automatically generated ticket or infraction instance for the driver, the ticket or infraction instance generated based on license plate information determined for the particular vehicle based on the monitoring information.

In some aspects, the remediation message includes one or more of control commands or configuration information generated for an Advanced Driver Assistance System (ADAS) module of the particular vehicle.

In some aspects, the one or more sensors comprises a plurality of cameras deployed to roadside locations or overhead locations within the roadway environment; and the monitoring information corresponds to respective image data obtained from the plurality of cameras and depicting the one or more vehicles.

In some aspects, the monitoring information comprises a unique identifier or

registration information associated with a vehicle, determined based on detecting license plate information within the respective image data obtained from the plurality of cameras.

In some aspects, the one or more sensors comprises a plurality of beacon devices configured to transmit beacon signals, and a plurality of receiver devices configured to receive transmitted beacon signals; and the monitoring information corresponds to relative position information of one or more receiver devices included in the plurality of receiver devices, the relative position information determined based on measurements of transmitted beacon signals from the plurality of beacon devices.

In some aspects, the plurality of beacon devices includes one or more stationary beacons each associated with a respective location within the roadway environment; and the one or more receiver devices are user computing devices each located within a respective vehicle of the one or more vehicles.

In some aspects, the method further comprises determining one or more of: vehicle position information, vehicle movement information, or vehicle trajectory information for a particular vehicle, the determination based on the relative position information of a corresponding receiver device located within the particular vehicle.

In some aspects, the corresponding receiver device is included in the plurality of receiver devices and comprises a smartphone associated with a driver or a passenger of the particular vehicle.

In some aspects, the plurality of beacon devices includes one or more user computing devices each located within a respective vehicle of the one or more vehicles and configured to transmit a beacon signal including an identifier of the respective vehicle; and the one or more receiver devices are stationary receivers each associated with a configured location within the roadway environment.

In some aspects, the relative position information is further determined based on a configured location determined for a particular beacon device associated with each one of the transmitted beacon signals.

In another illustrative example, an apparatus is provided, where the apparatus comprises at least one memory and at least one processor coupled to the at least one memory, the at least one processor configured to: obtain, from one or more sensors included in a plurality of sensors associated with a roadway environment, monitoring information associated with one or more vehicles; determine real-time mapping information indicative of one or more of movement information or trajectory information of the one or more vehicles, wherein the real-time mapping information is determined based at least in part on correlating each vehicle of the one or more vehicles to respective portions of the monitoring data; detect an unsafe driving behavior for a particular vehicle based on analyzing the real-time mapping information and one or more of historical mapping information obtained for the roadway environment or for the particular vehicle; and transmit, to a driver mobile application associated with a driver of the particular vehicle, a remediation message automatically generated in response to detection of the unsafe driving behavior.

In another illustrative example, a non-transitory computer-readable storage medium is provided and comprises instructions stored thereon which, when executed by at least one processor, causes the at least one processor to: obtain, from one or more sensors included in a plurality of sensors associated with a roadway environment, monitoring information associated with one or more vehicles; determine real-time mapping information indicative of one or more of movement information or trajectory information of the one or more vehicles, wherein the real-time mapping information is determined based at least in part on correlating each vehicle of the one or more vehicles to respective portions of the monitoring data; detect an unsafe driving behavior for a particular vehicle based on analyzing the real-time mapping information and one or more of historical mapping information obtained for the roadway environment or for the particular vehicle; and transmit, to a driver mobile application associated with a driver of the particular vehicle, a remediation message automatically generated in response to detection of the unsafe driving behavior.

In another illustrative example, an apparatus is provided. The apparatus includes: means for obtaining, from one or more sensors included in a plurality of sensors associated with a roadway environment, monitoring information associated with one or more vehicles; means for determining real-time mapping information indicative of one or more of movement information or trajectory information of the one or more vehicles, wherein the real-time mapping information is determined based at least in part on correlating each vehicle of the one or more vehicles to respective portions of the monitoring data; means for detecting an unsafe driving behavior for a particular vehicle based on analyzing the real-time mapping information and one or more of historical mapping information obtained for the roadway environment or for the particular vehicle; and means for transmitting, to a driver mobile application associated with a driver of the particular vehicle, a remediation message automatically generated in response to detection of the unsafe driving behavior.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and embodiments, will become more apparent upon referring to the following specification, claims, and accompanying drawings.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. The use of a same reference numbers in different drawings indicates similar or identical items or features. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a block diagram illustrating an example of a computing system of a user device, in accordance with some examples;

FIG. 2 is a block diagram illustrating an example of a computing system of a vehicle, in accordance with some examples;

FIG. 3 is a diagram illustrating an example road intelligence network deployment scenario that can be configured to monitor vehicle activity on a roadway and/or generate driver assistance information, in accordance with some examples;

FIG. 4 is a diagram illustrating an example road intelligence network deployment scenario that can be configured to monitor vehicle activity on a roadway and/or generate traffic safety notifications, in accordance with some examples;

FIG. 5 is a diagram illustrating an example road intelligence network implemented based on collaborative sensing data associated with a plurality of stationary and/or roadside beacon devices transmitting beacon signals to one or more vehicle-borne receivers, in accordance with some examples;

FIG. 6 is a diagram illustrating an example road intelligence network implemented based on collaborative sensing data associated with a plurality of vehicle-borne beacon devices transmitting beacon signals to one or more stationary and/or roadside beacon receivers, in accordance with some examples;

FIG. 7 is a diagram illustrating an example of a road intelligence network processing system, in accordance with some examples; and

FIG. 8 is a block diagram illustrating an example of a computing system, in accordance with some examples.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without departing from the spirit and scope of the disclosure. Additional features and advantages of the disclosure will be set forth in the description which follows, and in part will be obvious from the description, or can be learned by practice of the herein disclosed principles. It will be appreciated that for simplicity and clarity of illustration, where appropriate, reference numerals have been repeated among the different figures to indicate corresponding or analogous elements. The description is not to be considered as limiting the scope of the embodiments described herein.

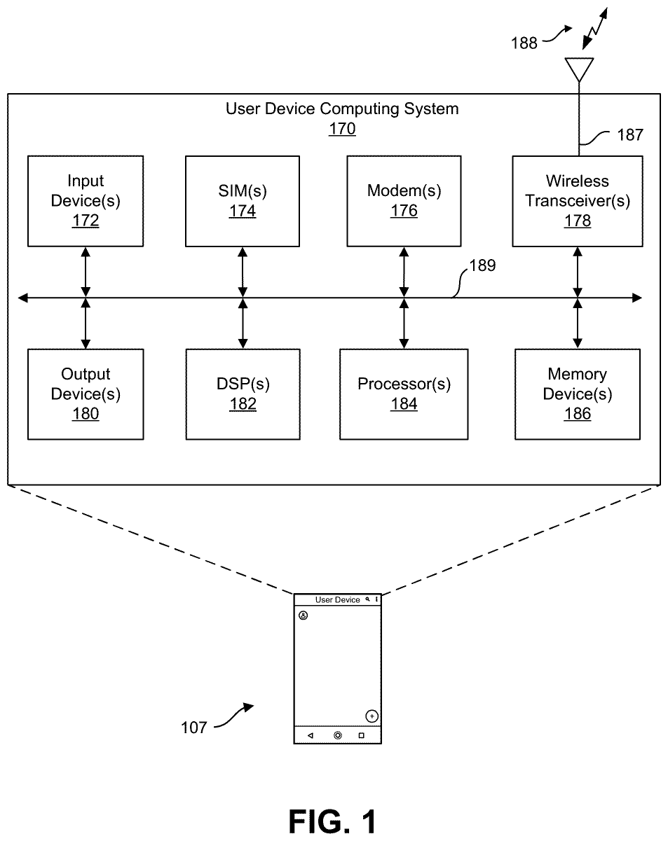

FIG. 1 illustrates an example of a computing system 170 of a user device 107 (or UE). The user device 107 is an example of a UE that can be used by an end-user. For example, the user device 107 can include a mobile phone, router, tablet computer, laptop computer, tracking device, a network-connected wearable device (e.g., a smart watch, glasses, an XR device, etc.), Internet of Things (IoT) device, and/or other device used by a user to communicate over a wireless communications network. The computing system 170 includes software and hardware components that can be electrically or communicatively coupled via a bus 189 (or may otherwise be in communication, as appropriate). For example, the computing system 170 includes one or more processors 184. The one or more processors 184 can include one or more CPUs, ASICs, FPGAS, APs, GPUs, VPUs, NSPs, microcontrollers, dedicated hardware, any combination thereof, and/or other processing device or system. The bus 189 can be used by the one or more processors 184 to communicate between cores and/or with the one or more memory devices 186.

The computing system 170 may also include one or more memory devices 186, one or more digital signal processors (DSPs) 182, one or more SIMs 174, one or more modems 176, one or more wireless transceivers 178, an antenna 187, one or more input devices 172 (e.g., a camera, a mouse, a keyboard, a touch sensitive screen, a touch pad, a keypad, a microphone, and/or the like), and one or more output devices 180 (e.g., a display, a speaker, a printer, and/or the like).

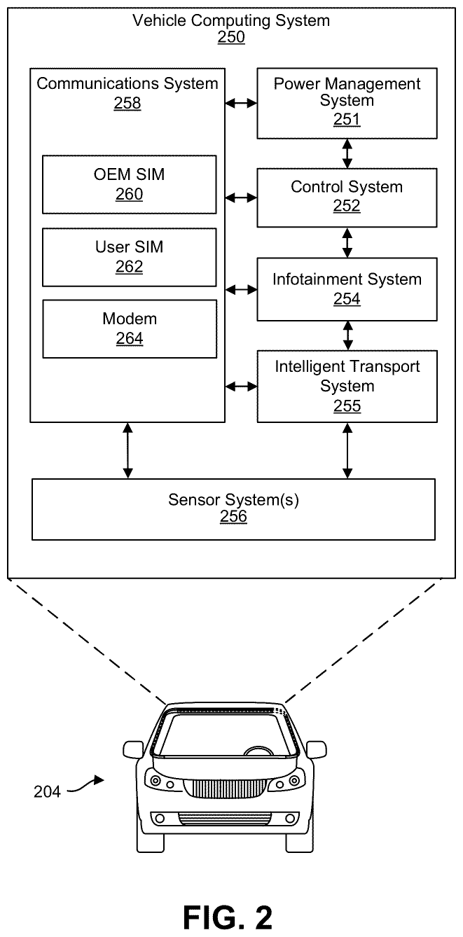

The one or more wireless transceivers 178 can receive wireless signals (e.g., signal 188) via antenna 187 from one or more other devices, such as other user devices, vehicles (e.g., vehicle 204 of FIG. 2 described below, etc.), network devices (e.g., base stations such as eNBs and/or gNBs, WiFi routers, etc.), cloud networks, and/or the like. In some examples, the computing system 170 can include multiple antennae. The wireless signal 188 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 178 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can handle selection and conversion of the wireless signals 188 into a baseband or intermediate frequency and can convert the RF signals to the digital domain.

The one or more SIMs 174 can each securely store an IMSI number and related key assigned to the user of the user device 107. As noted above, the IMSI and key can be used to identify and authenticate the subscriber when accessing a network provided by a network service provider or operator associated with the one or more SIMs 174. The one or more modems 176 can modulate one or more signals to encode information for transmission using the one or more wireless transceivers 178. The one or more modems 176 can also demodulate signals received by the one or more wireless transceivers 178 in order to decode the transmitted information. In some examples, the one or more modems 176 can include a 2G (or LTE) modem, a 1G (or NR) modem, a modem configured for V2X communications, and/or other types of modems. The one or more modems 176 and the one or more wireless transceivers 178 can be used for communicating data for the one or more SIMs 174.

The computing system 170 can also include (and/or be in communication with) one or more non-transitory machine-readable storage media or storage devices (e.g., one or more memory devices 186), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like. In various aspects, functions may be stored as one or more computer-program products (e.g., instructions or code) in memory device(s) 186 and executed by the one or more processor(s) 184 and/or the one or more DSPs 182. The computing system 170 can also include software elements (e.g., located within the one or more memory devices 186), including, for example, an operating system, device drivers, executable libraries, and/or other code, such as one or more application programs, which may comprise computer programs implementing the functions provided by various aspects, and/or may be designed to implement methods and/or configure systems, as described herein.

FIG. 2 is a block diagram illustrating an example a vehicle computing system 250 of a vehicle 204. The vehicle 204 can be an example of a UE that can communicate with a network (e.g., an eNB, a gNB, a positioning beacon, a location measurement unit, and/or other network entity) over a Uu interface and with other UEs using V2X communications over a PC5 interface (or other device to device direct interface, such as a DSRC interface), etc. As shown, the vehicle computing system 250 can include at least a power management system 251, a control system 252, an infotainment system 254, an intelligent transport system (ITS) 255, one or more sensor systems 256, and a communications system 258. In some cases, the vehicle computing system 250 can include or can be implemented using any type of processing device or system, such as one or more central processing units (CPUs), digital signal processors (DSPs), application specific integrated circuits (ASICs), field programmable gate arrays (FPGAs), application processors (APs), graphics processing units (GPUs), vision processing units (VPUs), Neural Network Signal Processors (NSPs), microcontrollers, dedicated hardware, any combination thereof, and/or other processing device or system.

The control system 252 can be configured to control one or more operations of the vehicle 204, the power management system 251, the computing system 250, the infotainment system 254, the ITS 255, and/or one or more other systems of the vehicle 204 (e.g., a braking system, a steering system, a safety system other than the ITS 255, a cabin system, and/or other system). In some examples, the control system 252 can include one or more electronic control units (ECUs). An ECU can control one or more of the electrical systems or subsystems in a vehicle. Examples of specific ECUs that can be included as part of the control system 252 include an engine control module (ECM), a powertrain control module (PCM), a transmission control module (TCM), a brake control module (BCM), a central control module (CCM), a central timing module (CTM), among others. In some cases, the control system 252 can receive sensor signals from the one or more sensor systems 256 and can communicate with other systems of the vehicle computing system 250 to operate the vehicle 204.

In one illustrative example, the control system 252 can include or otherwise integrate/communicate with an ADAS system associated with the vehicle 204.

The vehicle computing system 250 also includes a power management system 251. In some implementations, the power management system 251 can include a power management integrated circuit (PMIC), a standby battery, and/or other components. In some cases, other systems of the vehicle computing system 250 can include one or more PMICs, batteries, and/or other components. The power management system 251 can perform power management functions for the vehicle 204, such as managing a power supply for the computing system 250 and/or other parts of the vehicle. For example, the power management system 251 can provide a stable power supply in view of power fluctuations, such as based on starting an engine of the vehicle. In another example, the power management system 251 can perform thermal monitoring operations, such as by checking ambient and/or transistor junction temperatures. In another example, the power management system 251 can perform certain functions based on detecting a certain temperature level, such as causing a cooling system (e.g., one or more fans, an air conditioning system, etc.) to cool certain components of the vehicle computing system 250 (e.g., the control system 252, such as one or more ECUs), shutting down certain functionalities of the vehicle computing system 250 (e.g., limiting the infotainment system 254, such as by shutting off one or more displays, disconnecting from a wireless network, etc.), among other functions.

The vehicle computing system 250 further includes a communications system 258. The communications system 258 can include both software and hardware components for transmitting signals to and receiving signals from a network (e.g., a gNB or other network entity over a Uu interface) and/or from other UEs (e.g., to another vehicle or UE over a PC5 interface, WiFi interface (e.g., DSRC), Bluetooth™ interface, and/or other wireless and/or wired interface). For example, the communications system 258 is configured to transmit and receive information wirelessly over any suitable wireless network (e.g., a 3G network, 4G network, 5G network, WiFi network, Bluetooth™ network, and/or other network). The communications system 258 includes various components or devices used to perform the wireless communication functionalities, including an original equipment manufacturer (OEM) subscriber identity module (referred to as a SIM or SIM card) 260, a user SIM 262, and a modem 264. While the vehicle computing system 250 is shown as having two SIMs and one modem, the computing system 250 can have any number of SIMs (e.g., one SIM or more than two SIMs) and any number of modems (e.g., one modem, two modems, or more than two modems) in some implementations.

A SIM is a device (e.g., an integrated circuit) that can securely store an international mobile subscriber identity (IMSI) number and a related key (e.g., an encryption-decryption key) of a particular subscriber or user. The IMSI and key can be used to identify and authenticate the subscriber on a particular UE. The OEM SIM 260 can be used by the communications system 258 for establishing a wireless connection for vehicle-based operations, such as for conducting emergency-calling (eCall) functions, communicating with a communications system of the vehicle manufacturer (e.g., for software updates, etc.), among other operations. The OEM SIM 260 can be important for the OEM SIM to support critical services, such as eCall for making emergency calls in the event of a car accident or other emergency. For instance, eCall can include a service that automatically dials an emergency number (e.g., “9-1-1” in the United States, “1-1-2” in Europe, etc.) in the event of a vehicle accident and communicates a location of the vehicle to the emergency services, such as a police department, fire department, etc.

The user SIM 262 can be used by the communications system 258 for performing wireless network access functions in order to support a user data connection (e.g., for conducting phone calls, messaging, Infotainment related services, among others). In some cases, a user device of a user can connect with the vehicle computing system 250 over an interface (e.g., over PC5, Bluetooth™, WiFi™ (e.g., DSRC), a universal serial bus (USB) port, and/or other wireless or wired interface). Once connected, the user device can transfer wireless network access functionality from the user device to communications system 258 the vehicle, in which case the user device can cease performance of the wireless network access functionality (e.g., during the period in which the communications system 258 is performing the wireless access functionality). The communications system 258 can begin interacting with a base station to perform one or more wireless communication operations, such as facilitating a phone call, transmitting and/or receiving data (e.g., messaging, video, audio, etc.), among other operations. In such cases, other components of the vehicle computing system 250 can be used to output data received by the communications system 258. For example, the infotainment system 254 (described below) can display video received by the communications system 258 on one or more displays and/or can output audio received by the communications system 258 using one or more speakers.

A modem is a device that modulates one or more carrier wave signals to encode digital information for transmission, and demodulates signals to decode the transmitted information. The modem 264 (and/or one or more other modems of the communications system 258) can be used for communication of data for the OEM SIM 260 and/or the user SIM 262. In some examples, the modem 264 can include a 2G (or LTE) modem and another modem (not shown) of the communications system 258 can include a 3G (or NR) modem. In some examples, the communications system 258 can include one or more Bluetooth™ modems (e.g., for Bluetooth™ Low Energy (BLE) or other type of Bluetooth communications), one or more WiFi™ modems (e.g., for DSRC communications and/or other WiFi communications), wideband modems (e.g., an ultra-wideband (UWB) modem), any combination thereof, and/or other types of modems.

In some cases, the modem 264 (and/or one or more other modems of the communications system 258) can be used for performing V2X communications (e.g., with other vehicles for V2V communications, with other devices for D2D communications, with infrastructure systems for V2I communications, with pedestrian UEs for V2P communications, etc.). In some examples, the communications system 258 can include a V2X modem used for performing V2X communications (e.g., sidelink communications over a PC5 interface or DSRC interface), in which case the V2X modem can be separate from one or more modems used for wireless network access functions (e.g., for network communications over a network/Uu interface and/or sidelink communications other than V2X communications).

In some examples, the communications system 258 can be or can include a telematics control unit (TCU). In some implementations, the TCU can include a network access device (NAD) (also referred to in some cases as a network control unit or NCU). The NAD can include the modem 264, any other modem not shown in FIG. 2, the OEM SIM 260, the user SIM 262, and/or other components used for wireless communications. In some examples, the communications system 258 can include a Global Navigation Satellite System (GNSS). In some cases, the GNSS can be part of the one or more sensor systems 256, as described below. The GNSS can provide the ability for the vehicle computing system 250 to perform one or more location services, navigation services, and/or other services that can utilize GNSS functionality.

In some cases, the communications system 258 can further include one or more wireless interfaces (e.g., including one or more transceivers and one or more baseband processors for each wireless interface) for transmitting and receiving wireless communications, one or more wired interfaces (e.g., a serial interface such as a universal serial bus (USB) input, a lightening connector, and/or other wired interface) for performing communications over one or more hardwired connections, and/or other components that can allow the vehicle 204 to communicate with a network and/or other UEs.

The vehicle computing system 250 can also include an infotainment system 254 that can control content and one or more output devices of the vehicle 204 that can be used to output the content. The infotainment system 254 can also be referred to as an in-vehicle infotainment (IVI) system or an In-car entertainment (ICE) system. The content can include navigation content, media content (e.g., video content, music or other audio content, and/or other media content), among other content. The one or more output devices can include one or more graphical user interfaces, one or more displays, one or more speakers, one or more extended reality devices (e.g., a VR, AR, and/or MR headset), one or more haptic feedback devices (e.g., one or more devices configured to vibrate a seat, steering wheel, and/or other part of the vehicle 204), and/or other output device.

In some examples, the computing system 250 can include the intelligent transport system (ITS) 255. In some examples, the ITS 255 can be used for implementing V2X communications. For example, an ITS stack of the ITS 255 can generate V2X messages based on information from an application layer of the ITS. In some cases, the application layer can determine whether certain conditions have been met for generating messages for use by the ITS 255 and/or for generating messages that are to be sent to other vehicles (for V2V communications), to pedestrian UEs (for V2P communications), and/or to infrastructure systems (for V2I communications).

In some cases, the communications system 258 and/or the ITS 255 can obtain Controller Area Network (CAN) information (e.g., from other components of the vehicle via a CAN bus). In some examples, the communications system 258 (e.g., a TCU NAD) can obtain the CAN information via the CAN bus and can send the CAN information to a PHY/MAC layer of the ITS 255. The ITS 255 can provide the CAN information to the ITS stack of the ITS 255. The CAN information can include vehicle related information, such as a heading of the vehicle, speed of the vehicle, braking information, among other information. The CAN information can be continuously or periodically (e.g., every one millisecond (ms), every 10 ms, or the like) provided to the ITS 255.

The conditions used to determine whether to generate messages can be determined using the CAN information based on safety-related applications and/or other applications, including applications related to road safety, traffic efficiency, infotainment, business, and/or other applications. In one illustrative example, the ITS 255 can perform lane change assistance or negotiation. For instance, using the CAN information, the ITS 255 can determine that a driver of the vehicle 204 is attempting to change lanes from a current lane to an adjacent lane (e.g., based on a blinker being activated, based on the user veering or steering into an adjacent lane, etc.). Based on determining the vehicle 204 is attempting to change lanes, the ITS 255 can determine a lane-change condition has been met that is associated with a message to be sent to other vehicles that are nearby the vehicle in the adjacent lane. The ITS 255 can trigger the ITS stack to generate one or more messages for transmission to the other vehicles, which can be used to negotiate a lane change with the other vehicles. Other examples of applications include forward collision warning, automatic emergency braking, lane departure warning, pedestrian avoidance or protection (e.g., when a pedestrian is detected near the vehicle 204, such as based on V2P communications with a UE of the user), traffic sign recognition, among others. The ITS 255 can use any suitable protocol to generate messages (e.g., V2X messages). Examples of protocols that can be used by the ITS 255 include one or more Society of Automotive Engineering (SAE) standards, such as SAE J2735, SAE J2945, SAE J3161, and/or other standards, which are hereby incorporated by reference in their entirety and for all purposes.

In some examples, the ITS 255 can determine certain operations (e.g., V2X-based operations) to perform based on messages received from other UEs. The operations can include safety-related and/or other operations, such as operations for road safety, traffic efficiency, infotainment, business, and/or other applications. In some examples, the operations can include causing the vehicle (e.g., the control system 252) to perform automatic functions, such as automatic braking, automatic steering (e.g., to maintain a heading in a particular lane), automatic lane change negotiation with other vehicles, among other automatic functions. In one illustrative example, a message can be received by the communications system 258 from another vehicle (e.g., over a PC5 interface, a DSRC interface, or other device to device direct interface) indicating that the other vehicle is coming to a sudden stop. In response to receiving the message, the ITS stack can generate a message or instruction and can send the message or instruction to the control system 252, which can cause the control system 252 to automatically brake the vehicle 204 so that it comes to a stop before making impact with the other vehicle. In other illustrative examples, the operations can include triggering display of a message alerting a driver that another vehicle is in the lane next to the vehicle, a message alerting the driver to stop the vehicle, a message alerting the driver that a pedestrian is in an upcoming cross-walk, a message alerting the driver that a toll booth is within a certain distance (e.g., within 1 mile) of the vehicle, among others.

In some examples, the ITS 255 can receive a large number of messages from the other UEs (e.g., vehicles, RSUs, etc.), in which case the ITS 255 will authenticate (e.g., decode and decrypt) each of the messages and/or determine which operations to perform. Such a large number of messages can lead to a large computational load for the vehicle computing system 250. In some cases, the large computational load can cause a temperature of the computing system 250 to increase. Rising temperatures of the components of the computing system 250 can adversely affect the ability of the computing system 250 to process the large number of incoming messages. One or more functionalities can be transitioned from the vehicle 204 to another device (e.g., a user device, a RSU, etc.) based on a temperature of the vehicle computing system 250 (or component thereof) exceeding or approaching one or more thermal levels. Transitioning the one or more functionalities can reduce the computational load on the vehicle 204, helping to reduce the temperature of the components. A thermal load balancer can be provided that enable the vehicle computing system 250 to perform thermal based load balancing to control a processing load depending on the temperature of the computing system 250 and processing capacity of the vehicle computing system 250.

The computing system 250 further includes one or more sensor systems 256 (e.g., a first sensor system through an N^{th} sensor system, where N is a value equal to or greater than 0). When including multiple sensor systems, the sensor system(s) 256 can include different types of sensor systems that can be arranged on or in different parts the vehicle 204. The sensor system(s) 256 can include one or more camera sensor systems, LIDAR sensor systems, radio detection and ranging (RADAR) sensor systems, Electromagnetic Detection and Ranging (EmDAR) sensor systems, Sound Navigation and Ranging (SONAR) sensor systems, Sound Detection and Ranging (SODAR) sensor systems, Global Navigation Satellite System (GNSS) receiver systems (e.g., one or more Global Positioning System (GPS) receiver systems), accelerometers, gyroscopes, inertial measurement units (IMUs), infrared sensor systems, laser rangefinder systems, ultrasonic sensor systems, infrasonic sensor systems, microphones, any combination thereof, and/or other sensor systems. It should be understood that any number of sensors or sensor systems can be included as part of the computing system 250 of the vehicle 204.

As noted above, systems and techniques are described herein for implementing a road intelligence network using various combinations of sensor infrastructure, cameras, and/or beacon devices to determine positioning information and driving behavior information relating to a plurality of vehicles traveling on roadways that are configured for monitoring by the presently disclosed road intelligence network.

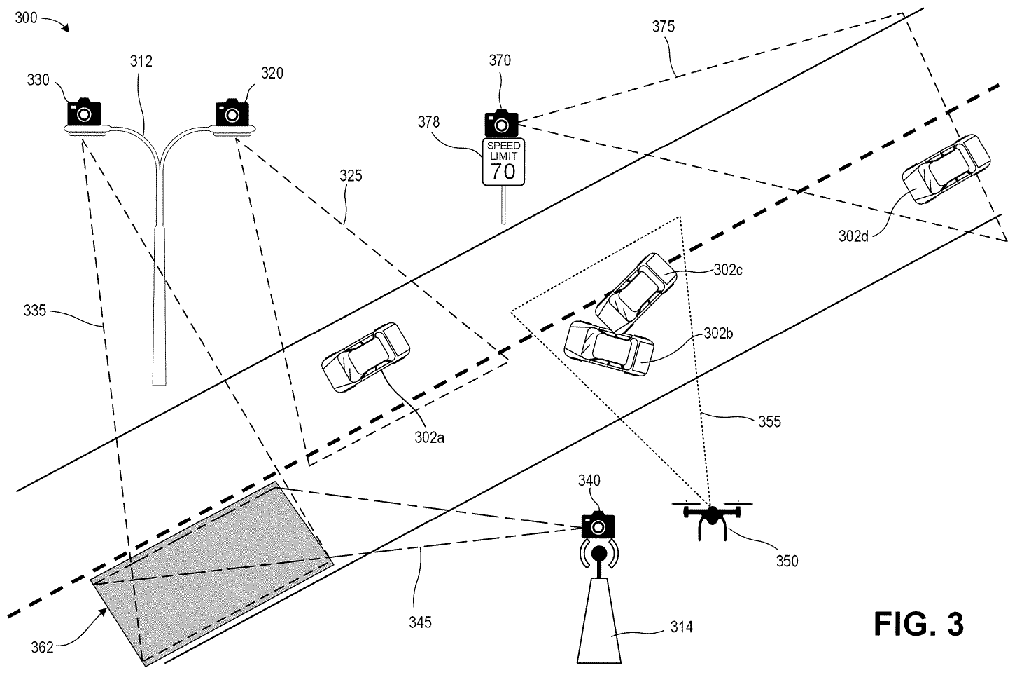

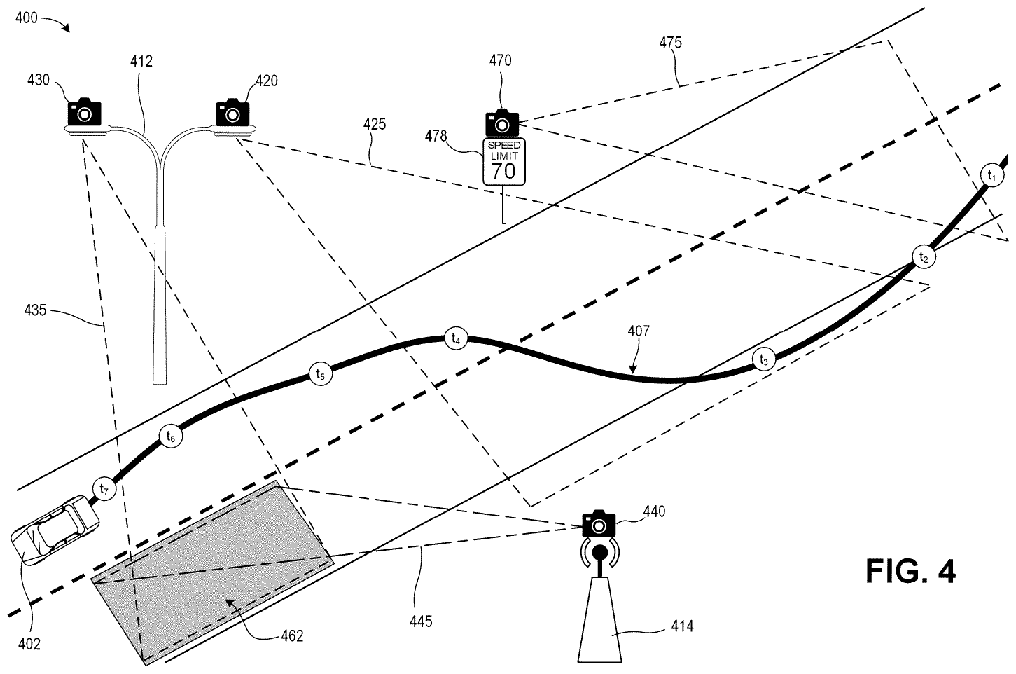

In some embodiments, the road intelligence network can be implemented using a network of distributed, roadside sensors and cameras to obtain sensor and image data indicative of driver registration information, driver monitoring information, license plate information, etc. For example, the road intelligence network can use various artificial intelligence (AI) and/or machine learning (ML) techniques, models, networks, etc., to analyze the distributed sensor data and/or roadside camera data in order to thereby provide road intelligence predictions or determinations that can be used for improved highway safety, monitoring, and administration thereof. Example embodiments of a road intelligence network implemented based on or using roadside camera information and/or distributed roadside sensor information are described below with respect to FIGS. 3 and 4.

In some embodiments, the road intelligence network can be implemented using collaborative sensing and relative positioning techniques that are configured to determine vehicle and/or driver identification, registration, and/or kinematic information without the use of roadside cameras or other image-based data. For example, the road intelligence network can be implemented using collaborative sensing associated with a plurality of beacons or beacon devices that are deployed to static locations on or nearby a roadway surface, and/or that are deployed within one or more vehicles traveling along the roadway surface. In some aspects, a network of beacons and receivers can be used to obtain a real-time understanding or prediction of vehicle positions, movements, and road conditions, without requiring the use of traditional sensor data and/or image data that may be obtained from dedicated roadside sensors and cameras. For example, the network of beacons and receivers can be used to obtain the real-time vehicle position and movement information based on relative positioning measurements determined using calculated distances between fixed beacons and moving receivers, and subsequent triangulation across the plurality of relative positioning measurements performed across the plurality of beacons within the beacon network.

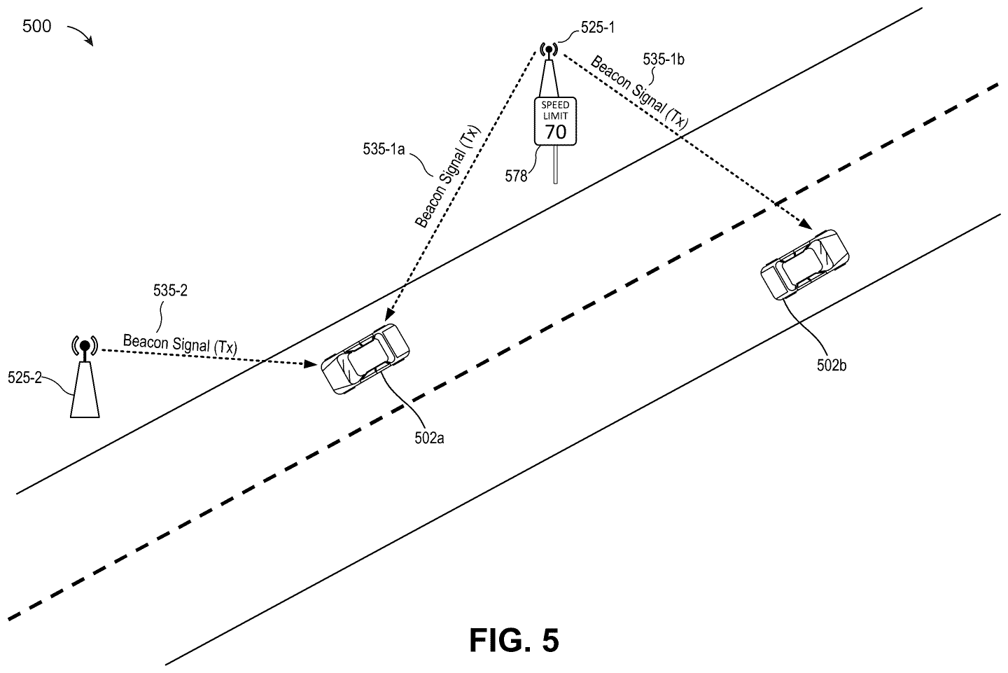

The beacon-based road intelligence network can be used as an alternative to, or an augmentation to, the road intelligence network that is configured to use roadside sensor data and/or roadside camera imagery data. The beacon-based road intelligence network can be associated with enhanced road safety, based on using the real-time information of the mapped vehicle positions, movements, and road positions. For example, the beacon-based road intelligence network can detect bad driving behavior, road damage, presence of foreign objects on the road, etc., among various other highway traffic safety enhancements described in greater detail below. The beacons can be implemented using various wireless communications technologies, standards, protocols, etc. For example, beacons may be implemented using Bluetooth-based beacon signals for relative positioning and related measurements for vehicle-borne receivers; can be implemented using WiFi-based beacon signals for relative positioning and related measurements for vehicle-borne receivers; can be implemented using UWB-based beacon signals for relative positioning and related measurements for vehicle-borne receivers; etc. In one illustrative example, the road intelligence network can perform traffic monitoring and roadway management using a plurality of beacon devices, receiver devices, and distributor devices that form a collaborative sensing network, where the beacons, receivers, and distributors are installed to various locations in, on, and alongside roadways as well as within the vehicles themselves, in order to thereby enable mapping engines of the road intelligence network to make accurate inferences about vehicle/driver positions and movements. Example embodiments of a road intelligence network implemented based on collaborative sensing techniques and/or beacon-based positioning, monitoring, and detection are described below with respect to FIGS. 5-7.

As contemplated herein, the disclosed systems and techniques can be used to implement one or more road intelligence networks using various combinations of data obtained from roadside sensors and cameras, data obtained from a plurality of beacons and beacon receivers provided at various in-vehicle locations and roadside locations, and/or various combinations of both roadside sensor and camera data, and beacon positioning data. Notably, the road intelligence networks contemplated herein can be used to provide improved and more efficient highway traffic safety administration, road safety, traffic management, and driver monitoring. In one illustrative example, the road intelligence network can be used to provide or otherwise implement a first mobile application, available to highway traffic patrol officers or other administrative authorities (e.g., those responsible for enforcing traffic rules and traffic safety, etc.), and a second mobile application, available to registered and/or verified drivers using the road intelligence network system.

Based on the combination of the administrative authority application and the registered driver application, the road intelligence network can be used to provide improved traffic patrol applications and workflows with significantly increased effectiveness in preventing and responding to dangerous drivers, incidents, and accidents. In particular, the road intelligence network(s) described herein can be used to address the problem(s) associated with the existing lack of highway traffic management and intelligence. Existing, un-managed and/or un-monitored (or minimally managed and minimally monitored) highways and other roadway infrastructure are associated with tens of thousands of traffic deaths per year, and hundreds of billions of dollars expended per year on car and truck insurance premiums. In some cases, approximately 20% of highway traffic incidents involve unlicensed or uninsured driving, and in many locations, approximately 30% of highway traffic incidents involve impaired or distracted driving. The systems and techniques described herein can be used to perform automatic driver and safety monitoring to preemptively detect and respond to potential occurrences of unlicensed or uninsured driving behaviors, as well as to preemptively detect and respond to potential occurrences of impaired or distracted driving behaviors. Moreover, the systems and techniques can be used to perform automatic driver and safety monitoring to preemptively detect and respond to unsafe or dangerous situations that do not involve uninsured/unlicensed driving or impaired/distracted driving. Accordingly, the disclosed road intelligence network(s) can advantageously be used to provide increased safety, management, and monitoring to at least a portion of the 91+ billion vehicle driving hours that are currently accumulated every year.

The disclosed road intelligence network systems can additionally provide more centralized and more efficiently coordinated traffic management and flow to improve roadway usage, for instance by reducing congestion, providing intelligent routing or re-rerouting, etc. In some cases, approximately 10-30% of the 90+ billion annual vehicle driving hours are reported as hours that occur in traffic or heavy congestion conditions, which can be caused by approximately 3-5% of total drivers. Accordingly, centralized management and traffic flow coordination provided by the road intelligence network system(s) described herein can be used to stop or prevent bad or illegal driving and to get such drivers off the streets, which can have a major impact in reducing the congestion experienced by the vast majority of the remaining drivers. In some cases, the traffic management and flow coordination associated with the road intelligence network system can be used to provide dynamic and flexible configuration or reconfiguration of roadway infrastructure, to support high congestion traffic flow patterns, temporary and/or dynamic tolled access lanes or roads, temporary and/or dynamic priority access lanes or roads, etc.

In some embodiments, the road intelligence network system can integrate and communicate with a vehicle Controller Area Network (CAN) and/or a vehicle CANbus for accessing the vehicle CAN. In some aspects, the road intelligence network system can integrate and communicate with a vehicle Advanced Driver Assistance Systems (ADAS). As noted previously, ADAS levels can be used to classify the autonomy systems of vehicles based on their respective capabilities. ADAS levels can refer to the set of six levels (0 to 5) defined by the Society of Automotive Engineers (SAE), or may be used more generally to refer to different levels and/or extents of autonomy. The six ADAS levels categorized by the SAE include Level 0 (No Automation), Level 1 (Driver Assistance), Level 2 (Partial Automation), Level 3 (Conditional Automation), Level 4 (High-Level Automation), and Level 5 (Full Automation). As used herein, in some aspects, an AV can refer to a vehicle that corresponds to any one of the six ADAS levels categorized by the SAE, which are summarized below:
Level 0 (No Automation): No automated vehicle control actions. All tasks are performed by the human driver, although warnings or assistive information can be issued by the ADAS system.
Level 1 (Driver Assistance): Single-task automation. For example, adaptive cruise control, lane following, etc. The human driver is responsible for all other aspects of driving, including monitoring the environment.
Level 2 (Partial Automation): Multiple-task automation, such as steering and acceleration, but the human driver is required to remain engaged and to monitor the environment at all times.
Level 3 (Conditional Automation): The vehicle itself is able to handle all major aspects of driving within specified conditions or operational design domains. Human intervention may be required when the conditions are no longer met, which can occur abruptly, and the driver must be available to take over.
Level 4 (High-Level Automation): The vehicle can handle all aspects of driving within its operational design domain, even if human intervention is needed, and the vehicle is able to safely come to a stop autonomously if the driver fails to respond.
Level 5 (Full Automation): Steering wheel, pedals, other human input or control components are not needed. The vehicle is capable of all driving tasks under all conditions and environments.

### Road Intelligence Network: Roadside Cameras and Distributed Sensing Infrastructure

As used herein, the various roadway locations to which the one or more sensors of the road intelligence network infrastructure can be deployed may refer to fixed or static locations, as well as movable or dynamic locations. For instance, a first subset of a plurality of roadway sensor locations may comprise static deployment locations where sensors are mounted on poles, signage, bridges or overpasses, adjacent building structures, power poles, telecommunications or cellular towers, etc. The static deployment locations can be provided by existing roadway or roadside infrastructure, as well as by purpose-built or purpose-installed infrastructure designed to deploy the one or more sensors. A second subset of the plurality of roadway sensor locations can comprise movable deployment locations, where sensors are deployed in combination with a movable device such as a drone, etc. that can be configured or controlled to position itself in various different locations with respect to roadway surfaces. In some embodiments, the term “roadway location” (e.g., associated with a deployment location of one or more sensors of the road intelligence network) may refer to a sensor deployment location that is adjacent to or nearby a roadway surface, but remains separate from the roadway surface itself. In some aspects, the term “roadway location” may additionally, or alternatively, refer to a sensor deployment location that is on the roadway surface, integrated into the roadway surface, etc. For instance, a roadway location deployment could include wireless or radio receivers that are integrated into the roadway surface and used to receive wireless positioning signals from vehicles traveling thereon, in order to provide highly precise and accurate localization and/or relative positioning information of one or more vehicles on the roadway surface.

In one illustrative example, the systems and techniques described herein can be used to implement a road intelligence network infrastructure of distributed sensors configured to obtain a plurality of sensor data feeds or sensor streams of information that can be used to determine road intelligence information and/or predictions, corresponding to one or more of a set of vehicles traveling on a roadway location, a set of drivers or passengers located within particular vehicles or roadway locations, traffic conditions for roadway locations, driving safety or driving violations information, etc. In some cases, the road intelligence information and/or predictions may include, or otherwise be used to determine, various types of driver assistance information, including one or more driver assistance messages that can be delivered to a user computing device (e.g., smartphone, in-vehicle entertainment or communication system, etc.) associated with a specific driver or other registered user of the road intelligence network system. As used herein, both AV control information (e.g., used to directly control the movement, navigation, driving, etc., of a vehicle in either an autonomous or semi-autonomous manner) and vehicle assistance information (e.g., provided to a human driver to inform or recommend manual control or driving actions) can be collectively referred to as “ADAS information,” “driving assistance information,” and/or “assistance information.”

In another illustrative example, the systems and techniques described herein can be used to implement the road intelligence network infrastructure of distributed sensors in order to implement one or more automated highway traffic safety administration and/or predictive traffic features. In various embodiments, the road intelligence network systems and techniques can be used to implement both automatically generated driving assistance information that is transmitted to vehicles traveling on a monitored roadway surface, as well as to implement one or more automated highway traffic safety administration notifications. For instance, as will be described in greater depth below, traffic safety notifications can be transmitted and/or otherwise combined with one or more interfaces for local authorities able to take appropriate action in response to a traffic safety notification or traffic event.

As will be described in greater depth below, a road intelligence network can be used to capture or obtain a plurality of sensor data streams from a corresponding plurality of sensors and/or other devices that are deployed to various roadway or roadside locations. In some aspects, the road intelligence network can include a distributed sensor infrastructure that is provided adjacent to or otherwise nearby to one or more road surfaces where vehicles will travel, or are anticipated to be traveling. In some embodiments, existing road and highway infrastructure can be augmented (e.g., upgraded) to include at least a portion of the sensor infrastructure associated with the presently disclosed road intelligence network. In some examples, at least a portion of the road intelligence network sensor infrastructure can be integrated with a road or highway at the time of construction (e.g., designed integration vs. retro-fit).

In one illustrative example, the road intelligence network sensor infrastructure includes a plurality of sensors or sensing devices, each associated with a corresponding deployment location that is nearby or otherwise associated with a road surface. The sensor deployment locations can also be referred to herein as “external sensing locations,” based on the fact that the sensor deployment locations are external to (e.g., remote from) a sensor payload that may be included on a vehicle or AV that uses the road surface. In some aspects, the external sensing locations can be fixed or static (e.g., on lampposts, streetlights, or other elevated infrastructure components above the street level, etc.) or may also be mobile (e.g., integrated on or carried as a payload by one or more drones or unmanned aerial vehicles (UAVs), etc.)

For instance, FIG. 3 is a diagram illustrating an example road intelligence network deployment scenario 300 that can be configured to monitor vehicle activity on a roadway and/or generate driver assistance information, in accordance with some examples. In particular, the example road intelligence network deployment 300 of FIG. 3 corresponds to a portion of roadway infrastructure (e.g., here, a two-lane road surface with both travel lanes in the same direction) that is monitored by a plurality of distributed sensors provided adjacent to the roadway and/or otherwise within the vicinity or nearby environment of the roadway subject to the monitoring.

As illustrated, a first sensor deployment location comprises a streetlamp 312 (e.g., among various other existing highway and roadside infrastructure upon which sensors may be installed or deployed), which is configured or retrofitted with a first camera or imaging sensor 320 and a second camera or imaging sensor 330. Each of the cameras/imaging sensors 320, 330 is associated with a respective field of view (FOV) of a portion of the roadway surface. For instance, the first camera 320 can be used to capture images and/or video corresponding to a field of view 325. The second camera 330 can be used to capture images and/or video data corresponding to a field of view 335. It is noted that the FOVs 325, 335 shown in FIG. 3 are depicted for illustrative purposes only and are not intended to be construed as limiting-cameras and imaging sensors or devices can be configured with various different FOVs and other imaging parameters and characteristics without departing from the scope of the present disclosure.

In some aspects, a camera FOV (e.g., FOV 325, 335 of FIG. 3, etc.) can be a static or fixed FOV. That is, the camera FOV may be non-adjustable without physically repositioning the camera upon the streetlamp 312 and/or may be non-adjustable without changing a lens or other camera intrinsic parameter of the corresponding camera device. In other examples, a camera FOV (e.g., FOV 325, 335, etc.) can be a dynamic or adjustable FOV. For instance, one or more (or both) of the cameras 320, 330 may be repositioned based on a remote control command, based on a programmed movement or panning sequence, based on motion detection or other image/object recognition ML models running locally onboard the camera, etc. The automatic repositioning of the camera 320, 330 can correspond to an automatic adjustment to the corresponding FOV captured by the camera. Panning the camera left or right can move the camera FOV to the left or the right; tilting the camera up or down can move the camera FOV up or down; etc. Camera FOV may additionally, or alternatively, be automatically adjusted based on modifying a zoom level of the camera-zooming in can reduce the camera FOV, zooming out can increase the camera FOV, etc. Adjustments to a camera zoom level may be implemented as optical zoom, digital zoom, or a combination thereof.

In some embodiments, multiple cameras or other sensors of the road intelligence network disclosed herein can be installed upon the same roadside infrastructure (e.g., such as the two cameras 320, 330 installed upon the same roadside streetlamp 312). In some aspects, cameras and other sensors of the road intelligence network can be installed upon various different types and configures of roadside infrastructure. For example, a third camera 340 may be installed upon a cellular (or other wireless communications) tower 314 that is within the roadside environment or otherwise generally within the vicinity of the road surface (e.g., such that the camera or other sensor installed thereupon has line of sight to at least a portion of the road surface, or is otherwise within sufficient range to capture the desired or intended sensor data corresponding to the road surface and vehicles traveling thereupon).

In some embodiments, the cellular tower 314 may also be referred to as a cellular base station or a wireless network entity, and can include (but is not limited to) a 3G/LTE eNB, a 5G/NR gNB, etc. In one illustrative example, the cellular tower 314 can be associated with a wireless communication network (e.g., a cellular network) that is the same as or similar to the wireless network 100 of FIG. 1. In some embodiments, the cellular tower 314 and associated cellular network can be used to provide a data network backhaul for communicatively coupling the distributed sensor network (e.g., the plurality of sensors) of the road intelligence network described herein. For instance, the cellular tower 314 and associated cellular network of FIG. 3 can provide backhaul internet connectivity, or various other data network backhaul connectivity, among some or all of the various distributed sensors depicted in FIG. 3. In one illustrative example, the cellular tower 314 and associated cellular network can be used to provide backhaul connectivity between one or more (or all) of the first camera 320, the second camera 330, the third camera 340, a fourth camera (or radar, lidar, etc.) sensor unit 370, a drone (or UAV, UAS, etc.) 350, etc. Backhaul internet or other data network connectivity be implemented for the presently disclosed road intelligence network and/or distributed sensor infrastructure using one or more of a satellite internet constellation connectivity, wired fiber (e.g., fiber optic cable-based) connectivity, public or private cellular network connectivity, visible-light based communications, etc.

In some aspects, it is contemplated that at least a portion of the distributed sensor system (e.g., the roadside infrastructure comprising the cameras 320, 330, 340, 370 and drone 350 of FIG. 3) can include one or more communications means that are configured to provide direct communications between the distributed sensor system and one or more vehicles within the same environment or area as the distributed sensor(s) of the system. For instance, in addition to passively observing any vehicles traveling on the road surface as they pass through the corresponding camera FOV 325 of camera 320 (e.g., such as vehicle 302a, shown in FIG. 3 as being located fully within the camera FOV 325), the camera 320 can be configured to transmit one or more communications directly to the vehicle 302a. In some embodiments, communications between the distributed sensor system and one or more of the vehicles 302a, 302b, 302c, 302d can be implemented based on various radio (e.g., RF, wireless, etc.) communications protocols, standards, systems, techniques, etc.; can be implemented using various laser-based and/or light-based communications systems, protocols, standards, techniques, etc.; can be implemented using various sound-based communications systems, protocols, standards, techniques, etc.; among various others.

As will be described in greater detail below, the one or more communications can be indicative of driver assistance or monitoring information, which may be derived (by the camera 320 or by a remote/cloud-based analysis engine of the road intelligence network) based on the sensor data captured by the camera 320 itself, may be derived based on sensor data captured by other sensors of the same road intelligence network, and/or may be derived based on any combination(s) thereof. In some embodiments, the backhaul communications network or link used to connect the distributed sensor network and/or other components of the road intelligence network 300 can be used to enable remote monitoring functionality of the road intelligence analysis engine, to enable driving assistance or driving configuration/control (e.g., ADAS configuration/control) functionality of the road intelligence analysis engine, etc. In some aspects, the one or more communications can be indicative of traffic safety notifications or traffic safety monitoring/alert information, which will be described in greater detail with respect to the example of FIG. 4. Similarly, however, the traffic safety information may also be derived (by the camera 320 or by a remote/cloud-based analysis engine of the road intelligence network) based on the sensor data captured by the camera 320 itself, may be derived based on sensor data captured by other sensors of the same road intelligence network, and/or may be derived based on any combination(s) thereof.

In some aspects, the presently disclosed road intelligence network can be implemented based on a plurality of local roadside sensor clusters or sensor deployments being connected to a centralized traffic and/or driver monitoring and analysis engine configured to generate various levels of driver assistance information and/or ADAS control or configuration information. In some aspects, the example deployment scenario 300 of FIG. 3 can correspond to a single roadside sensor cluster, which is deployed and configured to obtain streaming sensor data and perform monitoring thereof for the portion of the road surface that is within range of (e.g., covered by the camera FOVs and/or sensor detection areas) the respective roadside sensor cluster.

In one illustrative example, one or more sensor systems (e.g., with a sensor system comprising one or more sensors, of either same or different types in cases where the sensor system includes multiple sensors) can be installed onto lampposts, streetlights, or other elevated infrastructure components at a regular (or semi-regular) interval along the length of a roadway. For instance, the cameras 320, 330 can be installed onto the streetlight 312 at a first deployment location along the roadway surface shown in FIG. 3. The third camera 340 can be installed onto an elevated portion of the cellular tower 314, at a second deployment location along the roadway surface that is different from the first deployment location (e.g., different horizontal position along the road length, different side of the road, different height of installation, different setback or distance from the edge of the road surface, etc.).

The fourth camera 370 can be installed onto a roadside signpost 378, shown here as a speed limit sign (although various other roadside signs, posts, infrastructure, etc., can also be utilized), provided at a third deployment location along the roadway surface that is different from both the first and the second deployment locations. A fifth camera can be included in or carried as a payload sensor by a drone 350, shown in FIG. 3 as being provided at a movable deployment location along the roadway surface (e.g., the current or instantaneous location of the drone on its flightpath above and/or nearby to the roadway surface). Movable or dynamic sensor deployment locations, such as that provided by the drone 350, will be discussed in greater detail below.

In some aspects, one or more cameras, radars, and/or other sensor systems associated with providing vehicle-related sensing and control (e.g., AV-related, ADAS-related, driver monitoring-related, etc.) can be installed onto every lamppost (e.g., such as lamppost 312 of FIG. 3), every other lamppost, etc., along a given street or roadway. In some embodiments, the cameras, radars, and/or other sensor systems contemplated herein can be integrated into a single module or housing for more efficient installation above the roadway. For instance, the camera 370 installed on the speed limit sign 378 may be combined or otherwise integrated with a radar sensor unit within a single or shared housing, such that the multi-sensor housing is installed upon the speed limit sign 378 and provides a deployment of the multiple sensors contained therein (e.g., at least the camera 370 and the radar sensor unit, etc.). In another example, the multiple cameras 320, 330 shown in FIG. 3 as installed in two separate locations or relative positions on the streetlight 312 may alternatively be integrated into a combined housing or sensor module that requires only a single installation to be performed on streetlight 312 in order to deploy at least the two cameras 320, 330 for monitoring the roadway surface.

In some embodiments, one or more sensor systems can be installed in the street and on the ground. In other examples, the sensor systems can be installed so that the sensors stay proximate (e.g., within a threshold, predetermined distance, etc.) to a location. In some embodiments, there are a plurality of vehicles driving around a particular location/area with sensors located in the vehicles. For instance, reference made herein to a vehicle or AV may refer to one or more (or all) of the various vehicles 302a, 302b, 302c, 302d that are shown on and within the monitored roadway surface region of the road intelligence network 300 of FIG. 3. The different vehicles are shown to illustrate different example monitoring and driver assistance/ADAS configuration information generation scenarios that can be implemented using the presently disclosed road intelligence network. For instance, the first vehicle 302a can be monitored by at least the camera 320 while the first vehicle 302a is located within the corresponding camera FOV 325 (e.g., while traveling on the roadway surface within the area or region of the camera FOV 325). The fourth vehicle 302d can be monitored by at least the camera/radar unit 370 while passing through or located within the corresponding camera/radar FOV 375.

In one illustrative example, the different sensor deployment locations within a given roadside environment or roadside area such as that shown in FIG. 3 can communicate amongst one another and perform information sharing from “upstream” sensors/sensor deployment locations to “downstream” sensors/sensor deployment locations. An upstream sensor or sensor deployment location is closer to an origin point of vehicle traffic than a downstream sensor or sensor deployment location, and the classification of upstream vs. downstream can be based on the direction of travel. For instance, the example of FIG. 3 corresponds to a direction of travel that is from the right to the left (e.g., vehicle 302a is “ahead” of the vehicles 302b, 302c which are themselves “ahead” of the vehicle 302d). The speed camera/radar sensor 370 can be considered an “upstream” sensor and sensor deployment location relative to both the camera 340/cell tower 314 and the streetlight 312/cameras 320 and 330. The camera 340/cell tower 314 can be considered “upstream” of the streetlight 312/cameras 320 and 330. Similarly, the streetlight 314/cameras 320 and 330 may be considered “downstream” from both the cell tower 314/camera 340 and the speed sign 378/camera 370. The cell tower 314/camera 340 is also itself “downstream” from the speed sign 378/camera 370.

In some embodiments, communications and information sharing from upstream sensors/locations to downstream sensors/locations can be implemented in order to provide priors (from the upstream sensor(s)) to the downstream sensor(s), where the provided priors are indicative of information such as the particular vehicles and/or driving or traffic behavior that the downstream sensor locations should expect to see in the near future (i.e., once the vehicle travels the distance separating the upstream sensor location from the downstream sensor location).

For instance, the speed camera/radar 370 is the most upstream sensor deployment location shown in FIG. 3, and has a corresponding FOV 375 that spans the entire width of the two traffic lanes of the monitored roadway surface. Accordingly, the speed camera/radar 370 captured sensor information of vehicles detected or monitored within the FOV 375 may be shared to the downstream sensors (e.g., camera 340, 330, 320, etc.) prior to the respective vehicle entering the corresponding camera FOVs 345, 335, 325, respectively.

Notably, the information sharing and communications between neighboring sensors and sensor deployment locations in a roadside environment (e.g., information sharing and communications from upstream sensors 370, 350, and/or 340 to the respective downstream sensors 350, 340, 320, and/or 330) can be used to enable more effective and efficient interpretation of sensor data at the downstream sensor deployment locations. For instance, if the speed camera/radar sensor 370 detects that vehicle 302d is traveling at a very high rate of speed (e.g., 115 mph or some other speed far in excess of the posted 70 mph speed limit 378), the information sharing to provide a prior from camera 370 to the cameras 320, 330 can cause the cameras 320, 330 to take appropriate configuration changes in anticipation of monitoring the vehicle indicated in the prior (e.g., the speeding vehicle 302d). In some aspects, sensor modification or configuration changes based on upstream priors information sharing can include actions such as increasing frame rate or resolution of the cameras 320, 330 (e.g., increased from a default low value utilized to minimize bandwidth or storage consumption, to a relatively high or maximum value in anticipation of using a captured image to generate an automatic speeding ticket, etc.).

As noted previously, based on the installation of the sensor system modules at an elevated location above a roadway, each sensor system can be associated with a known field of view (FOV) (e.g., such as the known FOVs 325, 335, 345, 355, 375 of FIG. 3). For example, the sensor system module can be installed in a downward orientation, such that the camera(s) and radar(s) included on the sensor system module capture sensor data corresponding to one or more vehicles, pedestrians, etc., moving along the roadway surface in the FOV below the sensor system module. In some embodiments, each sensor system module can be associated with a corresponding coverage area within the surrounding or local environment in which aspects of the present disclosure are implemented. For example, the coverage area of each sensor system module can be the FOV of the sensor system module (e.g., which can be determined based on a combination of the height of the sensor system above the roadway surface, the angular field of view of the sensor(s) included in the sensor system, the resolution of the sensor(s) included in the sensor system, etc.).

In some embodiments, each installed sensor system module can be associated with a geographic location or coordinate (e.g., GPS coordinate) that can be used, along with intrinsic information of the discrete sensors within the sensor system module, to determine a total coverage area provided by a plurality of installed sensor system modules. In some cases, an installation height and/or an installation interval between adjacent installed sensor system modules can be determined to provide continuous coverage of a roadway surface of interest. For example, given the spacing of existing streetlights, lampposts, traffic lights, power poles, etc. (collectively referred to herein as “infrastructure elements”), an installation height can be determined for each infrastructure element that will result in continuous coverage of the roadway surface.

In some aspects, continuous coverage can be obtained based on an overlapping FOV between adjacent installed sensor system modules, such that a vehicle enters the FOV of a second sensor system module before exiting the FOV of a first sensor system module. For instance, the example of FIG. 3 depicts an overlapping FOV monitoring area 362 that comprises an intersection or union between the camera 330 FOV 335 (originating from a first location on a first side of the road) and the camera 340 FOG 345 (originating from a different, second location on the opposite side of the road). In some aspects, the overlapping FOV monitoring area 362 can be utilized for a more comprehensive, thorough, detailed, etc., monitoring or other analysis of the vehicles that travel within and through the overlapping FOV monitoring area 362. For instance, by capture the same vehicle from multiple different perspectives/angles/FOVs while the vehicle travels within the overlapping FOV monitoring area 362, additional and/or more detailed information can be determined corresponding to the vehicle and/or the driver of the vehicle. In some aspects, the overlapping FOV monitoring area 362 can be a pre-determined or specifically configured area on the roadway surface that is selected for enhanced monitoring via the multiple sensors and multiple sensor FOVs that capture monitoring information. In other words, the deployment of the cameras 340, 330 that are associated with the overlapping FOV monitoring area 362 can be configured or designed to achieve a desired FOV overlap for enhanced monitoring within a desired area or portion of the roadway surface (e.g., the desired area of road surface being the same as, or included within, the overlapping FOV monitoring area 362).

It is further noted that although reference is made herein to a “roadway surface,” this is done for purposes of example, and it is contemplated that the presently disclosed sensor system modules can be installed to provide coverage of any surface that is suitable for vehicle travel (e.g., parking lots, dirt or gravel roads, grassy fields used for stadium and event parking, driveways, etc.). As used herein, “roadway surface” may also refer to both the surface upon which vehicles are driven (whether paved or otherwise) as well as adjacent pedestrian areas, which can include, but are not limited to, sidewalks, medians, shoulders, emergency or breakdown lanes, etc.

In some embodiments, one or more (or all) of the plurality of sensor system modules can utilize solar power and/or mains power. For example, a sensor system module can include one or more solar panels or solar arrays that can be used to provide electrical power for the sensor system module (which may include a battery for storing electrical power). In some aspects, a sensor system module can be connected to the same electrical grid that powers a streetlight (e.g., streetlight 312) or traffic to which the sensor system module is mounted. In other cases, a sensor system module can be installed on a power pole and may be connected to electrical power via one or more appropriate interfaces between the sensor system module and the electrical supply lines carried by the power pole. In some aspects, a sensor system module can be installed in various locations above the roadway (e.g., on various infrastructure elements) and be connected to electrical power via a dedicated connection.

In one illustrative example, the sensor system modules can be communicatively coupled to one or more computational systems for processing the sensor data obtained by the sensor system modules. For example, in some cases, one or more (or all) of the sensor system modules can include local computational capabilities for processing the respective sensor data captured by each sensor system module. In other examples, one or more (or all) of the sensor system modules can be associated with a remote compute node that is external to the sensor system module(s). For example, if a plurality of sensor system modules are installed along a 5-mile stretch of roadway, a remote compute node may be installed at a regular or semi-regular interval (e.g., every block, every other block, every mile, etc.) that is larger than the interval at which the sensor system modules are installed (e.g., each remote compute node can obtain and process collected sensor data from multiple different sensor system modules).

The sensor system modules can communicate with a remote compute node via a wired connection and/or via a wireless connection. Various wireless communications standards, protocols, and implementations may be utilized, as noted and described previously above. The computational systems contemplated herein (e.g., whether integrated compute provided at each sensor system module, a remote compute node installed in combination with each sensor system module, and/or a remote compute node communicatively coupled to multiple different sensor system modules) can be powered via the same electrical connections used to power the sensor system modules, as described previously above.

### Road Intelligence Network: Driver Assistance Based on Distributed Sensor Data

Based on the installation of a plurality of sensor system modules, a robust understanding of the location(s) of one or more vehicles, pedestrians, and/or other objects within the covered area can be obtained by processing and analyzing the captured sensor data using the corresponding computational systems associated with the plurality of sensor system modules. In some aspects, the term “covered area” may refer to the combined or composite FOV obtained by combining the discrete FOVs captured by each individual sensor system module of the plurality of sensor system modules. For example, the “covered area” or “monitored area” of the road intelligence network deployment 300 of FIG. 3 can correspond to the combination (e.g., union, intersection, etc.) of the discrete camera and/or sensor FOVs 325, 335, 345, 355, 375 that are shown in FIG. 3. In other examples, the term “covered area” or “monitored area” may refer to the discrete FOV captured by an individual sensor system module—e.g., in this example, each of the individual FOVs 325, 335, 345, 355, 375, and/or the overlapping FOV area 362 can be referred to as respective “covered areas” or “monitored areas.”

In some aspects, it is contemplated that the sensor data can be processed jointly (e.g., for multiple ones, or all, of the installed sensor system modules in a given area) to generate a composite FOV in which autonomous vehicle control can be implemented. For example, a composite FOV can be associated with the entire covered area in which sensor system modules are installed, or multiple composite FOVs can each be associated with a sub-section of an overall covered area in which sensor system modules are installed (e.g., a composite FOV can be generated and processed on a block-by-block basis, or some other interval greater than the spacing interval between adjacent ones of the installed sensor system modules).

It is also contemplated that the sensor data may be processed individually (e.g., for individual ones of the installed sensor system modules) to generate a corresponding plurality of processed FOVs in which autonomous vehicle control can be implemented. For example, a first FOV associated with a first sensor system module can be processed separately from a second FOV associated with a second sensor system module adjacent to the first sensor system module. For instance, the sensor streaming data from camera 320 and FOV 325 can be processed separately to determine or otherwise obtain monitoring information corresponding to the first vehicle 302a. The sensor data from camera 370 and FOV 375 can be processed separately to determine or otherwise obtain monitoring information corresponding to the fourth vehicle 302d. The sensor streaming data from drone-based camera 350 and the movable FOV 355 can be processed separately to determine or otherwise obtain monitoring information corresponding to the second and third vehicles 302b, 302c and/or to obtain monitoring information or generate traffic safety alert information corresponding to the accident/collision shown between the vehicles 302b and 302c.

When a vehicle is detected within the first FOV (e.g., based on sensor data captured by the first sensor system module), one or more autonomous vehicle controls or other monitoring functions can be implemented for the vehicle while it remains within the first FOV associated with the first sensor system module. When the vehicle exits or begins to move out of the first FOV (e.g., and into the adjacent second FOV associated with the second sensor system module), a handover can occur between the first and second sensor system modules. During the handover, the one or more vehicle controls or other monitoring functions can transition to being implemented for the vehicle based on processing and analyzing the sensor data captured by the second sensor system module, rather than the sensor data captured by the first sensor system module. In some aspects, handover can be associated with control information, telemetry data, or other control metadata generated by the first sensor data being provided as input to the second sensor system module (e.g., when the vehicle moves from the first FOV to the second FOV, the first sensor system module can provide the second sensor system module with state information of the vehicle, such as current speed, heading, and/or currently executed autonomous navigation/control command).

In some aspects, the computational systems described herein (e.g., the local or remote compute associated with each sensor system module and utilized to process and analyze the corresponding captured sensor data) can be used to learn, over time, one or more patterns of traffic flow or other traffic information associated with a particular FOV of a covered area. For example, patterns of traffic flow and other traffic information can be learned in association with an FOV captured by a single sensor system module (e.g., in the example in which each sensor system module's FOV is processed separately) and/or can be learned in associated with a combined FOV captured by multiple sensor system modules in a contiguous geographic area (e.g., in the example in which multiple sensor system module FOVs are fused or otherwise jointly processed for a composite covered area). In one illustrative example, the overlapping FOV area 362 covered by cameras 330 and 340 can be configured as a monitored area 362 for learning traffic behaviors and/or traffic flows and patterns over time, based on observing vehicle travel behaviors and parameters within the constant monitoring location provided by the overlapping FOV area 362.

In some embodiments, vehicles, pedestrians, and/or other objects that are moving (or otherwise present) within an FOV captured by one or more sensor system modules can be tracked using one or more machine learning (ML) networks and/or artificial intelligence (AI) networks. In some cases, machine vision can be used to automatically detect and classify moving objects using one or more images captured by a camera or other sensor(s) included in the sensor system module. For example, machine vision can be used to automatically detect vehicles, pedestrians, animals, etc., using one or more images captured by the sensor system module. In some aspects, the one or more images captured by the sensor system module can include one or more of visible light images (e.g., RGB or other color spectrum images), infrared images, etc. For example, visible light images can be used to perform object detection and classification based on visual characteristics such as shape, color, etc., and may be combined with thermal (e.g., infrared) imaging that may be used to better differentiate vehicles and pedestrians from the background features of the environment based on the corresponding thermal signature(s) of vehicles and pedestrians.

The one or more images can be provided as input to a computer vision system and/or a trained ML network, which can detect and classify (and/or identify) one or more objects of interest. As utilized herein, objects of interest can refer to vehicles, pedestrians, animals, and/or other objects that may be present in or near the roadway being monitored. In some examples, the computer vision system and/or trained ML network can determine one or more unique identities for each detected object of interest, such that each detected object of interest can be tracked over time. For example, rather than performing a discrete object detection and classification task for each captured frame of image data, the object detection and classification task can be performed over time, such that an object previously detected and classified in a previous frame is detected and associated with an updated location/position in subsequent frames. Such an approach can be used to track the movement of a vehicle, pedestrian, or other object of interest over time and through/within the FOV associated with the currently analyzed covered area.

In some embodiments, the systems and techniques described herein can utilize one or more neural networks to perform detection and tracking of vehicles and other objects of interest within the FOV captured by one or more sensor system modules for a given covered area (e.g., recalling that a given covered area can correspond to the FOV of a single sensor system module or the combined FOV of multiple sensor system modules). The one or more neural networks disclosed herein can be provided as recurrent networks, non-recurrent networks, or some combination of the two, as will be described in greater depth below. For example, recurrent models can include, but are not limited to, recurrent neural networks (RNNs), gated recurrent units (GRUs), and long short-term memory (LSTMs). Additionally, the one or more neural networks disclosed herein can be configured as fully connected network networks, convolutional neural networks (CNNs), or some combination of the two.

In some aspects, the one or more neural networks can learn, over time, a baseline expectation of the patterns of traffic, traffic flow, driver behavior, pedestrian behavior, etc., that characterize the movements and interactions of various objects of interest within that given FOV. For instance, the one or more neural networks can learn a prior view of the expected traffic flow and traffic characteristics through the covered area of the FOV that is sufficient to make one or more predictions about what a given vehicle or pedestrian is likely to do in the future—these short-term predictions can extend over the period of the time that the vehicle or pedestrian is expected or estimated to remain within the FOV of the covered area (e.g., because upon exiting the FOV of the covered area, control and analytical responsibility is handed over to the next or adjacent FOV covered area, as described above).

In one illustrative example, the drone 350 can be deployed to capture the collision between vehicles 302b, 302c within its movable FOV 355, based on the road intelligence network analysis engine detecting the collision on the basis of its deviation from expected traffic flow and expected traffic characteristics within the monitored roadway environment of FIG. 3. For instance, either the collision itself may be directly detected, or the deviation behavior of vehicle 302c crossing the dividing middle line and/or vehicle 302b having a mis-aligned orientation relative to the travel lanes of the road can be used to automatically determine that a collision (or more generally, a traffic safety event) has occurred. As illustrated, the collision between vehicles 302b and 302c takes place at a location on the roadway surface that is not captured by any of the other camera FOVs 325, 335, 345, or 375 that are shown in FIG. 3. In some embodiments, the collision between the vehicles 302b and 302c can be predicted or inferred based on the last known locations and behaviors of the two respective vehicles 302b and 302c when they were most recently observed by the road intelligence network system 300 (e.g., while the two vehicles 302b, 302c were still located within camera FOV 375 and corresponding image or video data was captured of the vehicles 302b, 302c by the camera 370).

Based on the one or more predictions generated for the detected objects of interest, the systems and techniques can make enhanced or improved predictions for better controlling the movement or behavior of one or more autonomous vehicles within the FOV of the covered area. For example, the systems and techniques may receive as input additional or supplemental data indicative of an intended destination of one or more vehicles currently within the FOV of the covered area, and can use this supplemental information to generate improved predictions, recommended control actions, and/or direct AV control commands that optimize the traffic flow through the covered FOV and more efficiently route vehicles in the covered FOV to their final destination (e.g., if the final destination is located within the covered FOV) or to more efficiently route vehicles in the covered FOV to a handover point to the next/adjacent covered FOV (e.g., if the final destination is not located with the current covered FOV).

In some aspects, handover between two covered FOV areas (e.g., two adjacent covered FOV areas) can be performed based on a pre-defined boundary or handover zone between the two covered FOV areas. In some embodiments, handover (e.g., the handoff of communication and control for a given autonomously controlled or monitored vehicle) can be performed based on selecting an FOV coverage area that is determined to provide optimal or improved performance. For example, if two covered FOV areas overlap by 100 ft, a vehicle starting in a first FOV may remain under the control and monitoring of the first FOV until the vehicle is closer to the outer boundary of the first FOV than it is to the outer boundary of the second FOV (e.g., for a 100 ft overlap, assuming circular FOV areas, once the vehicle is more than 50 ft into the overlap area control and monitoring functions can be handed over to the second FOV). In some aspects, the selection of an FOV coverage area to perform autonomous control and monitoring of a vehicle can be performed dynamically, based on factors that may include, but are not limited to, current coverage quality, current and past performance of the candidate FOV coverage areas, roadway topography or features, etc.

In some embodiments, one or more interfaces can be provided to vehicles, as will be described in greater depth below. In some aspects, the vehicles may be standalone autonomous vehicles (e.g., fully autonomous, such as ADAS level 5; or partially autonomous, such as ADAS levels 1-4) that are capable of controlling one or more vehicle systems (e.g., acceleration functionality, steering functionality, the power management system 251, control system 252, infotainment system 254, intelligent transport system 255, vehicle computing system 250, communications system 258, and/or sensor system(s) 256 each illustrated in the example of FIG. 2, etc.) based on one or more autonomous control commands or otherwise without human input. In some aspects, the vehicles may be what are referred to as legacy vehicles, which lack autonomous driving capabilities but otherwise still implement electronic control and monitoring systems that are operated with human assistance or intervention. For example, both autonomous vehicles and legacy vehicles may implement some form of a Controller Area Network (CAN bus) that allows microcontrollers and vehicle systems/sub-systems to communicate with each other.

In one illustrative example, the systems and techniques can include an interface for receiving a desired or intended destination for a vehicle. For example, the destination can be input by a driver or passenger of the vehicle, such as by using an onboard navigation system or navigation interface included in the vehicle and/or by using a paired mobile computing device (e.g., a smartphone) to input the desired or intended destination for the vehicle. Based on the input destination information, the systems and techniques can remotely control (e.g., autonomously control) the vehicle for the portion of the route to the destination that passes through a covered FOV monitored area with installed overhead sensor system modules, as described above. For example, a desired destination may be initially received when the route begins (e.g., while a vehicle is parked at the driver's home, in a driveway, along the side of a street, etc.), at a location that is outside of the monitored coverage area(s). In such a scenario, the driver may manually drive the car along an initial portion of the route to their final destination (or, in the case of an autonomous vehicle, the vehicle may autonomously navigate along the initial portion of the route).

Upon reaching and entering an FOV monitored coverage area, a handoff can be performed to pass navigation control and/or monitoring functionalities to the autonomous systems described herein. For instance, monitored coverage areas may be installed in dense urban cores, city downtowns, expressways, interstates, parking lots, etc., while monitored coverage areas may not (initially) be installed to cover lower traffic density areas, such as suburban areas. In some cases, initial handoff of control to the autonomous systems described herein can be performed automatically upon the vehicle initially entering an FOV monitored coverage area. In some examples, handoff may be affirmatively confirmed by a driver or passenger within the vehicle.

In some embodiments, initial handoff of vehicular control can be performed based on performing a trigger action or other pre-determined handoff action. For example, initial handoff of vehicular control may be performed based on a driver parking his or her vehicle within an FOV monitored coverage area and turning off the vehicle ignition. When the vehicle ignition is subsequently turned back on, the vehicle can be automatically registered to the autonomous control system described herein and can be autonomously controlled to move within the starting monitored coverage area and one or more adjacent monitored coverage areas. In some examples, a handoff of vehicular control may be performed based on the driver starting the vehicle within a monitored coverage area (during which time autonomous control is provided) and subsequently driving it from a parking space to a location outside of the monitored coverage area (at which time control reverts to the driver or an onboard autonomous system of the vehicle). In some embodiments, an interface can be provided to permit a driver to take over control of a vehicle that is being autonomously controlled within an monitored coverage area, wherein control may be handed over from the autonomous control systems described herein to either the driver's manual control or the onboard autonomous control of the vehicle.

In some aspects, the systems and techniques can be used to perform one or more monitoring functions and/or to implement one or more rule-based control functions. For example, one or more monitored coverage areas can correspond to a section of roadway(s) for which local authorities wish to implement certain control measures-such control measures (whether temporary or permanent) can be implemented via one or more rules monitored and/or enforced by the autonomous control system described herein. For instance, local authorities can provide ongoing and/or updated instructions indicative of whether vehicles are and are not permitted to travel, indicative of patterns of vehicular behavior that are not allowed, etc. In some embodiments, an autonomously controlled vehicle can be automatically halted based on the systems and techniques determining that the vehicle's behavior has violated one or more constraints enforced by the system. In some aspects, an autonomously controlled vehicle may additionally, or alternatively, be halted based on the systems and techniques determining that the vehicle is at excess risk of hitting a pedestrian, object, other vehicle, or otherwise doing damage.

For instance, FIG. 4 is a diagram illustrating an example road intelligence network deployment scenario 400 that can be configured to monitor vehicle activity on a roadway and/or generate traffic safety notifications in response to automatically detecting and/or identifying an erratic driving behavior within the monitored zone of the road intelligence network.

In some aspects, the road intelligence network deployment 400 of FIG. 4 can include components that are the same as or similar to like components in the road intelligence network deployment 300 of FIG. 3. For instance, a streetlight 412 and cameras 420, 430 of FIG. 4 can be the same as or similar to the corresponding streetlight 312 and cameras 320, 330 of FIG. 3; a camera 440 and cell tower 414 of FIG. 4 can be the same as or similar to the corresponding camera 340 and cell tower 314 of FIG. 3; the camera FOVs 425, 435, 445 of FIG. 4 can be the same as or similar to the corresponding camera FOVs 325, 335, 345 of FIG. 3; an overlapping FOV monitored area 462 of FIG. 4 can be the same as or similar to the corresponding overlapping FOV monitored area 362 of FIG. 3; a speed limit sign 478 and camera 470 of FIG. 4 can be the same as or similar to the corresponding speed limit sign 378 and camera 370 of FIG. 3; a camera FOV 475 of FIG. 4 can be the same as or similar to the corresponding camera FOV 375 of FIG. 3; etc.

As illustrated, FIG. 4 depicts a prior travel path 407 taken by vehicle 402 as it travels from right to left along the roadway surface (e.g., with the vehicle 402 having been previously located at the indicated points in time t₁, t₂, . . . , t₇ shown on the path 407 in FIG. 4). In some examples, the prior travel path 407 exhibits poor lane control, and may correspond to an example of an intoxicated, incapacitated, or otherwise inattentive driver at the wheel of vehicle 402.

The systems and techniques described herein can be used to automatically detect the erratic driving behavior associated with vehicle 402 and the path 407, based on combining and analyzing the sensor feeds obtained from the various distributed sensors and corresponding to the respective FOVs 475, 425, 445, 435. In some embodiments, the road intelligence network can obtain a series of observations over time, where a portion of the observations are directly or explicit observations of the vehicle 402 behavior within a monitored area of a camera FOV and with a remaining portion being inferred or predicted vehicle 402 behavior corresponding to times where the vehicle 402 and path 407 are not within any one or more of the monitored camera FOV zones of the road intelligence network. For instance, at time t₁ the vehicle 402 is still outside of the monitored zone of camera FOV 475, and the system may not yet be aware of the vehicle's presence (or may be aware of the vehicle 402's predicted presence at the t₁ location, based on information sharing of upstream priors observing the same vehicle 402 at an upstream location of the same roadway).

Between times t₁ and t₂, the vehicle's path 407 passes through a portion of the monitored zone of camera FOV 475, and the system can use the observed data within the monitored zone of camera FOV 475 to generate and/or update a trajectory prediction for the vehicle 402, where the trajectory prediction corresponds to the portion of path 407 that is between the monitored camera FOV zones 475 and 425. In some aspects, the observed data within monitored camera FOV zone 475 and/or the trajectory prediction for vehicle 402 immediately after leaving the monitored camera FOV zone 475 can be shared from the upstream camera 470 to one or more (or all) of the downstream cameras 420, 440, 430 as a prior for the vehicle 402.

In some aspects, if the trajectory prediction for vehicle 402 corresponding to the time t₂ location along path 407 is sufficiently reliable or confidence (e.g., greater than a configured threshold value confidence, etc.), the road intelligence network may generate a traffic safety alert or erratic driving alert based on the predicted trajectory of vehicle 402 at time t₂ swerving outside of the lane boundaries of the road.

In some examples, the trajectory prediction for vehicle 402 at the t₂ location may be insufficiently confident, or an additional confirmation may be desired before generating a traffic safety alert or erratic driving alert for vehicle 402. In such examples, the road intelligence network system 400 of FIG. 4 can subsequently obtain a time series of monitoring data or sensor observations of the vehicle 402 for the portion of the path 407 that is within the monitored camera FOV zone 425 corresponding to camera 420. For instance, both the time t₃ location and the time t₄ location along path 407 of vehicle 402 may be characterized by explicit monitoring observations from camera 420 of the vehicle 402 behavior.

As illustrated, at the time t₃ location along path 407, the vehicle 402 is observed in the image or video data as continuing to swerve outside of the lane boundary for the roadway. Between the time t₃ and time t₄ locations along path 407, the vehicle 402 is directly observed in the image or video data as swerving back towards the center of the roadway, in an overcompensated swerve that takes the vehicle 402 from being located outside of the far left lane boundary at t₃ to being located in the far right lane at the time ta location along path 407.

In some embodiments, the double confirmation provided by the two explicit camera/sensor observations from camera 420 within the monitored camera FOV zone 425 at times t₃ and t₄ may be taken as sufficiently indicative of erratic driving behavior (e.g., intoxicated, incapacitated, inattentive, etc., driver of the vehicle 402), and corresponding traffic safety alert and/or erratic driving alert information, notifications, messages, etc., may be automatically generated by the road intelligence system 400.

In some embodiments, the road intelligence network system 400 can, after generating the traffic safety alert/erratic driving alert at time t₄, generate and transmit to the ADAS or other control (autonomous or semi-autonomous, assistive, etc.) system of the vehicle 402 one or more pieces of driver assistance or control information that are configured to bring the path 407 of the vehicle 402 back into the expected behavior of remaining within one of the two travel lanes of the roadway surface.

For instance, at the time t₅ location along path 407, the vehicle 402 begins to stabilize its path and trajectory to be centered within the right travel lane of the roadway. Because the time t₅ location is outside of a monitored camera FOV zone (e.g., between monitored camera FOV zone 425 and monitored camera FOV zone 435), the road intelligence network system 400 may not have sufficient information to generate further course correction commands that can be transmitted to the vehicle 402 as additional driver assistance or ADAS configuration/control information. Accordingly, the trajectory 407 of vehicle 402 may drift slightly away from center during the portion of the trajectory/path 407 that is outside of both the camera FOVs 425 and 435.

At time to, the vehicle 402 and path 407 are within the monitored camera FOV zone 435 corresponding to the camera 430, and the direct/explicit monitoring observations of the vehicle 402 and its behavior can be used by the road intelligence network system 400 to generate additional driver assistance or ADAS configuration/control commands that cause the path trajectory 407 to again stabilize back towards the centerline of the right travel lane of the roadway (e.g., shown as the location at time t₇ returning to the centerline of the right lane, relative to the location at time to that is to the right of the center line).

In some embodiments, the driver assistance or ADAS configuration/control commands generated by the road intelligence network system 400 can vary based on a desired or configured ADAS level for controlling the vehicle 402, and/or a maximum supported or maximum enabled ADAS level for control of the vehicle 402.

For instance, at ADAS Level 0 (no automation), the road intelligence network system 400 can send driver assistance information notifying the driver of vehicle 402 of the erratic behavior and prompting the driver to perform a manual correction. At ADAS Level 1 (driver assistance), single-task automation may be performed based on an ADAS Level 1 configuration/control command sent to the vehicle 402. For instance, the ADAS Level 1 configuration/control command can cause the vehicle 402 to perform autonomous lane following to regain lane position along the centerline.

At ADAS Level 2 (partial automation), the vehicle 402 can receive an ADAS Level 2 configuration/control command that causes the vehicle 402 to perform multiple task automation (e.g., lane following to regain centerline, and acceleration to control to bring the vehicle 402 to a reduced or zero speed over time; or lane following control and acceleration control implemented as ADAS commands that cause the vehicle 402 to automatically be pulled over/pull itself over and come to a stop on the side/shoulder of the roadway). The same or similar principle can apply for using the road intelligence network system 400 to automatically generate corresponding ADAS configuration/control commands for the higher ADAS levels that may be supported by the vehicle 402.

As mentioned previously, the systems and techniques can perform computations, monitoring, prediction, and autonomous control based on sensor data obtained from a plurality of installed overhead sensor system modules. In some embodiments, the systems and techniques can receive raw (e.g., un-processed or minimally processed) sensor data as captured by the overhead sensor system modules. In some cases, the systems and techniques can additionally, or alternatively, receive pre-processed or already processed data that was generated based on the raw captured sensor data. For example, pre-processed data can be locally processed by the corresponding sensor system module (e.g., using a local compute system) prior to being transmitted in a processed for to the autonomous control system described herein. In other examples, raw sensor data can be transmitted from the one or more sensor system modules to one or more remote compute nodes, wherein each remote compute node is responsible for collecting and processing data from one or more different overhead sensor system modules. The remote compute node(s) may subsequently process the received sensor data and transmit, to the autonomous control system disclosed herein, a combination of pre-processed and un-processed/raw sensor data as needed.

In some aspects, the pre-processed data received by the autonomous control system can include abstract geometry of where one or more objects (e.g., objects of interest) are located within a given or corresponding monitored coverage area. The pre-processed data may additionally, or alternatively, include telemetry or kinematic information such as the speed and direction (e.g., heading) of any moving objects within the monitored coverage area. In some cases, the pre-processed data can be indicative of one or more probabilities about future change(s) in direction and/or speed. Probability information can further include collision probabilities, lane or roadway deviation probabilities, etc.

In some embodiments, the systems and techniques can include one or more interfaces for notifying vehicle occupants (e.g., driver, passengers, etc.) about facts (or changes to facts) about coverage areas that the vehicle is entering or exiting. For example, if certain rules are enforced for a section of roadway within a monitored area that limit the maximum speed, prevent lane changes, or close one or more portions of the roadway, the occupants of a vehicle can be notified upon entering the corresponding monitored area (or slightly prior to entering the monitored area, based on a determination that the predicted route of the vehicle will pass through the monitored coverage area). In some cases, vehicle occupants may be notified based in part on a determination that the vehicle occupants have not previously or not yet been notified.

In some embodiments where there is a human driver (e.g., legacy vehicles), overhead sensors may provide an interface that enables a vehicle to be controlled by remote drivers, for example, in a call center. In some examples, the system is configured to prevent crashes and the remote driver is configured to handle other situations, for example, where the system is not enabled or able to control the vehicle. The remote drivers may see high quality video or a vectorized abstraction that enables them with a threshold amount of information for safely driving the vehicle, while consuming less bandwidth.

### Road Intelligence Network: Mobile Application for Administrative Authority Users

In some embodiments, the systems and techniques described herein can be utilized to provide or otherwise may include one or more interfaces for local authorities (e.g., governments of public spaces, owners of private spaces, etc.) that summarize patterns of behavior for vehicles within one or more monitored and/or controlled coverage areas. This information can be used to perform actions such as charging for tickets (e.g., for moving violations, vehicular violations, etc.), charging for parking, etc. In some aspects, the interface(s) can be used to submit queries to one or more databases of vehicles and/or logged vehicle behaviors, wherein the queries can be matched to specific vehicle characteristics and/or vehicle behaviors of interest.

Notably, the administrative authority application interface of the road intelligence network can be used to alleviate existing pressures and problems associated with personnel shortages experienced in many highway patrol and law enforcement departments and organizations. Currently, such shortages often correspond to a majority of dangerous, unsafe, or illegal driving behaviors being missed or not caught/detected by the authorities, and/or that the highway safety authority (e.g., highway patrol, other emergency responders, etc.) often take too long to learn of and respond to highway accidents. Existing personnel also face challenges associated with spending a large portion of their time on traffic stops that also too often go bad. The disclosed systems and techniques can be used to address and solve these challenges and more. Additionally, in at least some examples, existing ticket cameras and ticket camera systems often miss most or many forms of reckless driving, and do not result in timely driver self-correction in the instances where the ticket cameras do catch reckless or illegal driving behavior(s). In some cases, existing ticket cameras and ticket camera systems may be seen to create an experience of unfair or surprise ticketing as a source of revenue, and the corresponding public worries that this revenue may be skimmed for corruption, etc.

The interfaces provided for local authorities can also be used for ingestion and configuration of one or more rule sets that should be enforced to control vehicle behavior when certain conditions are met or violated, as described above. For example, vehicles may autonomously and/or automatically be halted if certain conditions or rules are violated, and these conditions and rules may be specified using the aforementioned interface(s). In one illustrative example, local authorities can use the interface(s) to specify the rules and conditions that should precipitate a halt to a vehicle and/or to specify one or more constraints on how a vehicle should be controlled (e.g., halt a vehicle violating a rule, or modify a vehicle's speed/autonomously controlled behavior to bring it into compliance with a rule that was being violated, etc.). Based on the granularity of control provided to local authorities via the one or more control interfaces described above, the systems and techniques can be used to change instructions, control modes and configurations, etc., in order to optimize the flow of traffic through a given monitored area as is preferred or desired by the local authorities. In some embodiments, the control interfaces for local authorities can be integrated with existing traffic control systems and infrastructure, such as stoplights and the programmed behavior of stoplights. For example, the control interfaces for local authorities can be used to optimize, control, update, or otherwise modify signaling for traffic lights (e.g., pattern/cycle of red, green, yellow light behavior) based on how the traffic light behavior should change based on traffic in the area. For instance, traffic in a monitored area can be dynamically analyzed in substantially real-time to determine an optimal traffic light behavior control signaling for one or more traffic lights, both within the monitored area and within adjacent or external monitored areas.

In one illustrative example, the road intelligence network can be used to provide administrative authority access or interfaces via a traffic patrol mobile application, as noted above. In some embodiments, the traffic patrol mobile application can be used to provide enhanced obstacle and emergency response, including use in preventing accidents and reducing accident severity and duration. For example, the traffic patrol mobile application of the road intelligence network can be used to detect accidents with an improved (e.g., shorter) detection time and response time. In existing approaches, a dispatcher of the traffic patrol agency waits for an individual to call 911 or other emergency response number to report an incident. The dispatcher must then try to understand the location of the caller, and the nature and details of the incident being reported by the caller, who may have an incomplete and/or inaccurate description of the incident and associated details. After taking the phoned-in report of the incident and determining an incident location, the dispatcher must coordinate with and wait for the nearest highway patrol officers to confirm the reported incident (or must wait for a highway patrol officer to see an incident while driving, in cases where the incident went unreported).

By comparison, the disclosed road intelligence network system can use the distributed network of roadside cameras and/or sensors (e.g., such as any of the cameras 320, 330, 340, 350, 370, etc. and/or sensors described with respect to FIG. 3; any of the cameras 420, 430, 440, 470, etc., and/or sensors described with respect to FIG. 4; etc.) to see and detect an obstacle or accident within a monitored roadway area as soon as the obstacle appears or the accident occurs.

In some cases, the analysis of distributed sensor infrastructure streaming data can be performed automatically (e.g., using an AI and/or ML-based road intelligence engine). In some cases, human-in-the-loop interventions or additional human inputs, analysis, information, etc., may be provided to the automated road intelligence engine. For instance, when the system determines something about the road appears unusual (e.g., abnormal sensed condition or event) and/or determines a possible driving characteristic may be present in the sensor data, but with confidence below a configured threshold confidence value/level, human-in-the loop intervention or review can be used. The system can automatically generate or trigger a request for one or more human labelers to view and analyze the underlying sensor data about which the ML road intelligence engine has reached an uncertain conclusion. The human labelers can provide an input (e.g., real-time label or labeling) indicative of the ground truth represented by the sensor data in question. In some cases, the human-in-the-loop labelers can confirm or reject the ML road intelligence engine's automatically generated prediction or conclusion. In some cases, the human-in-the-loop labelers can provide a ground truth label for the sensor data, which is then ingested to the road intelligence engine as an additional data point for generating an updated or refined prediction for the characteristics or events represented in the underlying sensor data that triggered the human labeler review request.

The highway patrol mobile application can be used by the road intelligence network system to automatically notify and dispatch highway patrol officers to the scene of an incident, in response to the automatic and real-time detection of the incident by the road intelligence network system. For example, the highway patrol mobile application can run on a smartphone, laptop, or other user computing device of each highway patrol officer or each highway patrol unit/vehicle used by one or more highway patrol officers. The highway patrol mobile application can receive a notification or link or can be automatically configured to show a sharable link to a live video of the real-time scene of a detected accident or other highway incident. The highway patrol application can additionally, or alternatively, display or link to replays of events depicting or associated with the automatically detected incident. In some embodiments, the highway patrol application can display or provide live video tracking of any departing vehicles involved in the detected accident that later flee the scene. The live video tracking can switch between the respective cameras or other distributed roadside infrastructure of the road intelligence network, to provide continuous tracking of the vehicle as it moves away from the accident scene by traveling along the roadway surface in view of different cameras or sensors deployed to various roadside locations adjacent to the roadway surface, etc.

In another illustrative example, the road intelligence network system and the highway patrol administrative authority mobile application can be used to detect and prevent bad driving behaviors sooner than in conventional or existing approaches. Currently, bad driving behaviors are detected and stopped only when highway patrol officers are on duty in the right place at the right time, and happen to observe the exact moment(s) when dangerous driving behavior occurs. Speed cameras and red light cameras in some cases may be used to supplement this human detection process, but these approaches often miss entirely other large categories of dangerous driving, and may be vulnerable to driver detection and avoidance by drivers using countermeasures such as radar detectors, etc. Calibration workflows are often required for maintenance of speed cameras and red light cameras, which additionally are only operative to generate ticketed offenses for the individual who is the registered owner associated with the unique license plate of a vehicle. The registered owner tied to the license plate information of a vehicle is not necessarily the driver of the vehicle at the time it is captured in an image taken by a speeding camera or red light camera, causing tickets to often be mailed to an owner who was not the driver committing the prohibited driving behavior.

The disclosed road intelligence network systems can use an AI camera network of roadside cameras and birds-eye-view cameras (e.g., such as the distributed camera network and sensing system described above with respect to the example of FIG. 3 and/or FIG. 4, etc.) to obtain a comprehensive and real-time, birds-eye-view of the monitored roadway surface (e.g., monitored portion of a road network). The road intelligence network can analyze the AI camera network image or video data feed for the monitored roadway areas, to automatically flag all vehicles that are detected in association with a prohibited, dangerous, or unsafe driving behavior. The vehicles flagged for unsafe or bad driving can be detected based on back tested rules corresponding to driver history and accumulation of observed dangerous driving patterns, for example including speeding, tailgating, passing on the right, poor lane discipline or lane maintenance, etc. In some embodiments, the rules for detecting and flagging bad driving behaviors from the birds eye camera view of the monitored roadway network area can be implemented using flagging rules that are calibrated by back-testing on observed traffic patterns and camera data. In some cases, the roadside distributed camera network of the road intelligence network can be configured to continue tracking the identified or flagged vehicles, until the generated flag is dismissed by human review in the highway patrol mobile application interface to the road intelligence network. In other examples, the flagged vehicles can continue to be tracked until a patrol intercept is initiated, performed, completed, etc., by the highway patrol officers, etc. In some examples, the AI camera network can automatically generate potential flagged vehicles and flagged driving behaviors, which can be reviewed by remote human labelers who access archive and live video feed data of the driving behavior(s) in question, and escalate to highway patrol authorities when confirming a machine-generated or machine-raised prohibited/unsafe driving behavior flag.

Remote observation of live video or image feed data of a prohibited or unsafe vehicle driving behavior can be used to trigger the generation of a remote ticket, which may be performed automatically by the road intelligence network system, manually by a highway patrol user of the highway patrol mobile application, or various combinations thereof. In some cases, the remote observation of a prohibited or unsafe vehicle driving behavior can be used to notify a closest or a nearby highway patrol unit or officer to respond and initiate an intercept or traffic stop to address the identified unsafe driving behavior. In some aspects, a traffic stop or patrol intercept of the driver flagged for unsafe driving behavior can be performed with full remote video coverage by the road intelligence network system, with more eyes on the situation and remote coaching or advice transmitted to the officer performing the traffic stop/intercept if needed. In some cases, a body-cam worn by the officer performing the stop can be included in the distributed camera network accessed by the road intelligence network system, and may be streamed to the road intelligence system as live video data with audio, live video data without audio, live audio data only, etc., for improvised and enhanced monitoring in real-time of the ongoing traffic stop and the safety of both the officer and the driver involved.

In another illustrative example, the road intelligence network and highway patrol mobile application can be used to catch fugitives and recover stolen vehicles with greater speed (e.g., in less time). The distributed camera and sensor network can support license plate recognition and lookup that may be performed automatically across multiple captures of the vehicle's license plate at the various locations to which cameras and roadside sensors are deployed for the road intelligence network. Driver photos and facial recognition can additionally be used, alone or in combination with license plate detection and recognition. In some aspects, live video tracking of vehicles of interest can be performed as the vehicle moves in and out of the respective FOVs of different roadside cameras deployed to different roadside monitoring locations, etc.

Advantageously, the road intelligence network system and the associated highway patrol or administrative authority mobile application described above can be used to provide a more systematic approach fort detecting and stopping dangerous drivers and dangerous driving behaviors, and can additionally lead to widespread awareness of the automatic monitoring and enhanced response system, leading to increased deterrence of potentially or otherwise dangerous and unsafe drivers and driving behaviors, etc. In some cases, the road intelligence network and/or the highway patrol mobile application can be restricted to avoid excessive or unauthorized access to personally identifiable data and other information of drivers and vehicles monitored by the road intelligence network. For example, user access to the highway patrol mobile application can be limited or restricted to authorized users only, and may require third-party approval and due process to obtain access to protected private or individual information and data, etc. In some examples, the road intelligence network system can be configured to automatically restrict access to license plate lookups, even for authorized users of the highway patrol mobile application, without the highway patrol user providing to the mobile application proof or confirmation of a warrant or other proper authorization to access the data or perform a certain type of query into private personal information, etc.

In some embodiments, the road intelligence network system and/or the administrative authority mobile application thereof can be configured to provide law enforcement or other authorized parties with the ability to query and resolve an identified vehicle (e.g., identified via license plate, photo, image, or video data, manually input data, etc.) to a current driver of that vehicle. For example, a query can indicate the license plate of the identified vehicle, or can include image data that depicts the license plate of the vehicle. The license plate can be cross-referenced against the license plates of vehicles registered with the road intelligence network system, and the registered vehicle can then be cross-referenced against access records of registered driver application to determine the particular individual who is currently driving the vehicle queried by law enforcement. In some aspects, the query with the license plate indication can be analyzed by the road intelligence network system to extract the license plate number or other unique identifier of the vehicle, and once identified, the vehicle travel history (e.g., collected and/or maintained by the road intelligence network) can be retrieved and returned as part of the response to the law enforcement query.

In some aspects, law enforcement may submit a query without the license plate of the vehicle in question, or without image data from which the license plate can be extracted. In such scenarios, the query may instead include additional descriptive information of the vehicle and when it was sighted by law enforcement, such as a description of the make/model and color of the vehicle, location of the sighting or observation by law enforcement, time of the sighting or observation by law enforcement, a direction of travel observed for the vehicle, an estimated or radar-measured speed of travel for the vehicle at the time of observation, etc. Observation parameters that are submitted by the law enforcement query can be matched against the observed, monitored, and/or recorded driver and vehicle parameters that are collected by the road intelligence network system, in order to identify a potentially matching vehicle in the records of the road intelligence network. A vehicle that potentially matches with the parameters submitted in the law enforcement observation query can be returned as the query response, optionally with additional monitoring data of the potentially matching vehicle, including one or more links to live or real-time camera feeds of each potential matching vehicle identified for the query.

In one illustrative example, the road intelligence network can implement and maintain a central database where any plate camera can ping to with a query for a particular license plate number or license plate identifier. The central database can receive pings or queries from plate cameras, and can respond with information indicative of only whether the license plate and/or associated vehicle has been flagged as dangerous or requiring attention in some manner. In some aspects, the central database can be automatically checked by plate cameras provided at the entrance and exit points of covered or monitored roadway areas. In this manner, any vehicle entering or exiting a covered/monitored roadway area can be automatically imaged and checked against the central database, to generate an obfuscated indication that does not contain personal or private information of the driver or vehicle, and instead contains only an affirmative or negative indication of whether the driver/vehicle has been flagged, identified as dangerous, problematic, needing intervention, etc.

### Road Intelligence Network: Mobile Application for Verified or Registered Driver Users; Image-Based Driver Registration and Monitoring

In one illustrative example, a verified driver application can be installed or otherwise provided on a smartphone or other mobile computing device of a user associated with the presently disclosed road intelligence network system (e.g., a registered and verified licensed driver, etc.). The user device for running the verified driver application can be provided on a UE or other smartphone/user computing device. For example, the user device configured to run the verified driver application may be the same as or similar to the device 107 of FIG., etc. In some examples, the verified driver application can additionally, or alternatively, be provided to run on an in-car display or in-car computing device that is integrated with the driver/user's vehicle (e.g., the same as or similar to the vehicle computing system 250 of FIG. 2, etc.). In some cases, the verified driver application described herein can also be referred to as the vehicle application (e.g., driver application), and may be used to implement various functionalities as described in the various examples below (e.g., including but not limited to stopping bad driving sooner, catching fugitives and stolen cars faster, real-time driver registration, and/or next-gen vehicle APIs/infrastructure for safe and reliable remote control and/or autonomy, etc.).

In some embodiments, a user registers a vehicle with the road intelligence network system, for example by utilizing a website or web portal and/or utilizing the verified driver application described herein. In some examples, the user can register a vehicle according to one or more aspects of a real-time driver registration process. For instance, a user can register a vehicle by using the driver application to upload the vehicle registration and insurance information. In some cases, the user can perform registration that includes the upload of one or more photos and/or videos of the vehicle, including photos or videos with views of the unique license plate number and/or VIN that uniquely correspond to the vehicle. Upload of the registration information, photos, videos, data, etc., may be via website, mobile application (e.g., driver application, etc.), or via a combination thereof. When registration is performed using one or more vehicle photo uploads, the road intelligence network system can verify that the vehicle's make as determined from the uploaded images matches the vehicle's make as indicated in the provided registration information or other data also included in the registration information upload. For instance, computer vision, ML classifiers and/or other ML or AI models, networks, algorithms, etc., can be used to automatically analyze uploaded vehicle image data (images and/or video frames, etc.) to identify the vehicle make and/or other identifying vehicle characteristics, which can be stored and logged and/or can be compared and analyzed against the corresponding vehicle information provided in the registration information or documentation uploaded by the user seeking to register the vehicle with the driver application.

During the vehicle and/or user (e.g., driver) registration process, the registering user can additionally note any other visually distinctive features of the vehicle being registered. The system may also check at that time (e.g., time of registration or time of document upload by the user) and/or intermittently thereafter with various other databases that the user's provided registration and insurance information are valid. In some embodiments, the driver registration application may also offer the user help renewing or replacing either or both of their insurance, their vehicle registration, or any other required documentation or licensing for the user and/or the user's vehicle that has either expired already, or is facing expiration in the future.

In some cases, the user registers as a driver by uploading a photo of his or her driver's license. The driver application may periodically ask the user to capture and upload a selfie to confirm that the user's phone (e.g., the phone being used to access the account or profile of the registered user or driver via the verified driver application) is under consistent control of the individual who registered as the user and is depicted in the driver's license. Image capture can be required to be performed using the same phone that is running the driver application and may further be limited to require live or real-time capture without exiting the interface of the driver application running on the user's smartphone or other user computing device. The driver application can, in some embodiments, be configured to confirm the registered or provided phone number for the user and to further ensure that the phone number matches with the device being used to access the user's driver profile or other account. For instance, the driver application can confirm the provided user phone number by performing verification based on a call or message through the application and/or through the phone itself.

In one illustrative example, a user of the road intelligence network system can become associated with a vehicle either by registering the vehicle through the in-app vehicle registration process as described above. In another illustrative example, a user can become associated with a vehicle by entering the unique license plate or other identifying information of the vehicle (e.g., if the user, but not the vehicle, is already registered with the road intelligence network system). In some examples, a user can become associated with a vehicle based on using an invitation link or referral code from another user already associated with the vehicle. For instance, a parent already registered to a particular vehicle in the road intelligence network system can send an invitation link or referral code for their spouse, child, or family member to become an additional registered driver of the same particular vehicle. In another example, an individual already registered to a vehicle can send an invitation link or referral code to his or her roommate inviting, allowing, or otherwise enabling the roommate receiving the invitation link or referral code to become an additional registered driver of the vehicle in the road intelligence network system and driver application described herein.

In some embodiments, the road intelligence network system may detect or otherwise determine that the user is the owner of a vehicle, and in response may be configured to allow the user to approve or reject other candidate or potential drivers attempting to register with the same vehicle. For example, the registered owner can approve or reject other users seeking or attempting to also register with the driver application as a driver (e.g., additional driver) of the registered vehicle owned by the user being notified with the option to approve/reject the registration request. In some examples, any vehicle referrer can undo authorization of any drivers they referred. The application or website can allow the approved users to identify the current driver in any vehicle that is owned by the approved user and/or any vehicle that is previously registered to the approved user. The identification of the current driver can be performed remotely and in substantially real-time, for instance as live information provided to the approved user or vehicle owner through a corresponding interface of the driver application running on the approved user's computing device or logged in with the approved user's account credentials, etc.

In some examples, the system can provide drivers with applications configured to provide background check and authorization workflows. For example, it may be important for prospective riders or owners of prospective cargo to make sure the driver is who they say they are. In some aspects, the presently disclosed road intelligence network system can be configured or used to provide a standard API for authorities to obtain driver and vehicle paperwork. In at least some embodiments, the disclosed road intelligence network system and/or mobile applications can interface with multiple third party applications or services. Notably, the disclosed road intelligence network system can be used to provide a single location lookup for obtaining information about a particular vehicle, independent from whether the users in question (e.g., the individual or entities seeking to perform authentication or verification) are using distinct applications or services for vehicle authorization.

In some examples, the road intelligence network system can obtain various streams of sensor data from the distributed sensor system that is included within and/or associated with the road intelligence network. For example, if a vehicle is in motion, the road intelligence network system can determine the corresponding movement information by looking for the locations of approved drivers closest to the location of the query, and/or based on an inferred location of the vehicle determined from application context information. If one of the nearby approved drivers is sufficiently close to the location of the vehicle being queried (e.g., based on GPS or other detected location information, inferred location information, or a combination thereof), then the road intelligence network system may be configured with a default assumption that the closest user/approved driver registered with the road intelligence network system is the same as the driver of the vehicle being queried. If multiple approved drivers/registered users are close, then the road intelligence network system can be configured to message each driver within a pre-determined threshold distance, in order for the system to thereby determine which specific driver within the threshold distance is actually driving the vehicle being queried. In other examples, the road intelligence network system may utilize onboard sensors and/or cameras of the vehicle being queried and/or sensors included in the smartphones of the multiple approved/registered drivers in question, etc., to obtain real-time information that can be used to determine and/or verify the identity of the individual who is currently driving the queried vehicle.

In some aspects, if a vehicle being queried is parked, then in response to the query the road intelligence network system may return the closest users or the last user seen driving the vehicle by a roadside camera (e.g., including roadside cameras such as any one or more of the various cameras and/or other roadside sensors shown and described in the illustrative example(s) of FIG. 3 and/or FIG. 4, etc.).

In some embodiments, the system can be configured to use images of vehicles (e.g., with license plate information represented in the images directly, extracted by visual recognition, etc.) or to use license plate information generated by another system or entered by a human along with a location at which the vehicle is purported to have been observed most recently or at the time of the underlying image capture. The observation location may be provided manually or by GPS from the device used to capture the image or license plate information. In examples where the road network intelligence system obtains or otherwise utilizes an image input, the system can be configured to additionally verify that the vehicle make represented within the image is consistent with the vehicle make selected in the registration information tied to the driver profile or in the vehicle registration information on record. If the road intelligence network system detects a mismatch or conflict between the detected vehicle characteristics and the registered vehicle characteristics, the system can generate a flag or notice indicating that the vehicle appearance has changed markedly from last-known images of the vehicle analyzed from prior observations associated with the license plate.

In some aspects, a recipient of the response information determined for a vehicle query (e.g., a vehicle query as described above, etc.) can receive an opaque identifier of the vehicle and/or driver information, where the opaque identifier does not include or reveal the unique personal information registered with the system. The vehicle query response can include the opaque identifier(s) for the vehicle and/or driver, along with corresponding assertions indicating the presence of valid (or invalid) paperwork. Some recipients of the vehicle query response may have additional authorizations that permit such recipients (e.g., verified highway safety patrol, law enforcement, etc.) to request and receive authorized access to view the underlying paperwork and/or the unique personal information of the driver and/or vehicle as registered to the road intelligence network system. In some examples, a recipient of the vehicle query response may be prompted to purchase authorized access to request and/or view the underlying paperwork and registration information of the driver and/or vehicle being queried, or to perform or obtain background check information for the user or vehicle.

As noted previously, in at least some embodiments it is contemplated that the road intelligence network system can provide a highway patrol application or highway patrol application functionality (e.g., also referred to as a traffic patrol application, etc.) that is configured to provide functionalities and features such as the stopping bad driving sooner, catching fugitives and stolen cars faster, etc., as described in further detail in the examples below. In some aspects, the highway patrol application confirms that a user is an authorized member of a highway patrol upon installation of the application or registration of the user to the mobile application service. For instance, a highway patrol user can take a photo of a vehicle (ideally including the vehicle license plate in the captured field of view of the image), or can enter a license plate number and provide current location information (e.g., using GPS). In response to the query, the highway patrol user can receive in return various types of response information. For example, in some embodiments, a response to the query may comprise an indication that all vehicle and driver paperwork corresponding to the query is valid (or is invalid). In some embodiments, a response to the query may include, with another level of authorization, access to copies of the documents themselves (e.g., such as in scenarios where the highway patrol user is contemplating a traffic stop, etc.). If a vehicle is issued a ticket, the ticket may be sent in real-time to the driver through a corresponding mobile notification in the driver application described above, and/or via SMS, etc.

In some embodiments, the automated roadside camera functionality may be implemented using various combinations and/or components described with respect to the road intelligence network and distributed sensing infrastructure described herein (e.g., including roadside cameras such as any one or more of the various cameras and/or other roadside sensors shown and described in the illustrative example(s) of FIGS. 3-7, etc.). The automated roadside camera functionality may additionally or alternatively be implemented using various combinations and/or components described with respect to the road intelligence network and highway traffic safety administration system(s) described herein. For example, automated roadside camera functionalities can be based at least in part on respective images or streams of image data obtained from one or more of the roadside cameras 320, 330, 340, 350, 370, etc., illustrated in the example road intelligence network system 300 of FIG. 3; and/or can be obtained from one or more of the roadside cameras 420, 430, 440, 470, etc., illustrated in the example road intelligence network system 400 of FIG. 4; etc.

In some aspects, the road intelligence network system can observe vehicles passing by the location of one or more roadside cameras (e.g., based on observing or detecting specific vehicles in the images or image streams captured by and obtained from the respective roadside cameras, etc.). In some examples, the road intelligence network system can automatically generate a message, notification, report, warning, etc., indicating that the system has determined that the driver and/or vehicle paperwork (e.g., registration, licensing, insurance, etc.) appears invalid for one or more reasons. The road intelligence network system can then send the report to a highway patrol dispatch center and/or directly to highway patrol officers in a position to respond and initiate a vehicle stop on the identified vehicle with invalid paperwork. The road intelligence network system may also auto-generate a ticket or a warning for transmission to the driver of the monitored vehicle, for example based on the road intelligence network analyzing a camera feed or image data showing the vehicle behaving in ways that warrant a remediation action or ticketing (e.g., including, but not limited to, actions such as speeding, maintaining poor lane discipline, changing lanes without signaling, etc.). If there is a warrant out for a vehicle or driver, the system can be configured to automatically reports each detected sighting of the vehicle to highway patrol or other relevant government/law enforcement authorities, etc.

In some aspects, when the road intelligence network system is used to offer or update insurance coverage information for drivers or registered users, the system can use information available from provided documents of the registered driver users, as well as information determined by the road intelligence network system itself. For example, the road intelligence network system may automatically determine a plurality of inferences corresponding to events where the system detects a particular vehicle/registered user driving on a monitored roadway surface, and subsequently generates one or more inferences corresponding to the quality, characteristics, etc., observed for the vehicle/registered user driving behavior. These automated inferences for driving behavior and quality can be determined based on streams of sensor and/or image information collected using the distributed network of cameras or other sensors that are associated with the road intelligence network system. For example, automated inferences of driving behavior or driving quality can be determined using image data from roadside cameras, and/or sensor data (e.g., accelerometer, etc.) captured by the smartphone or user computing device of the driver (e.g., where the sensor data is captured or uploaded by the driver application running on the driver's smartphone or user computing device). In some aspects, automated inferences for driving behavior or driving quality can be based at least in part on sensor data obtained from the vehicle CANbus and/or from image data or image streams obtained via the road intelligence network system having access to one or more in-vehicle cameras, dash-cams, etc. In some aspects, the road intelligence network system can be configured to query the user for other information in order to determine a most appropriate insurance policy for the user and the user's observed or inferred driving behavior, qualities, and/or characteristics, etc. The system may add more cameras to better underwrite the safety of registered vehicles.

In some embodiments, a plurality of connected or accessible (e.g., accessible by the road intelligence network, etc.) sensors may be used to obtain respective sensor data or other measurement information that can be used to determine or infer location and/or position information of an associated vehicle. For example, motion sensors (e.g., accelerometers, inertial sensors, IMUs, gyroscopes, etc.) may be present in multiple different user computing devices that are within the passenger compartment of the vehicle, such as in the smartphones, wearable devices, etc., of the driver and/or passengers of the vehicle. Based on being located within the passenger compartment of the vehicle, such sensors move with the vehicle, and location and movement information determined for the sensors and sensor-including device(s) can be used as an approximation of the respective location and respective movement information of the vehicle itself. Motion sensors may also be included in the vehicle itself, and accessed by the CANbus or other connection to the vehicle communication interface(s) to thereby provide additional inputs to the road intelligence network. For example, the road intelligence network can use the respective sensor data that can be obtained from all motion sensors associated with a given vehicle under analysis, such that the road intelligence network fuses the motion and sensor data obtained from the smartphones or personal devices of passengers or the driver of the vehicle, as well as the additional motion and sensor data obtained from the sensors that are included in or otherwise integrated with the vehicle. In some embodiments, motion sensor data and/or other sensor data obtained from devices within the vehicle or otherwise moving with the vehicle, as well as motion sensor data and/or other sensor data obtained from the vehicle itself, can be used by the road intelligence network system to determine whether the vehicle is being driven dangerously or in a prohibited or unsafe manner. For instance, motion sensor data from all available motion sensors can be analyzed periodically or continuously, alone or in combination with other information and inputs available to the road intelligence network system, to determine if the driver is sober or exhibiting indicators of driving impaired or under the influence, etc.

In some aspects, the road intelligence network system disclosed herein can be configured to use radio sensors and/or radio transceivers (e.g., RF sensors and/or RF transceivers, etc.) available from user devices within a vehicle or provided by the vehicle itself. In particular, the road intelligence network can use the radio sensors and transceivers, or various other RF sensors and transceivers, to obtain additional situational awareness of obstacles, events, etc., within the vicinity of the vehicle. For example, situational awareness can be augmented for the road intelligence system based on wireless detection and communication between roadside beacon emitters that emit a wireless (e.g., Bluetooth, WiFi, UWB, RF, etc.) beacon signal that is detected or received by a radio or RF receiver/transceiver within the vehicle. In some examples, various other RF sensing and/or RF positioning techniques can be used to improve situational awareness around a given vehicle, using the radio and RF sensors or transceivers provided by the vehicle itself as well as those provided by the driver/passengers and their respective smartphones or other personal computing devices, etc.

In some embodiments, Bluetooth communications and/or signaling can be used to improve situational awareness of nearby or neighboring vehicles. For instance, Bluetooth receivers or transceivers can be provided by user devices within a vehicle, or by the vehicle itself, and can detect the presence of nearby Bluetooth transmitters or transceivers that are provided by a different set of user devices within nearby vehicles, or that are provided by different transceivers included in the nearby vehicles themselves. Bluetooth-based neighbor or nearby device discovery can be performed locally by a vehicle or the driver mobile application provided by the road intelligence system to run on the various user devices within the vehicle. The results of the Bluetooth discovery or beaconing process can be transmitted to the road intelligence network system as an additional data point or additional indication of local situational awareness indicative of at least one or more nearby or neighboring vehicles. In some cases, the Bluetooth discovery can correspond to a list or other indication of device identifiers that are detected over Bluetooth, and the road intelligence network system can perform a correlation to map the detected device identifiers nearby to a particular vehicle, to translate the detected device identifiers into a unique identifier of a registered vehicle. Based on the correlation or translation, the road intelligence network can receive a list of nearby devices detected over Bluetooth, and can determine the corresponding listing of nearby or neighboring vehicles that are associated with the detected Bluetooth devices (and can further determine respective location, position, movement, etc., information for each neighboring vehicle, etc.).

Some locations (e.g., such as campuses, etc.) may require the driver to install the verified driver application and confirm the validity of the driver when passing through an established checkpoint location, which may be a physical checkpoint or gated entrance, a virtual or geofenced checkpoint, or both. Some locations may also require the owner or driver of a vehicle to connect a monitoring device into the vehicle that allows the road intelligence network system access to the vehicle bus (e.g., CANbus), for example to obtain additional information about the vehicle and/or to send control information or commands to the vehicle via the CANbus (e.g., either to be able to stop it remotely or control the vehicle remotely via roadside cameras or a view from dashcam, etc.). In examples where a remote control device is installed in the vehicle and connected to the CANbus, the road intelligence network system can be configured to monitor and report if it detects the vehicle operating but does not also detect the remote control/monitoring device on the vehicle CANbus operating concurrently.

Aspects of the presently disclosed road intelligence network system may provide vehicles with dash-cams or other devices that plug into the CANbus of registered vehicle. In some cases, the CANbus interface or monitoring devices may access (e.g., request, receive, obtain, etc.) roadside camera information collected by the road intelligence network system. The driver or the road intelligence network system may also use the CANbus interface devices to stop the vehicle or drive the vehicle via remote control or remote chauffeur techniques. In some aspects, the dashcam may be an input into remote driving or insurance calculations performed by the road intelligence network system.

In some aspects, cameras alongside the roadways that deliver vehicle tracking information and/or video records of bad driving occurrences/indications to highway patrol dispatch (e.g., such as any roadside cameras and/or distributed sensing infrastructure described in FIGS. 3-4 and/or FIGS. 5-7, etc.) can provide distributed roadway sensing information that can be analyzed by the disclosed road intelligence network system. The analysis of the distributed roadway sensing information inputs can be used, by the road intelligence network system, to prioritize or directly control the response actions of highway patrol officers who may be in a position to pull over or otherwise stop/apprehend drivers of the tracked vehicles for which bad driving is detected. Information delivered to dispatch may include recommendation of officers to handle the traffic stop in a particular manner determined based on a history and/or location of the user identified as the current driver of the vehicle (e.g., whether the user is a registered or non-registered driver for the vehicle), of the vehicle itself, of the traffic stop location, the roadway, other users or vehicles passing nearby or in the vicinity of the planned traffic stop location, history or location information of the responding officer or highway patrolman, etc.

In examples where the road intelligence network system has access to or otherwise stores driver smartphone information, or the driver is running the driver application on his or her smartphone or other user computing device, then in some aspects a remote call center can handle ticketing and notifications to the driver. For example, in some embodiments, a remote call center can issue a warning communication to the driver prior to the issuance of a ticket or violation, for example based on texting and/or calling to the driver application running on the driver's phone, to thereby notify the driver to pull over or improve the flagged driving behavior (e.g., without involvement of a highway patrol officer, or in addition to/augmenting involvement of a highway patrol officer for the traffic stop, etc.). In some aspects, automated recognition of bad driving can be performed by the presently disclosed road intelligence network system using a combination of ML and/or AI models, networks, systems, techniques, algorithms, etc., along with a human labeler ladder that rolls up to individuals designated by highway patrol. In some cases, remote handling of bad drivers can be performed via AI bots and/or humans approved by highway patrol either working from home or in call/text centers.

In some embodiments, the driver mobile application can be used to provide improved traffic management based on dynamic, virtual, and/or temporary tolled access lanes or priority access lanes. For example, existing approaches require dedicated highway infrastructure to establish toll lanes and toll booths, with tolling hardware needed at every on-ramp and exit from the managed toll lane(s) to properly charge drivers the correct usage-based or distance-based toll fee. The tolling infrastructure adds cost of construction to the roadway infrastructure, and moreover is generally unflexible and difficult or even impossible to modify or reconfigure in reasonable amounts of time. In one illustrative example, the road intelligence network and the driver mobile application can be used to configure and optimize traffic and lane configurations on a roadway in real-time and/or based on situational cues or triggers. For example, roadway throughput can be optimized by lane and vehicle capability, among various other factors and criteria. In some examples, for highways, one or more lanes can be marked and configured as reserved-access or priority-access that is limited only to registered and verified driver users of the road intelligence network system. The restricted access on a lane-by-lane basis is implemented in software, with dynamic monitoring and reporting of compliance or non-compliance of each vehicle within the restricted access dynamic lane(s). In some cases, tolling for entering or joining a dynamic and virtually managed toll lane can be implemented by a charging function of the road intelligence network system and the driver application thereof. Tolling prices and active times can be dynamic based on detected traffic and roadway conditions, etc., for example with the toll amount increasing as the lane approaches its peak throughput, based on weather conditions, based on the driver's following distance or assessed driving quality score, etc. In some examples, the road intelligence network and driver application can implement dynamic speed limits with higher upper speed limits allowed for vehicles and/or drivers that qualify, for example based on a safe driving history, an accident free record, a safe driving history, a safe driving behavior trend, etc. Dynamic tolls can be implemented as functions of time and/or distance in the dynamic and virtually managed restricted-access toll lanes of the road intelligence network, and may further be based on vehicle type and miles status, etc. In some aspects, registered drivers may use their driver mobile application to earn toll credits or reduced dynamic toll prices by driving in the lane at less contentious or congested times.

### Beacon-Based Collaborative Sensing and Relative Positioning

In some embodiments, the road intelligence network can be implemented using collaborative sensing and relative positioning techniques that are configured to determine vehicle and/or driver identification, registration, and/or kinematic information without the use of roadside cameras or other image-based data. For example, the road intelligence network can be implemented using collaborative sensing associated with a plurality of beacons or beacon devices that are deployed to static locations on or nearby a roadway surface, and/or that are deployed within one or more vehicles traveling along the roadway surface. In some aspects, a network of beacons and receivers can be used to obtain a real-time understanding or prediction of vehicle positions, movements, and road conditions, without requiring the use of traditional sensor data and/or image data that may be obtained from dedicated roadside sensors and cameras. For example, the network of beacons and receivers can be used to obtain real-time vehicle position and movement information based on relative position measurements determined using calculated distances between fixed beacons and moving receivers, with subsequent triangulation across the plurality of relative positioning measurements and corresponding beacons within the beacon network.

In some embodiments, various relative positioning techniques can be used to determine positioning information and/or kinematic information (e.g., velocity, acceleration, etc.) for a plurality of vehicles that are traveling, using, or otherwise located on a roadway surface. For instance, relative positioning information can be determined locally or onboard a vehicle (or user computing device carried by a passenger within the vehicle, etc.) based on signaling that is exchanged between the vehicle and one or more stationary beacons or beacon devices that are associated with known locations (e.g., absolute locations, referenced to a GPS coordinate or other reference coordinate(s) and/or relative location, referenced to other beacons or beacon devices).

For example, FIG. 5 is a diagram illustrating an example road intelligence network 500 implemented based on collaborative sensing data associated with a plurality of stationary and/or roadside beacon devices (e.g., beacon device 525-1, beacon device 525-2, etc.) transmitting one or more respective beacon signals to one or more vehicle-borne receivers, in accordance with some examples. In the example of FIG. 5, the beacon devices 525-1, 525-2 are implemented as stationary or static beacons, also referred to as roadside beacons (e.g., based on a roadside location where the stationary beacon devices 525-1, 525-2, are installed, etc.). The corresponding receivers that receive a beacon signal transmitted by the stationary beacon devices 525-1, 525-2 can be associated with the vehicles 502a, 502b, etc., traveling on the roadway surface and within range of the roadside beacons 525-1, 525-2. For example, vehicle 502a can include an integrated beacon receiver and/or a passenger or driver of the vehicle 502a can carry a smartphone or other computing device configured to act as a beacon receiver. Vehicle 502b can similarly include an integrated beacon receiver and/or a passenger or driver of the vehicle 502b can carry a smartphone or other computing device configured to act as a beacon receiver.

Each beacon receiver can receive one or more beacon signals transmitted from the roadside beacons 525-1, 525-2. For example, the beacon receiver implemented by or located within vehicle 502a can receive a first beacon signal 535-1a transmitted from the beacon device 525-1 (e.g., the beacon device 525-1 located on or attached to the roadside speed limit sign 578, etc.). The beacon receiver implemented by or located within vehicle 502a can additionally receive a second beacon signal 535-2 transmitted from the beacon device 525-2 (e.g., the beacon device 525-2 located at a different location than beacon 525-1, such as on a dedicated pole or roadside support, etc.). The beacon receiver implemented by or located within vehicle 502b can receive a beacon signal 535-1b transmitted from the beacon device 525-1.

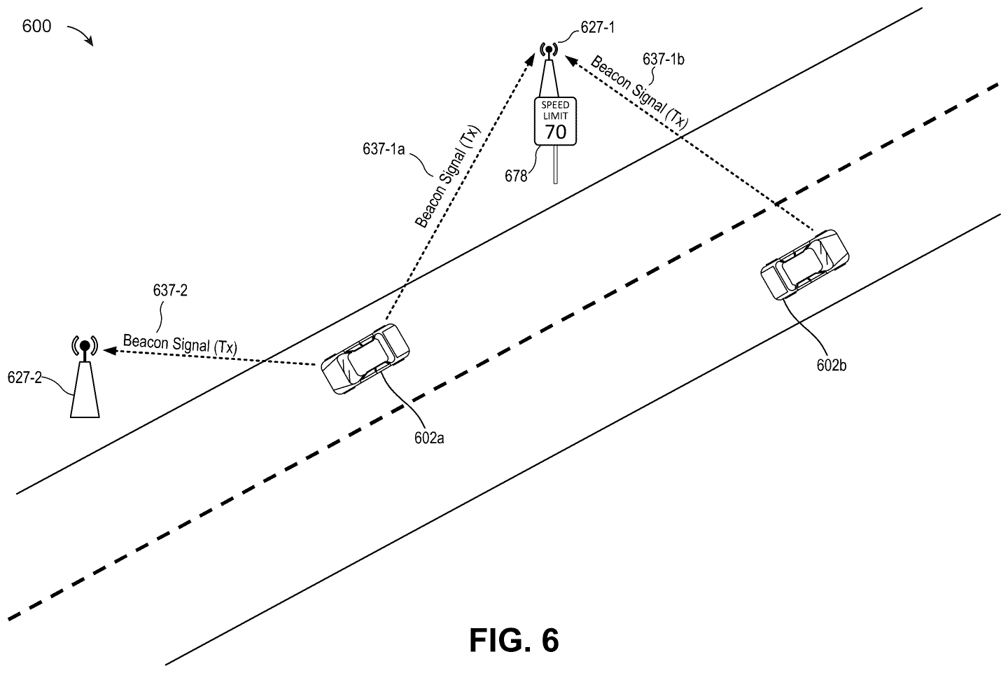

As contemplated herein, a beacon or beacon device can be stationary (e.g., integrated into the roadway surface or infrastructure, or other nearby surface or object, etc.), can be mobile or semi-mobile, or any combination thereof. For instance, in another illustrative example, FIG. 6 is a diagram illustrating an example road intelligence network 600 implemented based on collaborative sensing data associated with a plurality of vehicle-borne beacon devices (e.g., associated with the vehicles 602a, 602b) transmitting beacon signals (e.g., the beacon signals 637-1a, 637-1b, 637-2, etc.) to one or more stationary and/or roadside beacon receivers (e.g., roadside receivers 627-1, 627-2, etc.) in accordance with some examples. In some aspects, the road intelligence network 600 of FIG. 6 can be similar to the road intelligence network 500 of FIG. 5. In some examples, the roadside beacon receiver 627-2 of FIG. 6 can be the same as or similar to the roadside beacon transmitter 525-2 of FIG. 5 (e.g., a beacon transceiver configured for beacon transmission as the beacon transmitter 525-2 of FIG. 5, and configured for beacon reception as the beacon receiver 627-2 of FIG. 6, etc.). Similarly, the roadside beacon receiver 627-1 of FIG. 6 can be the same as or similar to the roadside beacon transmitter 525-1 of FIG. 5 (e.g., a beacon transceiver configured for beacon transmission as the beacon transmitter 525-1 of FIG. 5, and configured for beacon reception as the beacon receiver 627-1 of FIG. 6, etc.).

Various types of relative positioning and/or position and/or location sensing, determination, etc., can be utilized without departing from the scope of the present disclosure. In some aspects, the beacons and/or receiver devices described herein, along with the relative positioning and/or location determination systems described herein can be implemented based on radio frequency (RF) sensing. As described herein, radio frequency (RF) sensing techniques (e.g., monostatic RF sensing, bistatic RF sensing, multistatic RF sensing, etc.) can be used to detect the presence and location of targets such as objects, users (e.g., people), vehicles, etc. RF sensing techniques can additionally, or alternatively, be used to detect kinematic information of targets, such as the velocity, acceleration, etc., of a moving vehicle. In some aspects, RF sensing can further be used to identify a type or class of object that has been detected and/or localized. In some examples, the systems and techniques described herein can include or implement various artificial intelligence (AI) and/or machine learning (ML) techniques, models, networks, etc., for providing improved highway safety (including high traffic safety), monitoring, and administration thereof.

In one illustrative example, a “beacon” or “beacon device” may refer to a radio frequency (RF) wireless communication device configured to emit a constant signal, for instance using technologies like Bluetooth, Wi-Fi, or Ultra-Wideband (UWB). In some examples, a beacon may be provided as a wireless communication device that includes at least an RF transmitter, although beacons may also include an RF receiver (e.g., or an RF transceiver combining Tx and Rx functionality). Beacon devices can be attached to or integrated into objects, including standalone beacon devices or beacon installations, “tag”-like form factors, integrated into a smartphone, UE, vehicle, and so on, thereby allowing for accurate location tracking and/or other information to be determined. Beacons can be battery-powered, solar-powered, electrical grid/mains-powered, or various combinations thereof, etc. A primary function of beacons is to transmit a unique identifier that can be picked up by nearby receivers, such as smartphones or dedicated receiver units provided on or within a vehicle. These beacons can typically be provided as small, unobtrusive, durable hardware devices that are designed for long-term use with minimal maintenance. Beacons may be engineered to be highly durable, often resistant to various environmental factors like water, dust, and temperature fluctuations. The emitted signal can be detected by compatible devices within a certain range, which varies depending on the technology used and environmental conditions. Beacons can be programmed to operate at various signal strengths and intervals, balancing precision positioning/location determination vs. power consumption and complexity. In the context of road safety, a plurality of beacons (of same, similar, and/or different designs, characteristics, properties, operational principles, etc.) can be strategically placed in, on, and/or near roadways to facilitate real-time location tracking of vehicles and improve traffic management and safety systems.

In some aspects, a beacon device can allow proximate receivers to identify and locate a beacon from which the receiver obtains or measures a beacon signal transmission, with various levels of accuracy using one of a variety of signaling systems including Bluetooth, Wifi, and UWB. WiFi hotspots and cellular towers (e.g., 5G NR, 4G LTE, etc., amongst various others), base stations, nodes, etc., can also function as beacons. In some embodiments, some or all of the beacons can be configured to report GPS and accelerometer data to receivers on or within a vehicle on the roadway surface. Beacons can each be associated with a unique identifier (ID) that the beacon is configured to include in its beacon signal transmissions (e.g., the beacons may send their respective ID in encrypted or unencrypted form as part of their beacon (e.g., positioning) signals). In one illustrative example, beacons can be deposited along roadway lanes either next to one or more lanes, on top of one or more lanes, embedded in one or more lanes, underneath one or more lanes, or any various combinations of the above, etc.

As used herein, a “receiver” or “receiver device” can refer to a device with a unique ID that receives signals from beacons (due to proximity) and characterizes and interprets those signals to establish information useful to mapper devices (described below) in computing distances between the receiver (e.g., vehicle or vehicle-borne UE, etc.) and the beacons, distances between multiple receivers, distances between receivers and non-receiver objects, etc. For example, a “receiver” or “receiver device” can be a beacon receiver or beacon transceiver, the same as or similar to one or more of the beacon receiver devices of FIG. 5 and/or FIG. 6.

In one illustrative example, the receiver device can be implemented as a vehicle-borne receiver, where the receiver device is integrated within or provided by the vehicle itself, or is a mobile device associated with a driver or passenger of the vehicle (e.g., in which case the receiver device, such as a smartphone, is carried within the passenger or interior compartment of the vehicle by a passenger or driver of the vehicle, etc.). Underlying location algorithms, signals, and/or techniques can be based on or can include, but are not limited to, Trilateration, Multilateration, Triangulation, Time of Arrival (ToA), Time Difference of Arrival (TDoA), Received Signal Strength Indicator (RSSI), Angle of Arrival (AoA), Phase of Arrival (PoA), etc. In some aspects, receivers are implemented running on various user and/or mobile computing devices located within a vehicle, generally on mobile phones themselves, but in at least some embodiments receivers may be implemented as separate devices that may communicate through the phone or independently. Receivers may also have GPS and accelerometer data for use by mapper devices.

As used herein, a “mapper” or “mapper device” may refer to a computing process that takes all forms of information from one or more receivers and computes the values of the relative location, speed, direction, and acceleration of the receivers with respect to beacons from which they receive signal and with respect to other receivers, wherein if some receive signal from the same beacons each value can in some embodiments be represented as a probability distribution. Mapper devices (e.g., also referred to herein interchangeably as “mappers”) may deliver computed maps, vehicle position or location information, kinematic information, trajectory information, etc., to distributor devices (e.g., “distributors”) and/or to the vehicles, UEs, smartphones, beacons, and/or receivers, etc., themselves. In some embodiments, it is contemplated that mappers may run on devices in vehicles or on distributors or both.

As used herein, a “distributor” or “distributor device” can refer to a device that broadcasts calculated vehicle relative position and/or movement maps over the air to proximate devices that can receive this information, as well as in at least some embodiments to remote devices by various communications means, modalities, networks, etc., which can include but are not limited to, fiber, mobile or cellular connection (LTE, 5G, BLE, etc.), and/or satellite, etc. In some aspects of the present disclosure, distributors can be configured and used to deliver maps to vehicles driving by as well as to law enforcement to help them make sure vehicles are operating safely and within the traffic laws.

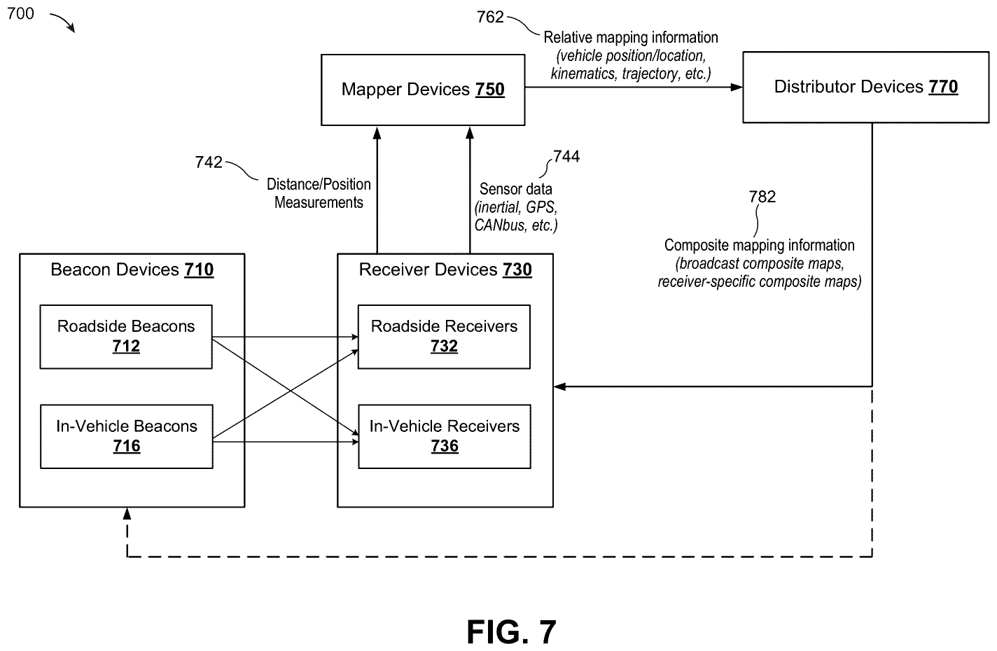

For example, FIG. 7 is a diagram illustrating an example of a road intelligence network processing system 700, in accordance with some examples. The road intelligence network processing system 700 can be associated with or include a plurality of beacon devices 710, including one or more roadside (e.g., stationary) beacons 712, such as the beacons 525-1 and 525-2 of FIG. 5, and including one or more in-vehicle (e.g., mobile) beacons 716, such as beacons associated with the vehicles 602a and 602b of FIG. 6, etc. A plurality of receiver devices 730 can be associated with the plurality of beacon devices 710, where the receiver devices 730 are configured to detect or received respective beacon signals transmitted by or from individual ones of the plurality of beacon devices 710. The plurality of roadside devices 730 can include one or more roadside (e.g., stationary) receiver devices 732, such as the roadside receivers 627-1 or 627-2 of FIG. 6, and can include one or more in-vehicle or vehicle-borne receivers 736, such as the in-vehicle receivers associated with vehicles 502a or 502b of FIG. 5, etc.

Based on detecting or receiving respective beacon signals from the beacon devices 710, the receiver devices 730 can determine relative distance and/or positioning measurements 742, which are transmitted from the receiver devices 730 to one or more mapper devices 750. In some aspects, the reader devices 730 can additionally provide one or more types of sensor data 744 as additional inputs transmitted to the mapper devices 750. For instance, the sensor data 744 transmitted from the receiver devices 730 to the mapper devices 750 can include, but is not limited to, inertial sensor data (e.g., accelerometer data, IMU data, IMS data, gyroscopic data, etc.), GPS or positioning sensor data, CANbus data obtained from the vehicle CANbus or vehicle CAN, etc. The one or more mapper devices 750 can process the plurality of reported distance and position measurements 742, and additional sensor data 744, that are reported by each individual receiver device included in the plurality of receiver devices 730. From the individual reports of distance/position measurements 742 and sensor data 744 collected at each receiver device 730, the mapper devices 750 can generate calculated or predicted relative mapping information 762, indicative of the vehicle position/location, kinematics, and/or trajectory information for a plurality of vehicles associated with at least one of the beacon devices 710 or at least one of the receiver devices 730 (e.g., vehicles 502a, 502b of FIG. 5, vehicles 602a, 602b of FIG. 6, etc.).

The relative mapping information 762 can be provided from the mapper devices 750 to one or more distributor devices 770, at a continuous or periodic interval, in substantially real-time. Different mapper devices 750 may receive different sets or combinations of distance/position measurements 742 and sensor data 744 from different respective subsets of receiver devices included in the plurality of receiver devices 730. Accordingly, each mapper device 750 may receive beacon receiver data from a subset of the plurality of beacon receivers 730, and generate corresponding relative mapping information 762 that correspond to the same subset of beacon receivers 730 and associated vehicles represented therewithin. The distributor devices 770 can receive the relative mapping information 762 generated by various mapper devices 750 for the different subsets of receiver devices 730.

From the different relative mapping information 762 inputs, the distributor devise 770 can generate one or more outputs of composite mapping information 782 that represents the vehicle position, location, movement, kinematics, trajectory, etc., information for some or all of the plurality of receiver devices 730. For instance, the composite mapping information 782 generated as output by the distributor device 770 can comprise broadcast composite maps that represent the mapped information determined for every entity represented by or associated with the plurality of beacon devices 710 and the plurality of beacon receivers 730. In some examples, the composite mapping information 782 can comprise receiver-specific composite maps that are generated to correspond to a particular subset of the plurality of receiver devices 730 (e.g., one example receiver-specific composite map 782 can be generated for the set of roadside beacon receivers 732, a second example receiver-specific composite map 782 can be generated for the separate set of in-vehicle or vehicle-borne beacon receivers 736, etc.).

### Beacon-Based Detection of Abnormal or Dangerous Driving Behavior

In some aspects, beacon data and/or the positioning data described herein (e.g., one or more of the distance/position measurements 742, the sensor data 744, the relative mapping information 762, and/or the composite mapping information 782 of FIG. 7, etc.) may be used to perform bad driver detection or abnormal driver detection, for example based on analyzing the collected data, position and/or kinematics information corresponding to specific drivers or vehicles. In some cases, the analysis can compare a first driver or vehicle against multiple other drivers or vehicles that are nearby in space or time and/or that otherwise share one or more characteristics of interest with the driver or vehicle being analyzed. For instance, road intelligence network 700 can perform the analysis to notice that a vehicle is being driven very differently from other vehicles traversing the same path and perhaps be traveling in patterns that indicate the driver is impaired, drowsy, or distracted and should be stopped.

In some implementations, this information will be used by a local driver application to warn the driver. In other examples, the information may be delivered to law enforcement (e.g. via the highway patrol or administrative authority mobile application of the road intelligence system) in order to assign a patrol officer to call or stop the vehicle. Following the above example, the system may be configured to determine if a particular vehicle is varying its speed (e.g., based on analyzing the distance and accelerometer information) in a way that indicates aggression. In another example, the road intelligence network system 700 can determine that other vehicles are driving in a straight line while a specific vehicle is periodically losing the straight line path before performing a sudden and jerky recovery onto the same path of the other vehicles, thereby indicating the driver may be drowsy or impaired in some other way.

In some aspects, the road intelligence network 700 can be used to perform bad or abnormal driver detection, and can be configured to warn drivers and/or notify authorities when the system detects bad driving. In some embodiments, bad driving can be considered driving that is different in kind from normal driving on a given section of road, e.g., driving that is jerky in some way or other factors that may be indicative of or a signal of impairment, drowsiness, aggression, etc. In some embodiments, the road intelligence network 700 can detect bad driving from any subset of accelerometer data (e.g., from a phone or computing device or sensor within the vehicle, and/or from an accelerometer included in the vehicle itself, etc.), connectivity with the vehicle Controller Area Network bus (CANBUS), connectivity with Bluetooth beacons on the side of the road, in-vehicle cameras, and/or cameras and other road-side sensing infrastructure, etc.

In some embodiments, bad driving detection or characterization can be performed using the analysis process as described above, and further using one or more comparisons with the driving patterns of other similar vehicles (in terms of make or size). In some embodiments, the bad driver detection information, data, predictions, inferences, conclusions, etc., may also be used by autonomous driving assistance systems (ADAS) of vehicles to make driving safer by generating signals for the driver (ADAS level 0) or to directly and/or indirectly, wholly or partially, inform control of the vehicle by ADAS level 1+ systems. In some aspects, the bad and/or abnormal driver behavior detection described herein can be more subtle than a speed camera-type, one-off detection of non-compliant driving behavior. For instance, existing approaches are largely focused on detecting driving behavior using a binary judgment-a driver is either speeding or not speeding. As contemplated herein, the bad driver detection can be implemented based on the idea that dangerous or bad driving can be a comparison-based or relative determination.

For instance, the comparison-based or relative determination of bad driver behavior enabled by the systems and techniques described herein can extend to include actions that are visible or visually observable by analyzing various factors and data inputs, which can include, but are not limited to, looking (a) at individual vehicle information like lane drift, or short stopping as well as (b) identifying or detection relations between vehicles like too short a following distance, and/or (c) comparisons between vehicles established by other vehicles in multiple spots along the roads and highways, such as more aggressive acceleration/deceleration or turning than others.

In some embodiments, the road intelligence network 700 can enable analysis of trends, patterns, etc., to determine or identify time-based driving behavior flags, relative/comparison based driving behavior flags (compared to other drivers on the same stretch(es) of road, etc.), and so on. As noted previously above, the bad or abnormal driver detection may be implemented based at least in part on analyzing accelerometer sensor data, or other kinematic data associated with a particular vehicle and/or driver of the vehicle. For instance, the analysis can be performed based on or using one or more of thresholds of too much or too little acceleration, etc. In some aspects, the road intelligence network 700 can analyze accelerometer data alone, can analyze accelerometer+CANBUS data in various combinations, and/or can analyze CANBUS data only, etc. This can be implemented at a per vehicle level and/or can be implemented by comparison of vehicle/driver-specific information to one or more configured baselines established by comparable vehicles on the relevant sections of roads and highways or intersections. In some aspects, the underlying comparison(s) used to perform bad or abnormal driver detection can be based on comparisons to behavior of other vehicles (e.g., over multiple different spans of road). For instance, there may be no driving behavior exhibited from moment-to-moment that is egregious or clearly illegal (e.g., such as speeding, etc.), but a dangerous driving behavior trend can accumulate over time and may be detected by the road intelligence network 700 as differences or variations between a particular driver as compared to the behavior of the immediately surrounding drivers in the same area of monitored road. Such relative comparison information can be potentially significant or informative for the road intelligence network 700, and may potentially trigger an action for the potential bad or abnormal driving behavior).

### Beacon-Based Detection of Road Damage and Foreign Objects on Road

In some embodiments, the road intelligence network 700 can be used to perform automatic detection or prediction of road damage and/or the presence of foreign objects on the road, etc., based on analyzing accelerometer or other collaborative sensing data (including CANBUS data) for a plurality of vehicles to identify patterns or trends of driving behavior that deviate from established baselines or are otherwise indicative of potential road damage, foreign objects in or on the road, etc. For instance, in some aspects, the detection of road damage or obstacles can include using the road intelligence network 700 to notify authorities or automatically dispatch autonomous or remote control robots to mark the detected area of damage or obstruction as damaged/blocked and/or to remove the obstacle or repair the road or both.

In some cases, the road intelligence network 700 may detect damage/obstacles in or on the roadway, based on corresponding changes in vehicle sensing data at a particular road location, as compared to the vehicle sensing data/vehicle behavior driving over the portion of road immediately prior to the particular road location, and as compared to the vehicle sensing data/vehicle behavior driving over the portion of road immediately after the particular road location (i.e., analyzing the road approaching and/or departing the relevant location of changes in the patterns at the location itself compared to a prior point in time). In some cases, patterns may include jerky motion of the accelerometer if the issue is a pothole, or using the dashcam or roadside camera(s) to detect the relevant section of road looking different. Notably, the same sort of information is obtained from multiple vehicles, which can be used and interpreted as an indication of a problem on the road not a problem with a driver or an issue with an individual vehicle. These signals can be captured via the driver mobile application described in and used for the collaborative sensing approaches above.

In one illustrative example, the detection of road damage, road obstruction, road condition changes, and/or foreign objects, etc., can be implemented in a manner similar to that described above for the bad/abnormal driving behavior detection-here, looking for “bumps” or other abnormalities in the accelerometer data. In principle, the road damage and object detection can work from data collected for just one vehicle. In some aspects, an improved and more accurate approach can be based on sampling the same section of road from multiple vehicles. The road intelligence network 700 can analyze the “bumpiness” or abnormality in the accelerometer data from each vehicle as a trend, and can verify conclusions over multiple vehicle's data or measurements. For instance, the analysis of the same section of road from multiple vehicles can be based on multiple factors, including but not limited to, a determination of whether the accelerometer or other collaborative sensing data is consistent over multiple vehicles; whether the data is worse than nearby sections of road (e.g., right before, right after, etc.); etc.

In some aspects, the road intelligence network 700 can be configured to perform the road damage or other abnormality detection using accelerometer and/or CANBUS data from multiple vehicles-a comparison across vehicles and across multiple stretches of road (and across different times, in some examples/inherently capture the different times aspect when doing this for multiple vehicles). Based on detecting road damage, a pothole, or some other abnormality—the road intelligence network 700 can trigger a decision or action that a threshold for dispatching a traffic patrol officer or traffic patrol unit to investigate/remediate has been met. The deployed response resources can comprise highway patrol, repair crew, etc. Notably, this road damage can be detected/inferred without using or needing visual or camera data.

In some embodiments, the road intelligence network 700 can additionally, or alternatively, be configured to analyze the collaborative sensing data from multiple vehicles traveling the same section(s) or portion(s) of road to perform other types of detection like frozen roads, black ice, etc.—sections of road that are transiently a problem for drivers. In some cases, as noted previously, vehicle CANBUS data can be used to augment collaborative sensing or accelerometer data. Vehicle CANBUS can also be used to drive the analysis and detection on its own. For example, the road intelligence network 700 can analyze various combinations of CANBUS and collaborative sensing/accelerometer data to determine that the movement of the vehicle is different from what CANBUS is trying to do (trying to command or control). For instance, the driver is on a frozen or icy road and hits the brakes, but the vehicle does not slow/does not slow at expected rate, etc.

In some embodiments, the road intelligence network 700 can include various implementations of a repair system integrated into the process described herein. For instance, the road intelligence network 700 can be configured to deploy flare drones to the location of road damage or abnormality to alert drivers. In some embodiments, the deployed drones (e.g., flare drones, alert drones, warning drones, repair drones, maintenance drones, etc.) can be autonomously piloted, remote human piloted, etc. In some cases, the road intelligence network 700 can deploy repair drones (e.g., pothole repair drone, robot, etc.). In some embodiments, the road intelligence network 700 can determine/classify the type of problem and a rank/severity/level (based on the type of problem providing characterizing information for the remediation in some manner). In one illustrative example of detection of non-receiver objects on the roadway surface, devices on vehicles deliver information derived from cameras looking out from the vehicle to mappers. These may be phones mounted onto windshields or separate devices. In these cases, collectors use this information to make better inferences about the location of vehicles and other objects on the road. In particular, collector devices can make inferences about objects and vehicles that are not themselves carrying receivers. In some implementations, mappers also infer the presence of an obstacle on the road from the pattern of participating receiver vehicles moving around it. In either case, the road intelligence network 700 may report the object to a third party for removal. If it is a vehicle, it may report so that the lane is used exclusively for vehicles that are authorized. Accordingly, it is contemplated that vehicles can be configured to collaborate in collecting enough information about the road to maximize safety traveling when on the road.

In at least one illustrative example, an example use case implementation is to detect vehicles that are not participating in this system and report such vehicles to law enforcement to be removed from the road, or to inform registered vehicles about the movements of non-registered vehicles. In another illustrative example of detection of pedestrians or legitimate obstacles carrying receivers or beacons, in some embodiments, pedestrians carry receivers and/or beacons for collectors to use to infer the pedestrian/obstacle locations as well. This allows vehicle ADAS systems to navigate around these mapped pedestrian/obstacle locations as well. In some cases, the pedestrian or obstacle beacons and/or receivers can be running on mobile phones or mobile connected watches. In some cases, beacons will be embedded in flares or barricades as well and marked as such.

### Beacon-Based Toll Collection and Managed Traffic Lanes

In some aspects, the road intelligence network 700 can be configured to use the location sensing system (e.g., presently disclosed collaborative sensing system for road safety and monitoring) to collect tolls or road usage fees from drivers. These charges may be assessed based on the fact that the driver (and their associated or operated vehicle) used the lane (toll lane, managed lane, etc.) for at least a threshold distance and/or time. In some cases, tolling for access to toll lanes or managed lanes may additionally, or alternatively, be a function of various different factors, characteristics, parameters, information, etc., which can include, but are not limited to, one or more of the time of day, road congestion, the sort of vehicle being driven, or the income or other facts about the driver. The toll collection may be a mobile payment through the driver application of the road intelligence network 700.

In some cases, the road intelligence network 700 can be configured to implement a reservation system for providing a driver/vehicle with advance (reserved) access to a selected toll lane or managed lane in order to limit congestion (e.g., based on shutting off reservations when the maximum throughput or other capacity measure of the toll/managed lane has been reached, through some combination of advance reservations and/or real time usage info of vehicles within the toll/managed lane(s)). In some embodiments, the road intelligence network 700 can be configured to charge drivers for not using their reserved spot. In some embodiments, the road intelligence network 700 can be configured to enable drivers who hold a reservation to access/use a toll/managed lane to sell their spot. In such approaches, the road intelligence network 700 can be used to collect revenue in a way that is fair both in terms of people's ability to plan and their ability to pay. In general, it is possible to keep adding vehicles to a tolled/managed lane up until a saturation threshold is reached, where congestion occurs or is caused when adding vehicles beyond the saturation threshold. At the saturation threshold point, adding further vehicles can reduce overall or effective throughput, rather than increasing throughput. Accordingly, in some embodiments, the road intelligence network 700 can be used by registered drivers (e.g., using the driver mobile application) to reserve a spot in a managed-access lane in advance, as introduced above and described in greater detail below. For instance, the road intelligence network 700 can allow a driver to reserve a spot for their vehicle in a particular managed lane (or multiple managed lanes) tomorrow at a certain time or time window; the lane is then closed down to further access when capacity is reached. The reservation can be used to guarantee the driver (and their current vehicle) a spot and access to the toll/managed lane(s) selected or configured during the reservation process. A reservation can extend to include multiple managed lanes, a series of managed lanes, etc. In some aspects, a reservation can be required to access a toll/managed lane of the system. In some embodiments, a reservation can be optional when the managed lane is not saturated or otherwise at maximum capacity (i.e., when the maximum capacity or throughput is not currently being achieved, drivers can enter the managed lane spontaneously or at will, etc.).

The managed lane access and reservation system described herein can be used to provide and implement for drivers a managed lane (e.g., toll lane) use reservation at a certain time. In some aspects, the road intelligence network 700 can support transactional exchanges of managed lane reservations (e.g., selling or trading an existing, future reservation to access a managed-access lane by a driver who does not or no longer needs or desires the reservation for accessing the managed lane, etc.). In some examples, a managed lane access reservation may automatically expire or incur penalty charging if not used. Notably, the managed lane or dynamic toll lane reservation functionality described above can be used in both the context of trip planning (by drivers) and congestion management (by the collaborative sensing road safety system of the road intelligence network 700, etc.). Enabling the dual functionalities of trip planning and congestion management can be seen to allow the road intelligence network 700 to implement more advanced features such as traffic control and optimization.

In general, it is observed that existing or conventional toll lanes and toll/managed lane infrastructure normally have fixed places to exit and enter. By contrast, the managed lane systems and techniques described herein can be implemented and configured to charge drivers based on the exact time and/or distance they and their vehicle are in the toll lane. In some aspects, the road intelligence network 700 can charge for managed lane access and usage based on vehicle type or brand, gas or electric powertrain, etc., and more generally can charge according to various characteristics of the driver and/or characteristics of the vehicle. In some aspects, tolling can be implemented and used as congestion management, revenue generation, or both. In some embodiments, the charging logic and parameters used by the road intelligence network 700 for the tolling and/or managed lane implementation can change based on goals of the tolling program, etc. For instance, congestion management without tolling may be performed in some cases (e.g., cannot enter toll lane, the toll lane is now full), based on the ability provided by the road intelligence network 700 to communicate the relevant managed lane information and status messages to drivers. In one illustrative example, the road intelligence network 700 can notify drivers they are in queue to join or enter a toll lane or managed lane that is currently at capacity. In some examples, the road intelligence network 700 can be configured to determine or detect that a driver in an adjacent lane has their turn signal on or is otherwise indicating they are trying to enter the toll lane. If the toll lane is at capacity or not available to that driver, the road intelligence network 700 can automatically send a message or notification to the driver's mobile application indicating the driver is currently not authorized to access the managed toll lane, but has been added to the queue to join when space is available.

### Beacon-Based Coverage Map(s)

In some aspects, the road intelligence network 700 may provide maps or mapping information indicative of where the collaborative sensing and positioning system described herein is available, implemented, deployed, or otherwise is able to provide different types of coverage of roads. In some cases, the coverage map information can correspond to coverage or availability information for particular services provided or enabled by the collaborative sensing system of the road intelligence network 700 (e.g., a general coverage map indicating locations where the collaborative sensing system itself is available or where at least one service is available, a plurality of more granular coverage maps indicating where specific services such as bad driver detection, toll collection, road damage or foreign object detection, etc., are available, etc.). In some cases, coverage map information may be indicative of where authorities mandate application usage (e.g., a driver application associated with the road intelligence network 700, etc.). In some embodiments, coverage map information can include one or more maps of where application users are driving in varying quantities (e.g., live map, tracking information and/or overlays of more detailed information, etc.). Notably, large amounts of information about driving a road can be obtained by the beacon-based road intelligence network 700, even if the road or road section has not been instrumented with roadside sensor infrastructure, given that the system has access to collaborative sensing data from enough drivers or vehicles with the driver application running, etc. In some aspects, drivers, passengers, and/or riders of registered vehicles may plan trips using this information and the driver application of the road intelligence network 700 may provide route guidance to follow the user preferences about coverage.

In some aspects, coverage map information can include, but is not limited to, system level information, availability, where the collaborative sensing network of the road intelligence network 700 is deployed, etc. In some cases, the coverage map information can be similar to a cellular carrier coverage map overlaid on a geographic area, indicating areas of availability (e.g., locations of monitored areas of roadway or road network, etc.), areas of no availability, areas of future, or upcoming coverage (e.g., coming soon areas), etc. In some embodiments, the road intelligence network 700 can characterize the system availability or coverage based on the type of sensing technology used (camera or beacon or both) or by what fraction of vehicles are cooperating (even in areas without beacons or cameras), etc. In one illustrative example, coverage map information can be used to inform route planning for drivers, e.g., a message indicating the presence of managed lanes on a driver's intended route, where there will not be heavy be traffic due to the lane being dynamically setup as being managed-access. In some aspects, coverage map and usage thereof for route planning can relate to or tie into the toll collection feature described above. In some cases, the intuition of the route planning provided by the road intelligence network 700 can be understood as similar to the current difference between flying a plane and driving in a car-planes submit a route plan in advance, cars do not. For instance, centralized control with some visibility into future intentions versus a lack of centralized control and purely reactionary driving with no announcement of future plans or intended route to others outside the driver's vehicle, etc. Accordingly, it is contemplated that if drivers submit their route information in advance, the road intelligence network 700 can react and plan accordingly to predict traffic, change routing of drivers once hit saturation or max capacity/throughput for a lane, etc.

### Beacon-Based Remote Driving

In some embodiments, the road intelligence network 700 can be configured to provide a pool of remote chauffeurs for operating a registered vehicle, either by appointment or on demand. A remote chauffeur can be a human driver who remotely operates, monitors, supervises, or otherwise controls etc., the vehicle owned by a driver registered with the road intelligence network system 700. For instance, if a driver does not wish to drive themselves in their registered vehicle, the driver can use their driver mobile application to engage with a remote chauffeur to drive the vehicle remotely. The remote chauffeurs can be used to drive registered vehicles remotely, with support from the road intelligence network 700 in terms of information about other vehicles and the road, where the support information provided to remote chauffeurs from the road intelligence network 700 is inferred from the beacon and/or sensor data collected by the road intelligence network 700, as well as with the support of autonomous driving assistance systems (e.g., the on-board vehicle ADAS, etc.).

In some embodiments, the remote chauffeur system can utilize the bad driving detection systems (e.g., such as the bad driver detection described previously above) to switch remote chauffeurs out dynamically if it determines the current remote chauffeur for a vehicle (e.g., the current remote chauffeur operator of a vehicle) is driving dangerously, negligently, and/or otherwise not performing sufficiently well, etc. The road intelligence network 700 can be configured to maintain a rating for all remote chauffeur drivers to thereby model each remote chauffeur driver's individual risk level for driving a given vehicle or registered driver. The road intelligence network 700 can thus allow regulators or vehicle owners to decide the level of skill at which they want vehicles driven in various locations. In one illustrative example, an example use case for the remote chauffeur is based on convenience. Improved safety can be another, important aspect-half of drivers by definition are worse than the median driver on the roads. The road intelligence network 700 can be configured to implement and maintain a remote driver (chauffeur) pool of drivers who are measurably better/safer drivers than the average or median driver safety for an area, based on the average or median driver safety information or statistics already being tracked by the road intelligence network 700. For instance, the road intelligence network 700 can be configured and used to determine and update dynamically (in real time) rating information for remote and in-vehicle drivers, rating the ability of remote and in-vehicle drivers to drive in various conditions, etc. These ratings can be applied to all drivers or registered drivers, which can include the remote chauffeurs and individuals who want to qualify as remote chauffeurs. Accordingly, rating information on driver safety and/or skill can be already available for remote chauffeurs, potential remote chauffeurs, applicant or candidate remote chauffeurs, etc.

In some aspects, the road intelligence network 700 can select and assign remote chauffeurs based on the driver safety or skill rating of the remote chauffeur, and a comparison to the average, median, etc., driver safety or skill rating, and/or a comparison to the corresponding driver safety or skill rating of the individual who is hiring the remote chauffeur to drive their car. For instance, the road intelligence network 700 can select the remote chauffeur to be qualified as a better/safer driver than the average/median driver, or a better/safer driver than the specific requesting driver who will use the remote chauffeur service, etc. In some embodiments, the road intelligence network 700 can monitor remote chauffeur actions and performance. For instance, the road intelligence network 700 can notice (detect or determine) if the remote chauffeur starts driving poorly, below their ability level, below a safety floor or other threshold level, etc. In one illustrative example, the road intelligence network 700 can, in real-time, switch to another remote chauffeur to maintain the improved safety or improved driver ability provided by use of the remote chauffeur service. This feature can be implemented as a driving skill floor protection when using a remote chauffeur to drive a registered vehicle of a requesting user (e.g., requesting driver using the driver mobile application of the road intelligence network 700). For instance, if the remote chauffeur is evaluated as driving poorly or dangerously for any reason, the road intelligence network 700 can switch automatically to a different remote chauffeur who is standing by. In some embodiments, a switch or change or swap of remote drivers or remote operators/chauffeurs can be implemented and performed without having to stop the vehicle. For example, the system may be configured to bring a standby driver online to watch the vehicle feeds if there is a detection of an indication of potential bad driving by current remote chauffeur (i.e. a potential need for switch/handover). Subsequently, if the need for the switch or handover in remote drivers is triggered, the replacement remote chauffeur is ready to take control immediately and not thrust into unfamiliar situation.

### Beacon-Based ADAS Integration, Vehicle Control, and or Remote Supervised Vehicle Operation

As noted previously above, in various embodiments, the systems and techniques described herein can be integrated with a vehicle Advanced Driver Assistance System (ADAS) and/or a vehicle Controller Area Network bus (CANBUS). In some embodiments, the vehicles are configured to share (to the system) control information about the vehicle often (e.g., a frequent and/or low periodicity basis, etc.) from the vehicle's CANBUS and/or on-board ADAS system. This allows shared reporting not just of vehicle movement but also of any turning, acceleration, and braking signals the vehicle is sending to internal systems that help anticipate what movements will result. In some embodiments, an adapter on the vehicle directly connects to vehicle control systems to operate as an ADAS+ system and uses collector information in order to do so. In some embodiments, the driver's phone or driver mobile application running thereon uses mapper information to provide ADAS level 0 style functionality to the driver.

In general, it is contemplated that one of the signals (e.g., collaborative sensing signals or information) the system may use for detection on driving is a connection with the vehicle control system, the CANBUS. In some embodiments, the connection with the vehicle CANBUS can be used for various ADAS implementations and/or to provide various ADAS or ADAS+ features from the system to the vehicle. Current ADAS implementations may largely be seen as providing a simple monitoring mode, where the car largely capable of driving itself, but human driver must be ready to take over control if needed (e.g., because the ADAS systems do work reasonably well, but can be imperfect, etc.). In one illustrative example, the systems and techniques described herein can be configured to provide remote vehicle control or operation to supervise an existing ADAS and/or to observe/monitor/stand ready to take over if needed by the ADAS, wherein the same person can remotely monitor multiple vehicles at the same time, standing ready to take over remote control of the vehicle from the on-board ADAS of the vehicle as needed. The multiple monitored vehicles per remote observer contemplated herein can be implemented based on the very low probability that all of/multiple of the supervised vehicles will need human intervention, supervision, or control all at exactly the same time. Accordingly, it is contemplated that the road intelligence network 700 can utilize a pool of remote drivers that is less (perhaps even significantly less) in number than the number of cars in the pool of cars being remotely monitored, i.e., each person monitors 2, 3, 5, 10, etc., vehicles simultaneously. This can be configured differently for different risk profiles, risk tolerances, probabilistic modeling, etc.

In some embodiments, the number of remote agents versus the number of monitored vehicles can be adjusted so that the probability is sufficiently low that any given remote human driver will be called upon to simultaneously control or manage multiple vehicles at a time—as such, if multiple vehicles request remote driving assistance, a sufficient number of remote human drivers are available or on call to do so, up to some configured threshold. In some aspects, a human remote drover may remotely monitor multiple vehicles at the same time, and the same vehicle may be remotely monitored by multiple humans at the same time. If a vehicle requires full attention, then the vehicle may be assigned to a particular one of the remote agents who were already performing remote monitoring of that vehicle. Assigning the vehicle needing full attention can comprise the remote monitoring human agent taking over from the vehicle ADAS and/or otherwise providing full or partial remote control of the vehicle, or other input(s) to the vehicle ADAS to resolve the issue that caused the need for remote operation or control. In this example, the other vehicles being monitored by the remote driver who is called upon to provide full attention to the particular vehicle can be transferred to other remote drivers to continue the same monitoring. The implementation of the assignment of multiple vehicles across multiple remote agents and/or subsets of a plurality of remote agents that in total numbers less than the number of vehicles can work successfully based on configuring the system to measure or otherwise determine the probability that each vehicle will need full driving attention in a given period of time. Accordingly, the system can allocate K remote drivers prepared to drive N vehicles (where K<N), as long as the probability that more than K vehicles need full attention at the same time is sufficiently low (e.g., less than one or more configured safety thresholds, local authority mandated thresholds, regulatory thresholds, other stipulated thresholds, etc.).

As an example, if there are ten vehicles being driven and have established good reason to believe the probability that any one of them will need full human attention in the next minute is less than 5% given where the vehicle is currently driving (e.g., probability of needing full human attention is less on the highway than in downtown city streets, etc.), and the road intelligence network 700 has four drivers available, in one illustrative example, the road intelligence network 700 can determine the optimal assignment of remote driving or monitoring agents to subsets of the multiple vehicles, based on binomial distribution information corresponding to the information above. For instance, the road intelligence network 700 can use the binomial distribution to find that the probability of being short a driver is ˜0.006%. If that probability is too high for a configured risk-tolerance or other threshold value(s), then the road intelligence network 700 can reduce the ratio of drivers to vehicles. If it is a tolerable level of risk given the speeds involved, then the road intelligence network 700 can keep the number intact and keep cost per vehicle lower.

In some embodiments, if there is a need for simultaneous intervention on multiple vehicles that are being monitored by one human, the road intelligence network 700 can call on and use another driver from the pool until the need for intervention has passed or been remediated (e.g., burst capacity by pulling from the pool of remote drivers/agents). For example, for N vehicles, the road intelligence network 700 can determine or compute the % likelihood that all N vehicles would need driver attention at the same time. This can be based on factors such as where the vehicle is located, what the current vehicle behavior is (e.g., what the vehicle is doing; as the need for intervention may be less likely if it is known that the vehicle is driving straight on the highway for next hour versus navigating narrow city streets in a dense downtown core, etc.). In some aspects, the road intelligence network 700 can integrate information and/or knowledge from the routes or destinations of vehicles, etc. In some cases, the calculation and probabilities can be dynamic based on a variety of different factors/inputs.

### Beacon-Based Qualified Drivers, Authorized Zones, and Geofencing

In some embodiments, the road intelligence network 700 can be configured to implement a qualified driving and/or authorized zones feature based on geofencing-specific permissions, rules or restrictions for providing or allowing driver access to configured areas. In one illustrative example, a qualified driver can be a driver who has valid driver's license. In another example, a qualified driver may be a driver who has a valid driver's license and a driving history or driving safety record sufficiently clean. In another example, a qualified driver can be a driver who has a valid driver's license and is authorized to be driving or located within a certain zone of monitored roadway. These zones can be a highway lane or a geofenced zones, can be set up with any kind of qualifications, criteria, or rules as specified by the entity or person who is in charge of or in control of the zone, etc. For example, a geofenced zone could designate only people with valid driver's license and military members are allowed to drive within the zone. In another example, a geofenced zone may be configured to require top secret clearance, etc. In addition to validation or qualification framework for restricting or permitting entry to geofenced zone, the road intelligence network 700 can be configured to add a time or temporal component to the zones, where for example a ride-share driver has authorization for a 5 minute access window starting from an estimated drop-off time to be within the zone. After the time limit expires, the road intelligence network 700 may be configured to take actions to alert authorities or get the unauthorized vehicle and driver out of the restricted geofenced zone, etc.

In some aspects, the geofencing application/implementation associated with qualified driving and authorized zones can additionally, or alternatively, be used by the road intelligence network 700 to track individual app-using pedestrians as well as app-using drivers. In some examples, the road intelligence network 700 can send a query out to the mobile applications of all registered app-users of the road intelligence network 700 that are allowed to be in a particular area. Then if the road intelligence network system 700 is monitoring that area and determines that either a driver or a pedestrian is in a location without a positive reply, the road intelligence network 700 can send a safety patrol officer to investigate and see if the driver or pedestrian is otherwise authorized for access. In many cases there will be camera or motion detectors noticing that there are people in a particular area and perhaps even able to count them. The question will then be whether they are authorized or not. This system can answer that question.

### Beacon-Based Framework for Speeding and Traffic Violation Detection

As noted above, the systems and techniques described herein can be associated with a driver application running on the smartphone or mobile computing device(s) associated with each driver and/or registered user of the road intelligence network system. The driver application may additionally, or alternatively, run on an onboard computer or computing system of the driver's vehicle. In some embodiments, the driver application and beacon framework (both described previously above) can be used to detect various traffic violations, moving violations, or other prohibited behaviors and actions by registered drivers or other users of the system. For instance, the driver application and beacon framework can be used to detect speeding, running red lights, running stop signs, etc., as will be described in greater depth below.

Speeding can be identified based on analyzing GPS or other location information of a vehicle, and possibly also beacon distances (e.g., distances between beacons and time for vehicle to travel a known beacon-to-beacon distance yields the vehicle's average speed between the two beacons). For instance, current (e.g., real-time or substantially real-time) GPS/location information and/or beacon distances corresponding to a vehicle can be used for measuring the vehicle's speed and comparing that speed with the officially recorded speed limit in the area. The same GPS/location information used to measure the vehicle's speed can be used to obtain or determine the officially recorded speed limit for the vehicle's current location. The process of determining a vehicle's speed and comparing the vehicle's speed against the recorded speed limit for the current vehicle location can be performed continuously and/or periodically. In some cases, the periodic interval can be consistent over time (e.g., every 30 seconds, every 1 minute, every 5 minutes, etc.). In some examples, the periodic interval can be random to avoid influencing driver behavior to circumvent the speed checks. In some embodiments, different geographic areas or regions (e.g., the same as or similar to the geofenced zones described previously above) can be configured with different rules for implementing the speeding detection. For example, school zones can be configured to check driver speed continuously, while interstate highways may check at a relatively long periodic interval. In some examples, the configuration or rules for speed checks/speeding detection can vary based on geographic location or region, and may additionally or alternatively vary based on factors such as time of day, type of vehicle, vehicle information or characteristics, driver information or characteristics, etc.

Vehicles that run or otherwise fail to come to a complete stop at stop signs can be identified using various combinations of GPS information, accelerometer information, and possibly also beacon data to confirm the vehicle came to a complete stop at the stop sign. This requires having a database of stop sign locations and possibly instrumenting the roads approaching them sufficiently. For instance, a vehicle can first be detected as approaching a known or configured stop sign location. GPS can be used to detect a vehicle running a stop sign based on the vehicle's speed being greater than zero (or some threshold speed) while the vehicle is near the stop sign. In other words, GPS can be used to detect running stop signs by identifying drivers whose speed never drops to zero (indicating the required stop at the stop sign). Similarly, accelerometer information can be obtained from the vehicle's onboard sensors, from the integrated sensors of the driver's smartphone or computing device running the driver app, or a combination of the two. Certain patterns of accelerometer data are indicative of a vehicle coming to a stop (e.g., a peak in acceleration followed by approximately zero acceleration in the direction of vehicle travel, etc.). The accelerometer data can be analyzed in a manner the same as or similar to the GPS information to determine whether a driver has come to the required stop at a stop sign, or if the driver has run the stop sign. In some cases, accelerometer data can be used on its own to perform detection of running stop signs. In some examples, accelerometer data can be used to augment the GPS-based approach described previously above.

Beacon data can be used to perform detection of running stop signs in a manner the same as or similar to GPS or accelerometers, where the beacon data is analyzed to determine whether the driver has come to a complete stop at the required stop sign location. In another example, beacon data can be analyzed to determine whether the distance between the vehicle and the beacon is constantly changing (e.g., indicative of a vehicle in motion, given a static beacon location) or if the distance between the vehicle and the beacon remains approximately constant for a period of time (e.g., indicative of the vehicle having come to a complete stop, again given a static beacon location). In some cases, the known stop sign locations can be localized or positioned relative to the fixed positions of one or more roadside beacons, and the beacons nearby the stop signs can be used to determine whether the beacon-to-vehicle distance stops changing and indicates a complete stop. In some embodiments, one or more beacons can be integrated into the stop sign, the stop line on the road, or otherwise provided nearby to the stop sign location, and can be analyzed to determine whether the beacon-to-vehicle distance has stopped changing and indicates a complete stop or not.

A same or similar approach as described above for stationary or fixed stop signs can also be applied to moving stop signs or moving stop targets/entities such as school buses. For example, the beacon framework and driver application can be used to perform detection of drivers who run or fail to obey/comply with stop signs on school buses and other moving stop signs. This is a matter of using the same technology to track the locations of school buses and possibly instrumenting them to know when the bus is displaying its integrated stop signs. Then the road intelligence network 700 can track whether a nearby vehicle stopped before passing the school bus using the stop sign system above.

Many cities have a feed of the current color of every traffic light. Information indicative of or corresponding to the current state of a plurality of traffic lights can be provided to the road intelligence network 700, and may be utilized to confirm whether vehicles are obeying traffic signals such as red lights (requiring the vehicle come to a stop/not pass through the lighted intersection until the traffic signal turns green), yellow lights (generally indicating a vehicle should begin slowing, and either be prepared to stop or be clear of the light/intersection by the time the traffic signal turns red, etc.), green lights, flashing yellow lights, flashing red lights, etc. In some aspects, the road intelligence network 700 can be configured to capture traffic signal state data and confirm that the vehicle didn't traverse the intersection until after the light turned green. This may be implemented based on the road intelligence network system obtaining, or determining itself, detailed tracking of vehicle position using beacons and possibly GPS, and knowing the location of the streetlights sufficiently well. In some aspects, the road intelligence network can obtain a real-time feed from one or more municipalities that maintain the roadway infrastructure within the monitored area(s) of the road intelligence network.

For instance, the road intelligence network can obtain real-time traffic light information from one or more municipalities responsible for the traffic lights within monitored areas of the road intelligence network. Based on establishing time synchronization between the traffic light information obtained from the municipalities, and the real-time mapping or tracking information of vehicle locations/positions, speeds, trajectories, etc., as the vehicles move about the road network within the monitored area(s), the road intelligence network can be configured to automatically determine when a vehicle has run a red light without using (or without requiring, e.g., only optionally using) image data, video data, or red light/intersection camera feed data that provide visual evidence of red light runners. For example, with time synchronization information indicating the start and end of a red light cycle of a given traffic signal for a particular intersection, the road intelligence network can obtain or query all vehicle movement information within that particular intersection within a time window that includes at least a portion of the red light cycle (beginning from, or slightly before, the start time of the red light cycle being analyzed). The road intelligence network may be configured to automatically determine when a vehicle has run a red light, based on analyzing the real-time or time-synchronized red light information obtained from the municipality with the vehicle location and speed information calculated, determined, maintained, etc., by the road intelligence network system.

Beacon-Based Framework for Driver Identification without License Plate Information

Existing automated approaches to vehicle ticketing or the issuance of traffic/moving violations are largely based on capturing and reading license plate information of the offending vehicle. This can be a relatively complex process, which requires the use of cameras positioned and properly timed to capture an image that includes a sufficiently clear representation of the license plate of the vehicle, and further requires a manual or automated computerized review of the image to extract/confirm the license plate that is depicted.

In one illustrative example, the road intelligence network 700 can be used to determine driver identity information and/or to perform ticket or violation notice generation without using or requiring license plate information or imagery thereof. In some embodiments, the system already has access to the identity or identity information of each vehicle driver through the corresponding instance of the driver application that is running and associated with each respective driver (e.g., of the plurality of registered drivers of the system). Advantageously, it is contemplated that the system can leverage this access to driver identity and associated information, to perform driver identification and/or to generate tickets or moving violations or other notices automatically, without needing to see the license plate on the vehicle or otherwise obtain imagery data of the vehicle and/or license plate.

For instance, the driver identity determination through driver application profile information can be used instead of license plate information or images for any (or all) of the different approaches described above (e.g., for speeding detection, red light violations, fixed stop sign violations, moving stop sign violations, etc.). In one illustrative example, the combination of the application and the system has the speed limit and stop or red-light information and the location/velocity of the vehicle and can then generate a ticket automatically for the current driver associated with the driver app/vehicle for which the violation was detected. In this approach, advantageously, the road intelligence network 700 does not need a license plate reader or a camera to capture the violations or license plate information to determine the driver/vehicle identity for which the ticket is generated.

In some embodiments, the system can include and utilize Bluetooth beacons, which are much cheaper than license plate reading or camera-based approaches conventionally used today. In some embodiments, Bluetooth beacons or other beacons may not even be needed, and the driver identity information can be determined through the same smartphone or computing device that is running the driver app. For instance, the smartphone or computing device running the driver application can use its built-in GPS and/or can communicate with cell towers to perform positioning and locate itself sufficiently well (e.g., accurately). The location information determined by the phone/driver application can be shared with the system, and used to correlate driver identities/driver application profiles to violation occurrences detected by the system as described above. In this example, sufficient mobile coverage is needed, but the required level of mobile coverage is much lower. In some aspects, the road intelligence network system can be implemented where the driver application can be configured to communicate with the network over Bluetooth and/or WiFi bridges located (e.g., installed, deployed, provided, etc.) on the side of the road, wherein the Bluetooth/WiFi bridges are equipped with data network backhaul connectivity via mobile data (e.g., cellular, satellite, and/or other wireless connectivity, etc.) and/or via a wired fiber connection. In this case, the driver application does not necessarily need to rely on the driver's smartphone (or other computing device running the driver application for that driver) to have good 4G/5G coverage in the particular location.

### In-Vehicle or Vehicle-Borne Beacons

In some embodiments, the beacon framework described herein can additionally, or alternatively, utilize one or more beacons that are installed into or onto vehicles (e.g., in addition to or alternative to the approach of the beacon framework described previously, using roadside beacons with receivers for the beacon signal(s) provided on the vehicles or driver's smartphone running the driver app). For instance, the system can be set up to specifically ask or require that beacons be installed in vehicles so that the vehicle-borne beacons can be read or otherwise used to obtain a record of the relationship between the beacon ID and the car identification (VIN or license plate etc.). Such implementations can be seen to allow for a reduction in the risk of colliding with parked cars with no driver in them, based on beacon signaling from a respective beacon in one of or both the parked car and the moving car (or also can be used if the car is running and the driver is not running the application on the driver mobile device). Additionally, in-vehicle or vehicle-borne beacon implementations can be seen to allow the driver application to identify the car in which it is located (e.g., allows the driver application to determine the car in which the smartphone or computing device running the driver application is currently located). The car or vehicle currently corresponding to a driver application instance/driver application device can be reported to the system so the system can use that information as well as locations of possible drivers to understand who is actually driving the vehicle. The current vehicle associated with a driver application instance/device can also be used for the driver identification and ticketing/violation generation and notification described previously above. The current vehicle associated with a driver application instance/device can be checked periodically and updates sent to the system as needed, and/or sent whenever there is a change in the mapping. In some cases, the system can notice or determine that a car is driving without the beacon, or notice the beacon is driving without the car and use that as an input to various protocols to make sure the vehicle is not stolen or other sorts of fraud is ongoing.

Implementations based on in-vehicle or on-vehicle beacons can be improved, extended, or otherwise augmented with a better understanding or knowledge of the location/position (or relative location/position) of the beacon in the vehicle. For instance, a vehicle beacon can be localized within the vehicle based on one or more of the techniques described below. In some embodiments, the vehicle beacons can be installed in a particular vehicle location, and/or the vehicle owner or driver can be required to do so. In some embodiments, the vehicle beacon can be provided as an integrated part or component of the physical license plate that is by law attached the center rear of the vehicle. With information about the make/model and geometry of those makes and models, the system can then be configured to use measurements and/or beacon signals from the vehicle beacon integrated with the vehicle license plate to infer or otherwise determine exactly how much distance around the beacon the car extends.

In some cases, the system can be configured to check or determine that the vehicle beacon is located where it is supposed to be located on or within the vehicle, for example by observing the location of the beacon with respect to one or more or various patterns of vehicle movement along the road. For example, if the system assumes or infers that the vehicle is driving reasonably centered within lane boundaries, the system can then infer how centered the vehicle-borne beacon is with respect to the left and right sides of the vehicle. If the driver app sees the beacon when entering the car, the system can possibly make further inferences about the beacon location with respect to the driver seat (e.g. if the beacon is seen to be sufficiently far away when the driver enters the car, then the system can assume that the beacon location is not at or near the driver's seat and may be at the rear end of the vehicle, etc.). In some aspects, the system can be configured to also use knowledge of the typical following distances of trailing vehicles to further aid in modeling the likely location of the beacon on or within the vehicle.

In some embodiments, the vehicle beacon implementation described immediately above can be implemented and deployed based on providing one or more (or a plurality of) sensors on the side of the road to record and report distances to passing vehicle beacons and directions to the passing vehicle beacons. This information measured between the moving vehicle beacons and the roadside sensor infrastructure can be provided to the system and used to add to the overall inference package obtained from the roadside beacons, roadside WiFi routers or APs, roadside sensor network(s), etc. In one illustrative example, the system would rely on a mix of apps in one vehicle that can be used to sense that vehicle's beacon as well as beacons in other vehicles, and that can additionally be used to sense the stationary beacons on the side of the road (e.g., the roadside beacons previously described in the context of the presently disclosed beacon framework) and as well as sensors on the side of the road seeing a mix of vehicle beacons passing by.

In some embodiments, the vehicle-borne beacons (installed on or within the vehicle, integrated with the vehicle or vehicle license plate, etc.) can include one or more integrated accelerometers or inertial devices in them. Accordingly, the vehicle-borne beacons can be configured to report accelerometer data as well to receivers on the side of the road. Or the vehicle beacons can be configured with mobile (e.g., cellular) connectivity and GPS location or positioning systems, and in such embodiments may function the same as or similar to the driver app on the driver mobile device (e.g., just without the identity of the driver and the ability to communicate, etc.). In either case, the same data can be used to track vehicle movement and position (possibly better) as well as road conditions.

In some aspects, it is contemplated that a vehicle-borne beacon can be permanently mounted as a dashcam of or for the vehicle, and can also share information captured by the dash cameras in forward-looking directions, backward-looking directions, side-looking directions, or any combination(s) thereof, etc. In some aspects, if the beacon (e.g., a vehicle-borne beacon) is attached to or otherwise associated with a camera or dashcam etc., the system can use image information captured by the dashcam or other in-vehicle camera to locate the beacon with respect to the vehicle. In some embodiments, the system may be battery-powered.

In some embodiments, the systems and techniques described herein can configure the road intelligence network to obtain input data streams from dedicated dashcams and/or from user devices that are mounted within a vehicle and configured to function as a dashcam (e.g., via an application running on the phone, or the native camera functionality of the phone, or via the driver mobile application provided by the road intelligence network system, etc.). The dedicated dashcam image or video data obtained from the vehicles, as well as flexibly configured dashcam image or video data obtained from smartphones or other user devices that are mounted or held at the appropriate vantage point from within the vehicle passenger compartment to capture outward-facing footage of the roadway environment, can be used to enhance the full situational awareness determined by the road intelligence network. For example, computer vision and object recognition techniques, including ML-based and/or AI-based object recognition, can be used to detect or identify objects in or near the roadway or lane of travel for a vehicle, using dashcam footage obtained from a camera associated with or within the vehicle; can be used to detect barriers, road signage, nearby vehicles, etc., among various other detection capabilities. IN some aspects, the dashcam image or video data obtained from smartphones, dedicated dashcams, integrated vehicle cameras, etc., can be used for license plate reading and recognition, to thereby identify via a different modality than those described above, the nearby or neighboring vehicles within the vicinity of the particular vehicle from which the dashcam footage is obtained. Such detection can run locally at the vehicle or user devices, can run remotely in the road intelligence network system, can run in the cloud, or can run using various combinations thereof.

In some embodiments, the system will also get power from the vehicle or instead get power from the vehicle. In some cases, one or more components can be configured to obtain or receive power from the vehicle, while one or more remaining components can be battery-powered. In some cases the batteries can be charged by the vehicle when running. In some embodiments, the components may use battery power after the vehicle shuts off, until it runs out, is depleted, or reaches a configured threshold level, etc. In other examples, it will only run when the vehicle is on. In some cases this vehicle system will operate as a beacon. In other cases it will also operate as a sensor reporting other beacons it sees or detects. In one illustrative example, the system can be configured to report other beacons it sees before it shuts down, wherein the reported information includes or is otherwise indicative of the respective identities and/or movement patterns of any of the other beacons that are seen or within range before the shutdown, etc.

In some aspects, a license plate identifies a vehicle the same way a beacon does. The difference is that a beacon doesn't require a camera seeing the vehicle from the correct angle so it is easier to automate various functionalities and use cases. In some aspects, the systems and techniques described herein can be used to charge for parking and/or issue parking tickets, e.g., based on determining the driver identity using the driver app (as described above) and/or based on determining the vehicle location based on the beacon framework(s) described herein (also described above). In some embodiments, the system can report the location of valid tags and provide meter maids the ability to compare that to the physical location of vehicles they observe. Possibly they can use an AI camera to compare the two impressions. It is generically a much lower cost alternative to license plate readers with the advantage of being better at establishing the exact position of the vehicle. In addition to installing beacons roadside, the system can be configured or deployed to include one or more WiFi routers or access points (APs) that are also installed roadside, in locations, regions, areas, zones relative to the roadway, etc., that are the same as or similar to where the roadside beacons are installed. In one illustrative example, the roadside WiFi routers can be used by the system to improve detection of the location of pedestrians and pets. In some aspects, relevant sensors for implementing the improved detection and/or localization and/or perception of the pedestrians, pets, etc., can be provided in vehicles or on the side of the road.

In some cases, the systems and techniques described herein can be implemented be computing device or apparatus which may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The processes described herein can include a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the processes described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

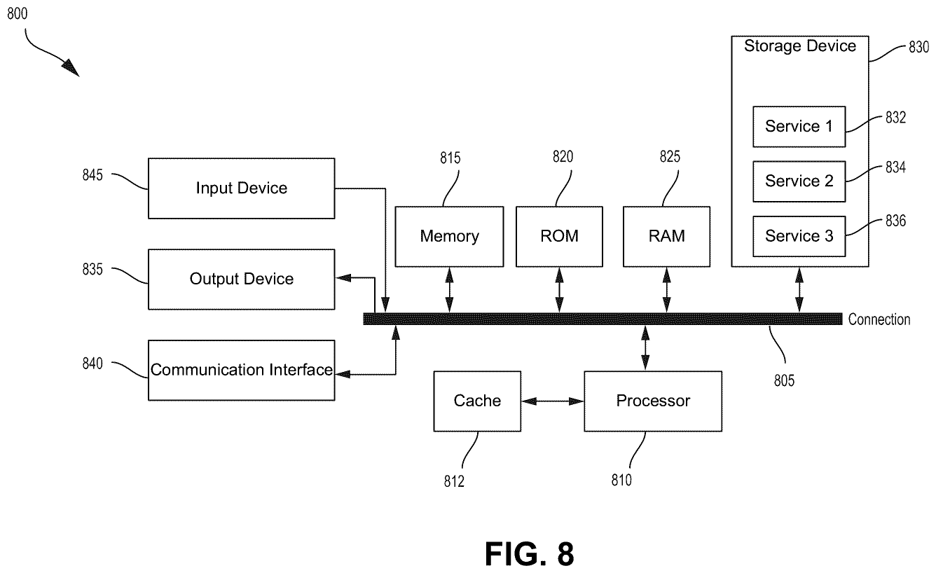

FIG. 8 is a diagram illustrating an example of a system for implementing certain aspects of the present technology. In particular, FIG. 8 illustrates an example of computing system 800, which may be for example any computing device making up internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some aspects, computing system 800 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 800 includes at least one processing unit (CPU or processor) 810 and connection 805 that communicatively couples various system components including system memory 815, such as read-only memory (ROM) 820 and random-access memory (RAM) 825 to processor 810. Computing system 800 may include a cache 812 of high-speed memory connected directly with, in close proximity to, or integrated as part of processor 810.

Processor 810 may include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with computing system 800.

Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some aspects, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general-purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description. Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof. The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A method comprising: obtaining, from one or more sensors included in a plurality of sensors associated with a roadway environment, monitoring information associated with one or more vehicles; determining real-time mapping information indicative of one or more of movement information or trajectory information of the one or more vehicles, wherein the real-time mapping information is determined based at least in part on correlating each vehicle of the one or more vehicles to respective portions of the monitoring data; detecting an unsafe driving behavior for a particular vehicle based on analyzing the real-time mapping information and one or more of historical mapping information obtained for the roadway environment or for the particular vehicle; and transmitting, to a driver mobile application associated with a driver of the particular vehicle, a remediation message automatically generated in response to detection of the unsafe driving behavior.

Aspect 2. The method of Aspect 1, wherein detecting the unsafe driving behavior includes: determining, based on the real-time mapping information, one or more driving characteristics corresponding to the particular vehicle; identifying neighboring vehicles within the roadway environment, wherein the neighboring vehicles are included in the one or more vehicles and are located nearby to the particular vehicle; and determining, based on the real-time mapping information, one or more baseline driving characteristics corresponding to the identified neighboring vehicles.

Aspect 3. The method of Aspect 2, further comprising: detecting the unsafe driving behavior based on one or more deviations between the driving characteristics corresponding to the particular vehicle and the baseline driving characteristics corresponding to the identified neighboring vehicles.

Aspect 4. The method of any of Aspects 2 to 3, wherein the neighboring vehicles are located within a configured threshold distance from the particular vehicle.

Aspect 5. The method of any of Aspects 2 to 4, wherein the neighboring vehicles are located in an adjacent lane position relative to a current lane position of the particular vehicle.

Aspect 6. The method of any of Aspects 1 to 5, wherein detecting the unsafe driving behavior is further based on analyzing sensor data obtained from one or more sensors associated with the particular vehicle, wherein the one or more sensors includes at least an accelerometer.

Aspect 7. The method of Aspect 6, wherein at least a portion of the sensor data is obtained from a Controller Area Network (CAN) bus associated with the particular vehicle, or is obtained from a CAN bus associated with additional vehicles included in the one or more vehicles.

Aspect 8. The method of any of Aspects 1 to 7, wherein the remediation message comprises automatically generated driver assistance information configured to remediate erratic driving characteristics associated with the unsafe driving behavior.

Aspect 9. The method of any of Aspects 1 to 8, wherein the remediation message comprises a warning notification or a request for the driver to stop the unsafe driving behavior.

Aspect 10. The method of any of Aspects 1 to 9, wherein the remediation message comprises an automatically generated ticket or infraction instance for the driver, the ticket or infraction instance generated based on license plate information determined for the particular vehicle based on the monitoring information.

Aspect 11. The method of any of Aspects 1 to 10, wherein the remediation message includes one or more of control commands or configuration information generated for an Advanced Driver Assistance System (ADAS) module of the particular vehicle.

Aspect 12. The method of any of Aspects 1 to 11, wherein: the one or more sensors comprises a plurality of cameras deployed to roadside locations or overhead locations within the roadway environment; and the monitoring information corresponds to respective image data obtained from the plurality of cameras and depicting the one or more vehicles.

Aspect 13. The method of Aspect 12, wherein the monitoring information comprises a unique identifier or registration information associated with a vehicle, determined based on detecting license plate information within the respective image data obtained from the plurality of cameras.

Aspect 14. The method of any of Aspects 1 to 13, wherein: the one or more sensors comprises a plurality of beacon devices configured to transmit beacon signals, and a plurality of receiver devices configured to receive transmitted beacon signals; and the monitoring information corresponds to relative position information of one or more receiver devices included in the plurality of receiver devices, the relative position information determined based on measurements of transmitted beacon signals from the plurality of beacon devices.

Aspect 15. The method of Aspect 14, wherein: the plurality of beacon devices includes one or more stationary beacons each associated with a respective location within the roadway environment; and the one or more receiver devices are user computing devices each located within a respective vehicle of the one or more vehicles.

Aspect 16. The method of any of Aspects 14 to 15, further comprising determining one or more of: vehicle position information, vehicle movement information, or vehicle trajectory information for a particular vehicle, the determination based on the relative position information of a corresponding receiver device located within the particular vehicle.

Aspect 17. The method of Aspect 16, wherein the corresponding receiver device is included in the plurality of receiver devices and comprises a smartphone associated with a driver or a passenger of the particular vehicle.

Aspect 18. The method of any of Aspects 14 to 17, wherein: the plurality of beacon devices includes one or more user computing devices each located within a respective vehicle of the one or more vehicles and configured to transmit a beacon signal including an identifier of the respective vehicle; and the one or more receiver devices are stationary receivers each associated with a configured location within the roadway environment.

Aspect 19. The method of any of Aspects 14 to 18, wherein the relative position information is further determined based on a configured location determined for a particular beacon device associated with each one of the transmitted beacon signals.

Aspect 20. An apparatus comprising: at least one memory; and at least one processor coupled to the at least one memory, the at least one processor configured to: obtain, from one or more sensors included in a plurality of sensors associated with a roadway environment, monitoring information associated with one or more vehicles; determine real-time mapping information indicative of one or more of movement information or trajectory information of the one or more vehicles, wherein the real-time mapping information is determined based at least in part on correlating each vehicle of the one or more vehicles to respective portions of the monitoring data; detect an unsafe driving behavior for a particular vehicle based on analyzing the real-time mapping information and one or more of historical mapping information obtained for the roadway environment or for the particular vehicle; and transmit, to a driver mobile application associated with a driver of the particular vehicle, a remediation message automatically generated in response to detection of the unsafe driving behavior.

Aspect 21. The apparatus of Aspect 20, wherein, to detect the unsafe driving behavior, the at least one processor is configured to: determine, based on the real-time mapping information, one or more driving characteristics corresponding to the particular vehicle; identify neighboring vehicles within the roadway environment, wherein the neighboring vehicles are included in the one or more vehicles and are located nearby to the particular vehicle; and determine, based on the real-time mapping information, one or more baseline driving characteristics corresponding to the identified neighboring vehicles.

Aspect 22. The apparatus of Aspect 21, wherein the at least one processor is further configured to: detect the unsafe driving behavior based on one or more deviations between the driving characteristics corresponding to the particular vehicle and the baseline driving characteristics corresponding to the identified neighboring vehicles.

Aspect 23. The apparatus of any of Aspects 21 to 22, wherein the neighboring vehicles are located within a configured threshold distance from the particular vehicle.

Aspect 24. The apparatus of any of Aspects 21 to 23, wherein the neighboring vehicles are located in an adjacent lane position relative to a current lane position of the particular vehicle.

Aspect 25. The apparatus of any of Aspects 20 to 24, wherein, to detect the unsafe driving behavior, the at least one processor is further configured to analyze sensor data obtained from one or more sensors associated with the particular vehicle, wherein the one or more sensors includes at least an accelerometer.

Aspect 26. The apparatus of Aspect 25, wherein at least a portion of the sensor data is obtained from a Controller Area Network (CAN) bus associated with the particular vehicle, or is obtained from a CAN bus associated with additional vehicles included in the one or more vehicles.

Aspect 27. The apparatus of any of Aspects 20 to 26, wherein the remediation message comprises automatically generated driver assistance information configured to remediate erratic driving characteristics associated with the unsafe driving behavior.

Aspect 28. The apparatus of any of Aspects 20 to 27, wherein the remediation message comprises a warning notification or a request for the driver to stop the unsafe driving behavior.

Aspect 29. The apparatus of any of Aspects 20 to 28, wherein the remediation message comprises an automatically generated ticket or infraction instance for the driver, the ticket or infraction instance generated based on license plate information determined for the particular vehicle based on the monitoring information.

Aspect 30. The apparatus of any of Aspects 20 to 29, wherein the remediation message includes one or more of control commands or configuration information generated for an Advanced Driver Assistance System (ADAS) module of the particular vehicle.

Aspect 31. The apparatus of any of Aspects 20 to 30, wherein: the one or more sensors comprises a plurality of cameras deployed to roadside locations or overhead locations within the roadway environment; and the monitoring information corresponds to respective image data obtained from the plurality of cameras and depicting the one or more vehicles.

Aspect 32. The apparatus of Aspect 31, wherein the monitoring information comprises a unique identifier or registration information associated with a vehicle, determined based on detecting license plate information within the respective image data obtained from the plurality of cameras.

Aspect 33. The apparatus of any of Aspects 20 to 32, wherein: the one or more sensors comprises a plurality of beacon devices configured to transmit beacon signals, and a plurality of receiver devices configured to receive transmitted beacon signals; and the monitoring information corresponds to relative position information of one or more receiver devices included in the plurality of receiver devices, the relative position information determined based on measurements of transmitted beacon signals from the plurality of beacon devices.

Aspect 34. The apparatus of Aspect 33, wherein: the plurality of beacon devices includes one or more stationary beacons each associated with a respective location within the roadway environment; and the one or more receiver devices are user computing devices each located within a respective vehicle of the one or more vehicles.

Aspect 35. The apparatus of any of Aspects 33 to 34, wherein the at least one processor is further configured to determine one or more of: vehicle position information, vehicle movement information, or vehicle trajectory information for a particular vehicle, the determination based on the relative position information of a corresponding receiver device located within the particular vehicle.

Aspect 36. The apparatus of Aspect 35, wherein the corresponding receiver device is included in the plurality of receiver devices and comprises a smartphone associated with a driver or a passenger of the particular vehicle.

Aspect 37. The apparatus of any of Aspects 33 to 36, wherein: the plurality of beacon devices includes one or more user computing devices each located within a respective vehicle of the one or more vehicles and configured to transmit a beacon signal including an identifier of the respective vehicle; and the one or more receiver devices are stationary receivers each associated with a configured location within the roadway environment.

Aspect 38. The apparatus of any of Aspects 33 to 37, wherein the at least one processor is configured to determine the relative position information further based on a configured location determined for a particular beacon device associated with each one of the transmitted beacon signals.

What is claimed is:

1. A method comprising:
obtaining, from one or more sensors included in a plurality of sensors associated with a roadway environment, monitoring information associated with one or more vehicles;
determining real-time mapping information indicative of one or more of movement information or trajectory information of the one or more vehicles, wherein the real-time mapping information is determined based at least in part on correlating each vehicle of the one or more vehicles to respective portions of the monitoring data;
detecting an unsafe driving behavior for a particular vehicle based on analyzing the real-time mapping information and one or more of historical mapping information obtained for the roadway environment or for the particular vehicle; and
transmitting, to a driver mobile application associated with a driver of the particular vehicle, a remediation message automatically generated in response to detection of the unsafe driving behavior.

2. The method of claim 1, wherein detecting the unsafe driving behavior includes:
determining, based on the real-time mapping information, one or more driving characteristics corresponding to the particular vehicle;
identifying neighboring vehicles within the roadway environment, wherein the neighboring vehicles are included in the one or more vehicles and are located nearby to the particular vehicle; and
determining, based on the real-time mapping information, one or more baseline driving characteristics corresponding to the identified neighboring vehicles.

3. The method of claim 2, further comprising:
detecting the unsafe driving behavior based on one or more deviations between the driving characteristics corresponding to the particular vehicle and the baseline driving characteristics corresponding to the identified neighboring vehicles.

4. The method of claim 2, wherein the neighboring vehicles are located within a configured threshold distance from the particular vehicle.

5. The method of claim 2, wherein the neighboring vehicles are located in an adjacent lane position relative to a current lane position of the particular vehicle.

6. The method of claim 1, wherein detecting the unsafe driving behavior is further based on analyzing sensor data obtained from one or more sensors associated with the particular vehicle, wherein the one or more sensors includes at least an accelerometer.

7. The method of claim 6, wherein at least a portion of the sensor data is obtained from a Controller Area Network (CAN) bus associated with the particular vehicle, or is obtained from a CAN bus associated with additional vehicles included in the one or more vehicles.

8. The method of claim 1, wherein the remediation message comprises automatically generated driver assistance information configured to remediate erratic driving characteristics associated with the unsafe driving behavior.

9. The method of claim 1, wherein the remediation message comprises a warning notification or a request for the driver to stop the unsafe driving behavior.

10. The method of claim 1, wherein the remediation message comprises an automatically generated ticket or infraction instance for the driver, the ticket or infraction instance generated based on license plate information determined for the particular vehicle based on the monitoring information.

11. The method of claim 1, wherein the remediation message includes one or more of control commands or configuration information generated for an Advanced Driver Assistance System (ADAS) module of the particular vehicle.

12. The method of claim 1, wherein:
the one or more sensors comprises a plurality of cameras deployed to roadside locations or overhead locations within the roadway environment; and
the monitoring information corresponds to respective image data obtained from the plurality of cameras and depicting the one or more vehicles.

13. The method of claim 12, wherein the monitoring information comprises a unique identifier or registration information associated with a vehicle, determined based on detecting license plate information within the respective image data obtained from the plurality of cameras.

14. The method of claim 1, wherein:
the one or more sensors comprises a plurality of beacon devices configured to transmit beacon signals, and a plurality of receiver devices configured to receive transmitted beacon signals; and
the monitoring information corresponds to relative position information of one or more receiver devices included in the plurality of receiver devices, the relative position information determined based on measurements of transmitted beacon signals from the plurality of beacon devices.

15. The method of claim 14, wherein:
the plurality of beacon devices includes one or more stationary beacons each associated with a respective location within the roadway environment; and
the one or more receiver devices are user computing devices each located within a respective vehicle of the one or more vehicles.

16. The method of claim 14, further comprising determining one or more of: vehicle position information, vehicle movement information, or vehicle trajectory information for a particular vehicle, the determination based on the relative position information of a corresponding receiver device located within the particular vehicle.

17. The method of claim 16, wherein the corresponding receiver device is included in the plurality of receiver devices and comprises a smartphone associated with a driver or a passenger of the particular vehicle.

18. The method of claim 14, wherein:
the plurality of beacon devices includes one or more user computing devices each located within a respective vehicle of the one or more vehicles and configured to transmit a beacon signal including an identifier of the respective vehicle; and
the one or more receiver devices are stationary receivers each associated with a configured location within the roadway environment.

19. The method of claim 14, wherein the relative position information is further determined based on a configured location determined for a particular beacon device associated with each one of the transmitted beacon signals.

20. An apparatus comprising:
at least one memory; and
at least one processor coupled to the at least one memory, the at least one processor configured to:
obtain, from one or more sensors included in a plurality of sensors associated with a roadway environment, monitoring information associated with one or more vehicles;
determine real-time mapping information indicative of one or more of movement information or trajectory information of the one or more vehicles, wherein the real-time mapping information is determined based at least in part on correlating each vehicle of the one or more vehicles to respective portions of the monitoring data;
detect an unsafe driving behavior for a particular vehicle based on analyzing the real-time mapping information and one or more of historical mapping information obtained for the roadway environment or for the particular vehicle; and
transmit, to a driver mobile application associated with a driver of the particular vehicle, a remediation message automatically generated in response to detection of the unsafe driving behavior.
